(19) United States
(12) Patent Application Publication
(10) Pub. No.: US 2018/0061243 A1
(43) Pub. Date: Mar. 1, 2018

(54) SYSTEM AND METHODS FOR AUTOMATED AIRPORT AIR TRAFFIC CONTROL SERVICES

(71) Applicant: IATAS (AUTOMATIC AIR TRAFFIC CONTROL) LTD, Eilat (IL)

(72) Inventor: Ori SHLOOSH, Eilat (IL)

(21) Appl. No.: 15/675,749

(22) Filed: Aug. 13, 2017

Related U.S. Application Data
(63) Continuation-in-part of application No. PCT/IL2014/050074, filed on Jan. 22, 2014.
(60) Provisional application No. 61/755,682, filed on Jan. 23, 2013.

(51) Int. Cl. G08G 5/00; G08G 5/06; B64D 45/00; B64D 45/04; B64F 1/20

(52) U.S. Cl. CPC G08G 5/0013; G08G 5/0065; G08G 5/065; B64D 45/0005; B64D 45/04; G06F 3/147; G08G 5/0091; B64F 1/20; G08G 5/0043; G08G 5/0056; G08G 5/0021

(57) ABSTRACT

A system and method for automating Air Traffic Control operations at or near an airport. as a complete standalone automated system replacing the need for a human controller to make aircraft movement decisions nor the need communicate with pilots, or as semi-automated, where a controller controls how the system operates. The system with related methods and computer hardware and computer software package, automatically manages manned aircraft, remote controlled UAV and airborne-able vehicles traffic at or near an airport, eliminates ATC-induced and reduce pilot-induced runway incursions and excursions, processes control messages related to aircraft or Pilots, communicates with Pilot over ATC radio frequency, receives aircraft positions, communicates control messages with the aircraft avionics, provides pilots a dynamic map with continuous display of nearby traffic operations, shows clearance and information related to runway operations, warns pilot of runway conditions and turbulence from other operations, warns when landing gear is not locked, displays the pilot emergency exits during takeoff roll, shows the pilot when and where to exit from the runway, shows the pilot where and when to cross a junction, calculates and displays pilot optimal speed and timing on taxiways and junctions for saving fuel, calculates congestions, calculates best taxiway routes, calculates when aircraft can cross a runway, provides directives and information to pilot over CPDLC display or dynamic map for airside operations, alerts and triggers breaks of the aircraft on wrong path or when hold-short bar is breached, displays emergency personnel with routing map and final aircraft resting position for emergency operations, takes over an aircraft operation when aircraft is hijacked or deviates from the flight plan, provide standalone or manned Remote Tower functionality, Records and retains all information related to airport airside operations including aircraft positions and conditions from sensors and reports for runways, junctions and taxiways, Records and retains aircraft data and cockpit voice to ground-based servers to eliminate black-box requirements, calculate future weather and airport capacity from aircraft at or nearby airport, coordinates handoff operations with other ATC positions, interfaces with ACDM systems, airport operations center, flow center and network operations center.

### FIELD OF THE INVENTION

The invention generally relates to the field of Traffic Control Systems for aircrafts, and more particularly to Airport Tower Traffic control Systems combining control traffic of aircrafts both airborne and on the ground, as well as vehicle movements within the airfield.

### BACKGROUND OF THE INVENTION

As Air/Ground infrastructures, standards and communication protocols for the aviation industry are being implemented by governing bodies such as EUROCONTROL (SESAR SWIM program) and FAA (NextGen program).

Clearances, requests and directives to pilots relating to airport movements operations, are only given or received by a human controller, although the communication may involve technologies of radio, data communication, CPDLC units for relaying information and alike, the human controller is the one that is making the decision and administrating the commands or providing the clearances.

Runway incursions, excursions, junction hotspots and taxiway transgression are currently well recognized as major safety issues at Airports. Runway incursions and taxiway transgression usually involve an inappropriate entry to a taxiway or runway and potentially can result in unsafe separation between other aircrafts or vehicles. As with any aviation accident or incident, the casual chain of events leading to runway incursions and unsafe taxiway transgression is complex. Current data shows that these events include consequences such as: takeoff or landing from a taxiway; takeoff or landing from incorrect runway; turning onto incorrect taxiway; unauthorized takeoff or landing; unauthorized runway crossing; unauthorized runway entry; and unauthorized taxiing. Many occurrences of these events involve poor Pilot approach or on-the-ground situational awareness that has not been overcome by either current traffic controls or Tower instructions. Furthermore, existing methods for selecting Runways and taxi routing are typically useless because they simply select the closest route.

There are two different systems for implementing Controller Pilot Data Link Communications (CPDLC) for commercial aircraft. The first CPDLC system is referred to as the Future Air Navigation System (FANS), or FANS CPDLC. FANS based programs are typically implemented on an aircraft's Flight Management Computer (FMC), also referred to as the Flight Management System (FMS), and communicate with Air Traffic Control (ATC) stations using text based messages communicated over the Aircraft Communications Addressing and Reporting System (ACARS). The second CPDLC system is implemented over the Aeronautical Telecommunication Network (ATN) via an aircraft's Communication Management Function (CMF) and is commonly referred to as ATN CPDLC. It is typical to consider the CPDLC Display unit (CPDLCDU) as the interface for communicating with the Pilot.

Voice communication between ATC and pilots typically use radio frequency (RF) in the frequency range of 108 MHz through 139 MHz, the frequency range varies between geographical areas and countries. It is typical for each type of ATC operation to use a different frequency. It is typical to use a dedicated frequency for each area of the airport in an airport with many taxiways or more than one tower. It is also typical for a large airport or an airport with several runways to use a dedicated frequency for each runway or a set of runways. Two Types of ATC operations related to the movement of aircraft within an Airport, first, a Ground ATC, for moving aircraft to and from the runway via taxiways, and, second, a Runway ATC for all runway operations, including takeoff, landing and crossings. It is common to consider both types of ATC operations as a Tower ATC. In small airports, it is typical for one single ATC to execute both Ground ATC and Runway ATC operations.

One type of technology is used today by Airport ATC to communicate commands and information with Pilots. A Radio Frequency (RF) is used for voice communication between ATC and Pilots where both Pilots and the Controller speak on the same radio frequency.

Two types of CPDLC text messages are typically used in commercial aviation today. The first message type is a downlink, typically used for sending aircraft information to the ATC or Airline ground systems from the onboard FANS or FMS, typically the data contains aircraft operation data such as fuel level and route information. The second message type is a bidirectional link, typically used for communicating non-critical ATC messages between high-altitude ATC and the flight crew, typically over a CPDLC Display Unit, the data typically contains altitude, vector clearances or routing information. High-altitude ATC operations are typically known to be managed by a Centre or En-route ATC.

In the USA, CPDLC is being tested for texting messages for non-critical information or operations between ATC at Airports and Pilots.

In order to check if a landing gear is locked, the ATC notifies the Pilot over the ATC radio frequency after ATC looks with binoculars at the aircraft from the tower.

When an emergency situation is dispatched to emergency personnel, the vehicles are routed strategically along runway points. The location of the vehicles is not always close to the final resting place of the aircraft, and sometimes may take the standard 5 minute response time to reach the aircraft.

there are many tools, hardware and software products assisting ATC with information for decision support and increasing efficiency, however, humans remain as the highest probable cause for airport related safety incidents. The rate of incidents is rising due to capacity and controller workload conditions.

One type of controller protocol is used for synchronizing departure requests between a Tower ATC with Departure ATC, a Tower ATC manually requests a “request-release” from departures ATC, and a flight will only be cleared for takeoff if a “released” is manually sent back from the departures ATC.

One type of technology is used for sending information to pilots related to airport changes such as closed taxiways, are available as a recorded message, and the controller requests the pilot to know the changes, and the pilot acknowledges once he has heard the information by declaring “we have BRAVO”, the controller then knows the pilot understands the information and changes affecting the Airport.

Two types of technology are used for ATC to assign taxi routes, One type is where an ATC verbally instructs a pilot of an aircraft to use a taxi route at an airport. The taxi route may be from any point within the airport to another. The second type is where an air traffic controller selects an aircraft on a display and assigns it a route, the route is then sent via uplink communication to onboard display, and the Pilot needs to confirm, reject or modify the sent route.

There are many types of route and taxiway display apparatuses and schemes, each providing certain information, or perspective, which are manually prescribed either by a controller or pilot, or provide partial functionality at best. Several types of common technologies provide some features, such as controller selected routes or segments, pilot approved and rejected routes, manual route or taxi entries, manual inputs, route selections, progressive taxi instructions, a dynamic map with perspective of the aircraft itself without other surrounding traffic or no map at all, nor the calculations for how long each route or route segment would take.

In order to ensure an aircraft is in a safe distance from or after clearing a junction or from other aircrafts, ATC informs the pilot on the radio frequency to stop or move the aircraft.

Communication of operational directives, clearances and information in International airports is done in English to bridge between all cultures and accents.

One type of technology is used for providing operational information to pilots, depending on the operation, such as winds, crossing traffic, turbulence warnings, initial climb altitude, breaking action, birds, and alike.

Several types of technologies are used to control an aircraft if hijacked, one type of technology requires an onboard air marshal to switch off the autopilot and gain control back of the aircraft. Another type of technology contains several emergency routes to be executed by the autopilot.

### SUMMARY OF THE INVENTION

### Glossary

ACARS: Aircraft Communications Addressing and Reporting System
A-CDM: Airport Collaborative Decision Making
ADSB: Automatic Dependent Surveillance Broadcast
AFL: Airfield Lighting
AGC: Air/Ground Communication (bidirectional)
aircraft: Any airborne enabled object with a UAV, RPAS, PAV, flying vehicle/car(s) or autonomous aircrafts, able to receive and send control messages
airfield: An area specific for aviation and supporting vehicles and including but not limited to service and maintenance
airport: An airfield associated with arrival or departure operations affecting an airfield or its runways and associated areas up to 18,000 feet in height to include descends for landing and climb for takeoffs.
airside crew: robot, human, or automated machine within the airside performing duties related to airside operations
airside object: any aircraft, vehicle or device worn by a human within the airfield
Alert: Audible sound or a visual cue or a visual depiction, or a visual highlight of a certain area
ALSF: Approach Lighting System with Sequenced Flashing Lights
AMS: Airport Management Software
APRD: Aircraft Position Reporting Devices
APRS: Aircraft Position Reporting Sensors
assigned task: tasks normally handled by maintenance crew but not limited to: snow removal, FOD maintenance and the like
ATC: Air Traffic Control, the ground and/or tower control function and/or the controller function within the tower
ATN: Aeronautical Telecommunication Network
automatic/automated: performance of a process without required intervention once triggered
autonomous: self-determining mechanism triggering automatic processes
available taxiway/runway/junction/gate: A taxiway clear of traffic for a sufficient period of time and can be used in all direction
CANSO: Association of Global Air Navigation Service Providers
CCS: Cockpit Computer System
CMF: Communication Management Function
control message: any control message sent or received between ground and aircraft or ground and airside object
CPDLC: Controller Pilot Data Link Communications
CPDLCDU: CPDLC Display unit
crossings: Any given point that can be crossed
CWP: Controller working position, that could be located at tower, remote tower, back up control room, or remote control room displaying information and allowing selection DAM: Dynamic map—solution provided by IATAS installed on aircraft tablet within the flight-deck or airside vehicle driver and/or pilots PDA device executing control messages and displaying menus and continuous pictures of surroundings area and information pertaining to each current or future operation
data: Control message, text message, ASCII code, binary, images or any type of graphic, alert, audio stream
DH: Decision height for landing or missed approach/go-around
EAS: Emergency Announcement System
EDM: Emergency Dispatch Module
environment: clouds, precipitation, snow, temperature, air pressure and/or winds and/or gusts and/or windshears at different altitudes
FAA: Federal Aviation Administration (U.S. aviation regulator)
FANS: Future Air Navigation System
FMC: Flight Management Computer
FMS: Flight Management System
FOD: Foreign object debris
gate: a position within an airfield for passengers to embark or disembark an aircraft, including stands, gates and terminals exits leading to aircrafts
GBCE: ground-based communication equipment
GPS: Global positioning satellite
HUD: Head-up display within aircraft cockpit or RPAS workstation
ICM: Interactive Controller Module
image streaming camera: A camera sending image frames at high speed of frames per second
Incursion: Any occurrence at an aerodrome involving the incorrect presence of an aircraft, vehicle, or person on the protected area of a surface designated for the landing, takeoff or taxiing of aircraft
junction: An intersection of any combination of taxiways and/or runway. In the air a junction refers to a FIX or NAVAID
LGRC: Landing Gear Reporting Cameras
MDC: movement detection cameras
NOTAM: notice to airmen
object: A material thing that can be seen and touched.
operator: a human or robot or autonomous device operating an aircraft of any type or any type of airside vehicle or any type of airside object
operation: Taxiing, crossing, lineup, takeoff, landing, entering, stopping, clearing, climbing, slowing, speeding up, descending, turning, holding, pushback, rolling, attaching, detaching, following, docking, undocking, fueling, recharging
pilot: any operator within a cockpit, or remotely controlling an airside object
RF: radio frequency
RNAV: IFR navigation utilizing GPS
route: A sequence of several taxiways and/or junctions and/or crossings and/or holding positions and/or gates within or near the airport. A route may also be in the air where it comprised of altitudes, speeds, holding patterns, points such as NAVAID, GPS routes, airways and the like. A route may also include the runway for taking off and/or runway for landing.
RPAS: Remotely Piloted Aircraft System
runway: A paved section used mostly for takeoffs and landings by aircrafts
runway operation: Operations of aircraft and/or vehicles and/or humans located on the runway
SAMM: Strategic Airline Monitoring Module
selection menu: a list consisting of multiple items to be chosen/selected by an operator
sensor: Physical sensor, or satellite data with position information replacing measurement or functionality of said sensor
sequencing: The decision of priority depending on operation
signal: a frequency sent from a transmitter device to a receiver
SMGCS: Advanced Surface Movement Guidance & Control System
taxiway: A paved section between 2 points to be used by aircrafts and airside vehicles
TD: Touch down
UAV: unmanned aerial vehicle
vehicles: Any form of car, truck, including ambulance, fire and police
wake areas: areas affected by wake affecting operations of other objects
wake dissipation: the weakening rate, position and strength of turbulence generated by an aircraft
WCL: wireless communication link

The following discusses various aspects or Air Traffic Control (ATC) in airports within the scope of this invention, particularly in the areas of ATC operations relating to at or an airport or airside or any of their associated operations. The aspects are discussed in the form of problems, with provided solutions within the scope of this invention.

First problem dealt with by the present disclosure relates to the large amount of repetitive and manual routine calculations, logic and operations performed by ATC, requiring constant awareness and high level of skill in adherence to rules, precision in timing and error-free multitasking, with low or no visibility to see out of the tower in severe weather and bad runway conditions and, the need to control and monitor multiple aircrafts with different operations or stages of flight, including holding patterns, holding short for a landing prior to lineup for takeoff, lining up for a takeoff on the runway, rolling for takeoff, aborting a takeoff, contacting departure, on a final approach for landing, Missed Approach or go-around, clearing the threshold area so another aircraft can line up for a takeoff, exiting or crossing the runway, moving and following and waiting on taxiways and taxiway crossings, closing and opening runways, dispatching emergency vehicles and personnel in case of emergency, closing and diverting aircraft in case of emergency or FOD clearing operations.

The second problem dealt with by the present disclosure is the inability of a tower ATC to remotely activate a go-around or missed approach procedure.

The third problem dealt with by the present disclosure is that pilots do not have complete and updated information associated to their operation within an aerodrome.

The forth problem dealt with by the present disclosure is the inability to efficiently control an aircraft from the ground if it was hijacked or is off-course, or pilots lost control.

The fifth problem dealt with by the present disclosure is the dangers and safety issues resulting from call-sign similarities where Pilots execute ATC orders that were not directed to them, for example, ATC will issue “AC4554 follow company to 18L and hold short”, but due to the similarity, the Pilot of AC4454 may mistakenly execute command. At times, the AC4454 aircraft will provide a read-back, and the AC4554 aircraft will assume the command was for AC4454. ATC does not always notice the read-back was from the wrong aircraft. There are three types of aircraft call-sign similarities. First type is similar flight numbers for the same Airline operator, for example, AC4554 and AC4454. Second type is different airline operators with same or similar flight numbers, for example, AA4554 and AC4554, and third, is different airline operators with similar flight numbers, for example AA4554 and AC4454.

The sixth problem dealt with by the present disclosure is the time taken on the ATC frequency due to Pilot read-back operations. The time typically increases in two cases, first, when the flight-crew and ATC differ in speech, language or dialect, and second, when ATC provides many parameters within the ATC command to be repeated by the Pilot's read-back. In most cases, Pilots typically request a “say again” and ATC will repeat either the whole command or some of the parameters, this increases the frequency time, time of ATC and Pilot by over thirty percent.

The seventh problem dealt with by the present disclosure is the limitation and congestion of runway ATC frequency due to the large amount of data given to flight crew during the clearance of a takeoff or landing, for example, ATC typically issues a landing clearance with wake turbulence advisory from previous aircraft operation on the runway, winds, exit to take after the landing and the new ATC frequency for Ground ATC, and, possibly runway condition with reported breaking action during bad weather conditions.

The eighth problem dealt with by the present disclosure is the static nature of the information given by ATC during a takeoff and landing operation, which is not updated during the operation, for example, after an aircraft is issued a landing clearance by ATC with the wind direction and speed information during gusting wind conditions, the wind speed increases and the wind direction suddenly changes, the initial information given by ATC with the landing clearance is no longer valid and may become a hazard to aircraft safety.

The ninth problem dealt with by the present disclosure is the congestion of the ATC frequency for issuing routine runway exit instructions and ATC frequency change as the aircraft enters the area of another ATC. This also may include the different directives from the previous controller to the new controller, as each controller has their own mandate and way of controlling their area.

The tenth problem dealt with by the present disclosure is that any changes made by ATC after the clearance given at the gate force the flight crew to manually change the relevant onboard FMS [130] and/or CPDLCDU [140] to reflect any changes assigned by ATC, for example: the flight crew received a clearance at the gate to depart through a particular RNAV SID from a particular runway, but ATC reassigned a new runway for takeoff with a different departure RNAV, this situation forces the flight crew to re-enter data to the relevant FMS [130] and/or CPDLCDU [140], thus raising the probability of human error during the entry, lowering overall airport safety as the flight may be delayed on the runway and, directly affects nearby aircraft and associated airport operations.

The eleventh problem dealt with by the present disclosure is the inability to automatically ground all airborne traffic and halt all airport operations in case of a terrorist attack or other security concern at any geographical area having air navigation service coverage.

The twelfth problem dealt with by the present disclosure if the aircraft landing gear mechanism may not be locked prior to a landing, and, a controller may not be able to see or reliably assess from the tower if the landing gear is locked due to several visibility conditions and contributing factors, such as fog, smog, dust, low cloud formation, precipitation, brightness of the sun, or darkness at night.

The thirteenth problem dealt with by the present disclosure is when a runway closes due to a sudden emergency, and all landing traffic on final approach must be diverted to another runway or even another airport. In the event of an emergency, the controller workload is increased substantially, as many tasks must be performed, such as dispatching emergency vehicles and personnel to the area of incident, relaying the information to ground and arrival controllers to divert additional traffic to and from the runway. In addition, the controller must notify all aircraft on their final approach to execute a go-around or missed approach.

The fourteenth problem dealt with by the present disclosure is the large waste of fuel due to inefficient taxiway routes and waiting in intersections, changing taxi speeds and holding for takeoff on the runway.

The fifteenth problem dealt with by the present disclosure is the inability of maximizing the number of runway takeoff operations per runway due to human limitations in calculating the length of runway and time needed for a takeoff rollout for each aircraft type.

The sixteenth problem dealt with by the present disclosure is the issues of radio frequency jams created by unauthorized radio stations operating on the ATC radio frequency so neither ATC nor Pilots can efficiently talk on the frequency.

The seventeenth problem dealt with by the present disclosure is the inability to efficiently balance future takeoff operations between several runways.

The eighteenth problem dealt with by the present disclosure is that expedite instructions by ATC to pilots may not be executed by the pilot in time the controller expected it to be, whereby the expedite operation is affecting the overall safety of the area of the operation as well as other areas that may be associated to that operation. This is the highest safety problems in airports today, especially associated to runway crossing operations at very busy airports, as many incidents are registered at an alerting rate.

The nineteenth problem dealt with by the present disclosure is the information, notification and warnings given by ATC with a takeoff or landing clearance over the radio frequency. The information is only provided once and is not available to the flight crew at all times. In addition, the repetitive information such as winds, runway conditions and breaking action waste radio frequency time.

The twentieth problem dealt with by the present disclosure is the lack of situational awareness of a Pilot in regards to surrounding traffic and associated airport operations that may affect the current or next operation. Pilots rely on what is being said over the radio frequency, and a combination of speed and language barriers may reduce pilot situational awareness.

The twenty first problem dealt with by the present disclosure is the high manual workload involved in coordinating takeoffs between Tower and departures ATC positions, where each flight needs to be approved manually by the departures ATC prior to a takeoff clearance.

The twenty second problem dealt with by the present disclosure is the high manual workload of tower controller for compiling data from vast number of decision support tools and systems, to make a decision. In essence, the workload is reduced, but the time required to make a decision by a controller may take longer due to the number of inputs that are taken into account. As a direct result, a controller looks at the decision support screens more than before, and, less time is available to look at the conditions outside the tower. Also as a direct result, the controller will lose situational awareness of other aircraft traffic, and is one of the primary reasons in the ride of safety associated incidents at airports in recent times.

The twenty third problem dealt with by the present disclosure is the inability to control aircraft responding poorly to an expedite directive, or not fully clearing an intersection or junctions.

The twenty forth problem dealt with by the present disclosure is the time it takes for emergency vehicles to reach an emergency aircraft after a landing, whereby standards provide 5 minute response time, yet, smoke in an aircraft spreads in less than 2 minutes.

The twenty fifth problem dealt with by the present disclosure is the lack of information available to a pilot to make a go-around decision when the risk of overshooting the runway when over the TD too high and too fast, especially due to bad runway conditions and breaking action.

The twenty sixth problem dealt with by the present disclosure is the repetitive information given by tower controller to each departing or arriving aircraft, such as altimeter settings or winds.

The twenty seventh problem dealt with by the present disclosure is the inefficiency and incompleteness of the process of Controller-Pilot negotiations of taxi routes between two points within an airport, as described in patents U.S. Ser. No. 08/401,775 and US 20100198489A1, it is also common for ATC to repeat the same process to multiple aircrafts within the same day that have to taxi from the same two points, such as several departing flights from the same terminal taxiing to the same departing runway which is the most common scenario in most International airports.

The twenty eighth problem dealt with by the present disclosure is that FOD still requires the manual closure of a runway or taxiway by ATC, and traffic diverted, thus lowering the overall airport capacity.

The twenty ninth problem dealt with by the present disclosure is the lack of common interface between systems relating to aerodrome operations and associated data.

The thirtieth problem dealt with by the present disclosure is that taxi route calculations do not provide the best possible taxi route between two points.

The thirty first problem dealt with by the present disclosure is that aircraft crossing junctions and runways may stop after the junction, while not completing the operation to be in a safe distance from the junction.

The thirty second problem dealt with by the present disclosure is that no known existing art nor implementations nor current patent applications nor granted patents providing pilots with complete information during airport operations that directly affect fuel costs, airport safety, capacity and efficiency, including U.S. Pat. No. 7,813,845 B1 and the earlier US2004/0006412A1, US2008/0270020A1, US2011/0196599A1, WO2006125725A1, U.S. Pat. No. 8,242,950B2, U.S. Pat. No. 8,424,472B2, U.S. Pat. No. 7,974,773B1, U.S. Pat. No. 8,180,562B2 and the earlier 2009/0306887A1, U.S. Pat. No. 8,599,045B2, US2009/0306887, 2013/0201037A1, EP2506237A1, US79999699B2, US2011/0313645A1, U.S. Pat. No. 7,737,867B2, U.S. Pat. No. 8,373,579B2, EP2259245A2,US2003/0045994A1, U.S. Pat. Nos. 7,933,714B2, 7,343,229B1, U.S. Pat. No. 6,751,545B2, US2012/0158277A1, U.S. Pat. No. 8,401,775B2, US2009/0051570A1, U.S. Pat. No. 7,109,889B2, U.S. Pat. No. 7,813,845B2, U.S. Pat. No. 8,594,916B2, U.S. Pat. No. 8,290,643B2, U.S. Pat. No. 7,706,973B2, EP2533014A1, U.S. Pat. No. 8,386,167B2, U.S. Pat. No. 7,567,187B2, U.S. Pat. No. 8,560,214B2, U.S. Pat. No. 8,560,214B1, US2012/0253649A1, U.S. Pat. No. 7,860,641B2, U.S. Pat. No. 8,280,618B2 and earlier US2011/0196599A1 as well as the known common set of patents of US2004/0225432A1 and the earlier U.S. Pat. No. 6,751,545B2, and the earlier U.S. Pat. No. 6,314,363 and the earlier U.S. Pat. No. 5,867,804 and the earlier U.S. Pat. No. 5,548,515

The thirty third problem dealt with by the present disclosure is the lack of pilot situational awareness.

The thirty forth problem dealt with by the present disclosure is the lack of awareness and control a pilot has at or near the sleeve at the terminal gate. Relying on human ground personnel to provide with signals for thrusts and maneuvering. It is a known problem that the ground personnel make mistakes with several incidents that prove the need for a solution

The thirty fifth problem dealt with by the present disclosure is inability to ground multiple airborne aircraft efficiently, in case of area emergency such as September 11.

The thirty sixth problem dealt with by the present disclosure is the workload and coordination efforts required to close a runway for maintenance, directly impacting overall airport capacity and operational delays.

The thirty seventh problem dealt with by the present disclosure is lack of pilot response time to ATC commands, lowering the airport capacity.

The thirty eighth problem dealt with by the present disclosure is lack of situational awareness a pilot encounters within an airport especially during runway and taxi operations.

The thirty ninth problem dealt with by the present disclosure is lack of information from an aircraft, especially regarding cockpit operations, especially flight information, cockpit conversations between pilots during emergency situations requiring replication and/or playback for safety and investigative authorities.

The fortieth problem dealt with by this disclosure is the congestions on the taxiways and junctions due to the lack of optimization of pushback timing from multiple gates and stands.

The forty first problem dealt with by this disclosure is the waste of taxi times and fuel to the runway.

The forty second problem dealt with by this disclosure is that at most airports around the world, taxiing priority is given on a first-come first-serve basis.

The forty third problem dealt with by this disclosure is that taxi speeds are not assigned nor static and precious fuel is wasted at each junction due to inefficient taxi speed management of multiple aircrafts without the need to stop.

The forty forth problem dealt with by this disclosure is that controllers repeatedly use the same routes for aircrafts inefficiently and repeat saying the route instructions.

The forty fifth problem dealt with by this disclosure is that the pilot does not always have updated information associated to braking action relevant for the aircraft type flown.

The forty sixth problem dealt with by this disclosure is that the pilot does not have sufficient information to make proper DH (decision height) in poor braking or poor runway conditions by using onboard equipment.

The forty seventh problem dealt with by this disclosure is that the pilot does not have the information for the fastest routes available to gate from the runway after landing.

The forty eighth problem dealt with by this disclosure is that there is no way to externally marshal aircraft brakes in case the aircraft is entering a restricted area, making a wrong turn, not abiding to assigned routes, or not stopping at junctions and the alike.

The forty ninth problem dealt with by this disclosure is that a pilot does not have any way to select from fastest routes from gate to runway or vice versa.

The fiftieth problem dealt with by this disclosure is that the congestion at most medium and large airports increase delays and fuel costs.

The fifty first problem dealt with by this disclosure is that the congestion at most medium and large airports decreases safety.

The fifty second problem dealt with by this disclosure is that the congestion at most medium and large airports decreases efficiency and capacity.

The fifty third problem dealt with by this disclosure is that there is no physical mean to stop incursions.

The fifty forth problem dealt with by this disclosure is that incursions are sometimes unobserved by ATC or by pilots without early warnings for all stakeholders.

The fifty fifth problem dealt with by this disclosure is that wake separation does not account for the combination of crosswinds and multiple dependent operations Solution

The fifty sixth problem dealt with by this disclosure is that Pilots may not adhere to the given routing instructions.

The fifty seventh problem dealt with by this disclosure is that real-time operating conditions are not readily available to pilots, unless provided by controllers.

The fifty eighth problem dealt with by this disclosure is that static maps by pilots aboard the aircraft and where actual applicable and closed runways, taxiways and junctions are given in periodical updates but not real time.

The fifty ninth problem dealt with by this disclosure is that the liability of visual separation is wrongly transferred from the controller to the pilots when it should remain the controller's obligation, especially when given cleared to land or cleared for takeoff.

The sixtieth problem dealt with by this disclosure is the need for ATC to confirm front gear lock for every aircraft when time permits.

The sixty first problem dealt with by this disclosure is the lack of all-weather, zero-visibility situational awareness of vehicle drivers and airside personnel.

The sixty second problem dealt with by this disclosure is the lack of scheduling slots for airside maintenance, causing runway closures for long periods.

The sixty third problem dealt with by this disclosure is the inability for ATC to effectively provide ATC services in all-weather or zero visibility conditions.

The sixty forth problem dealt with by this disclosure is the fatigue and declined attention span of controller s due to the constant monitoring and processing of data from numerous screens and gages that provide operational information.

The sixty fifth problem dealt with by this disclosure is that there is no known technical solution providing a single and unified system for controlling multiple runways at an airport served by multiple towers.

The sixty sixth problem dealt with by this disclosure is there is no technical solution that provides stackable redundant backups either locally at each airport or remotely.

The sixty seventh problem dealt with by this disclosure is there is no technical solution allowing an automated control or a single controller to provide ATC services for multiple towers at multiple airports.

The sixty eighth problem dealt with by this disclosure is that a human departures controller makes mistakes and is limited in human capacity in providing request release with departure climb, heading and time slotting assignment per flight, spanning on multiple runways at multiple airports.

The sixty ninth problem dealt with by this disclosure is that approach controller uses static wake separation model to separate arrivals for final approach.

The seventieth first problem dealt with by this disclosure is that the English spoken by a controller may not be understood by pilots due to dialect or strong accent.

The seventy first problem dealt with by this disclosure is there is no standalone system allowing pilots to see traffic and operational conditions at airports in bad or zero visibility conditions.

The seventy second problem dealt with by this disclosure is that ATC recording equipment is separate from SMGCS systems and is prone to loss of data.

The seventy Third problem dealt with by this disclosure is that gate and stand scheduling and assignments are mostly manual, inefficient and erroneous, even if an A-CDM is present at the airport.

The seventy forth problem dealt with by this disclosure is that there is no technical solution for solving a loss in voice communication between controller and a pilot.

The seventy fifth problem dealt with by this disclosure is the lack of knowledge of bird associated information to the pilot, and is sometimes provided by a controller.

The seventy sixth problem dealt with by this disclosure is the inability to safely and effectively control the movements (such as speed, altitude height, heading, descent, climb, vector and the like) of aircrafts having autonomous flying capabilities (such as aircraft, RPAS, UAV, drones and the alike) at or nearby an airport.

The seventy seventh problem dealt with by this disclosure is the decreasing number of pilots and the rise of physical aircrafts, with the future of autonomous or remote controlled commercial and cargo flights.

The seventy eighth problem dealt with by this disclosure is the inability for an airport to efficiently operate as the number of qualified controller s is declining, or, during controller strikes.

The seventy ninth problem dealt with by this disclosure is the inability of remote piloted aircrafts and other remotely controlled aircrafts, to interact with an ATC system for airports.

The eightieth problem dealt with by this disclosure is the ineffective way to switch between active runway configurations as winds change or due to emergencies.

The eighty first problem dealt with by this disclosure is the inefficient and error prone process between Controllers and pilots for clearance delivery prior to pushback. Today, the process includes filing a flight plan at an airport pilot facility periodic with weather maps and models, then once in the cockpit prior to pushback, the controller issues a clearance delivery for the pilot to read-back and enter to the FMS. The delivery, confirmation and entry process to the FMS pose many language and accent barrier issues, waste of resources from both Controllers and pilots.

Embodiments of the invention provide a standalone automated Air Traffic Control (ATC) system for managing airport operations at any airport or airside or its nearby area, for all aircrafts and vehicles, by listening to pilots over the ATC radio frequency, communicating data to aircraft avionics and through text or graphical-based mapping over some type of CPDLC for Pilot interaction, or, through existing air/ground communication infrastructure with onboard computer via touch-screen or HUD while saying the commands and information through a speaker in pilot preferred language.

Embodiments of the invention use ATC radio frequency for sending ATC voice commands to all aircrafts on the frequency, and recognizing Pilot's voice for requests and responses to commands.

Embodiments of the invention use automated information updates to a pilot during takeoff and landing operations in the form of text or pictures.

Embodiments of the invention use identification and avoidance congestions on taxiways, junctions and hotspots when assigning routing for taxiing to and from a runway.

Embodiments of the invention use optimization for runway and taxiway operations for lowering delays.

Embodiments of the invention maximize the number of takeoff operations for any long runway by allowing more aircrafts to safely takeoff from junctions instead of the initial lineup position at the start of the runway.

Embodiments of the invention automatically balance workloads of takeoff operations on multiple runways.

Embodiments of the invention allow Pilots to select preferred runways, runway exits and fastest routes for taxiing to and from runways.

Embodiments of the invention provide a notification to flight crew when the front landing gear is not locked prior to a landing operation.

Embodiments of the invention send control messages between the system and aircraft avionics. The Control Messages are used to both communicate with the flight crew and communicate with the avionics aboard the aircraft.

Embodiments of the invention provide a system for triggering the autopilot of an aircraft and sending commands directly to the FMS for the aircraft to execute. The autopilot trigger is turned on in case of hijack, distress, or when aircraft deviates from its flight plan.

Embodiments of the invention provide an automated method to ground all airborne aircraft at any given airspace.

Embodiments of the invention use data communication for reducing the reliance of radio frequency as the primary medium for ATC services.

Embodiments of the invention automatically simultaneously manage and synchronize operations on multiple runways.

Embodiments of the invention automate the handoff operations with Ground ATC, Departure ATC and Arrivals ATC.

Embodiments of the invention automatically flash the runway lights to notify the Pilot of a landing aircraft when the Runway or airport is closed.

Embodiments of the invention automatically flash the runway exit lights for a landing aircraft to direct the Pilot where to exit and lower human errors. The flashing exit AFL (airfield lighting) [10] also operate at every taxiway junction.

Embodiments of the invention trigger aircraft breaks when an aircraft is taking a wrong turn at a junction or aircraft continues past a hold short bar. The objective can be induced automatically or manually by a Tower/Ground controller.

Embodiments of the invention directly lower fuel costs during taxiway operations.

Embodiments of the invention record and retain all data from all airport sensors, all image data from cameras located at or nearby the airport, all data and voice from cockpits of all aircraft at or nearby the airport that are normally sent to each aircraft's black-box, all commands and displayed images onboard the dynamic map interface for each aircraft at or nearby the airport, all data displayed on CPDLC for each aircraft at or nearby the airport, all relevant data provided by external systems interacting with the system.

Embodiments of the invention allow controllers to manage settings and preferences to be used by the system for preferred taxi routes, runway and airport capacity, emergency response, handoff with other controllers and alike.

Embodiments of the invention warn a pilot to go-around when the landing aircraft may overshoot a runway due to current runway conditions, breaking action, aircraft altitude and speed.

Embodiments of the invention calculate future weather and associated airport capacity based on collected weather-associated data from aircrafts systems at or nearby an airport.

Embodiments of the invention notify emergency personnel of aircraft emergency situation with aircraft data and fastest route to take to the anticipated final resting position of the aircraft.

Embodiments of the invention re-route all aircrafts affected by emergency situation or hotspots or ground-traffic congestions to the best possible route for aircraft desired operation.

Embodiments of the invention share and interchange data with Airport collaborative decision making systems, Airport Operations Centers, Flow centers, ATM centers and network operation Centers.

Embodiments of the invention ensure the efficient selection of taxi routes to and from different locations within an airport

Embodiments of the invention communicate data with other external systems by using system embodiments and implementations to standards in protocols and framework for data interchange set by EUROCONTROL SESAR SWIM framework and alike.

Embodiments of the invention control the engines and steering of the aircraft when the pilot has not cleared the junction for other safe operations, where the system will communicate to the aircraft power controls and steering controls and break control system, to produce the proper power and steering and break combination required for the aircraft to be in safe distance from the junction.

Embodiments of the invention provide a pilot a selection list of available routes, with time for each route, with optional progressive taxiing, or a complete taxi route. All options will include estimated total time for taxi to destination from current location

Embodiments of the invention provide a pilot better situational awareness and overall airport safety, through the display of distance until a junction, or a turn to be taken

Embodiments of the invention provide a pilot better situational awareness through the ability to set measurement preferences for distances, speeds and alike, such as meters and feet, km and miles, kph and mph, and alike

Embodiments of the invention provide a pilot better situational awareness through the ability to set a view or satellite image of the airport, or an airport diagram, as some pilots are more oriented to satellite images

Embodiments of the invention pilot better situational awareness and increase security within designated areas, provide a visual and audible warning to the pilot when in the direction nearing a restricted airport area. If the aircraft is too close and remains on course to the restricted area, security personnel are dispatched and a warning is also displayed and heard by the administrating tower controller.

Embodiments of the invention provide a pilot better visual representation of the surface and gate sleeve to make better gate maneuvering decisions during taxi operations such as pushback and alike.

Embodiments of the invention reduce operating costs for air navigation service operators, associated in direct costs of highly skilled labor, training and system overheads, by reducing the amount of controller workload, and thus reduce the number of Controllers needed at the tower at any given time.

Embodiments of the invention provide all airside personnel and vehicles with a handheld device, providing personnel the same functionality for maximized situational awareness and taxi routing, with the additional functionality of requesting to a maintenance window or to immediately close or open any runway, taxiway, junction or area for maintenance or security reasons, such as debris removal and replacing AFL (airfield lighting).

The system includes a Server [300], Landing Gear Reporting Cameras (LGRC) [355], Weather sensors [356] including but not limited to Anemometers, Altimeters, clouds, precipitation/rainfall and the like, Aircraft Position Reporting Sensors (APRS) [353] and Movement Detection Cameras (MDC) [354]. In addition, the computer programs associated with the system include Airport Management Software (AMS) [320], an Interactive Controller Module (ICM) [330], Emergency Dispatch Module (EDM) [331] with an Emergency Announcement System (EAS) [340], and, a Strategic Airline Monitoring Module (SAMM) [339].

The system uses the following equipment and technologies for communicating with aircrafts and Pilots: a wireless communication link (WCL) [600]; ground-based communication equipment (GBCE) [310]; aircraft CPDLC communication unit [110]; aircraft FANS communications unit [120]; aircraft Flight Management System (FMS) [130]; aircraft CPDLC Display Unit (CPDLCDU) [140]; an aircraft Autopilot [150]; various Aircraft Position Reporting Devices (APRD) [350] including: input from external systems, Radar [351] and GPS [352]. In addition the said CPDLCDU [140] and associated infrastructure embodiment and implementation, another embodiment of the system may also use equipment and infrastructure consisting of a Dynamic Map (DAM) [161] executed on a Cockpit Computer System (CCS) [160] to provide seamless bidirectional interface between Pilot and flight crews with the AMS [320] via DAM [161] running on CCS [160] linked via any type of Air/Ground communication supporting infrastructures [610], such as Satellite, Wi-Fi, Cellular and the alike.

### BRIEF DESCRIPTION OF THE DRAWINGS

FIG. 1 is a perspective view of the hardware, computers and devices used by the system, in accordance with an example embodiment.

FIG. 2 is a diagram that further illustrates the uplink and downlink data flow between the Server [300] and each of the communication systems aboard the aircraft [100], in accordance with an example embodiment.

FIG. 3a illustrates a flow diagram of the processes in a method within the AMS [320] involved in sending a Control Message to FANS or FMS or CPDLCU [140] for processing, in accordance with an example embodiment.

FIG. 3b illustrates a flow diagram of the processes in a method within the AMS [320] involved in sending a Control Message to DAM [161], in accordance with an example embodiment.

FIG. 4 illustrates a block diagram of the data communication in methods involved in sending a Control Message between the AMS [320] and the various onboard aircraft equipment [110,120, 130,140,150], in accordance with an example embodiment.

FIG. 5 lists an example of Control Messages sent to the aircraft [100] by the AMS [320], in accordance with an example embodiment. The example embodiment showing CPDLCDU [140] also refers to control messages supported by DAM [161].

FIG. 6 lists an example of incoming Control Messages sent from the various onboard aircraft equipment [110,120,130,140,150,160] to the AMS [320], in accordance with an example embodiment. The example embodiment showing CPDLCDU [140] also refers to control messages supported by DAM [161].

FIG. 7 lists an example of ATC commands processed by the AMS [320] as voice commands over the ATC radio frequency, in accordance with an example embodiment.

FIG. 8 illustrates an example of locations for all types of Aircraft Position Reporting Device (APRD) [350], Movement Detection Cameras (MDC) [354] and Landing Gear Reporting Cameras (LGRC) [355] in relation to a Runways and taxiways, used by the AMS [320] for updating the aircraft locations database [1010], in accordance with an example embodiment.

FIG. 9 illustrates an example of network topology for an Airport with Server [300] connectivity with ICM [330], EDM [331] and SAMM [339], in accordance with an example embodiment.

FIG. 10 illustrates the relationships between the various databases used by AMS [320], in accordance with an example embodiment.

FIG. 11 illustrates a flow diagram of the processes in a method within the AMS [320] involved in issuing a “lineup and wait” ATC command to an aircraft, in accordance with an example embodiment.

FIG. 12 illustrates a flow diagram of the processes in a method within the AMS [320] involved in issuing a takeoff clearance ATC command to an aircraft, in accordance with an example embodiment.

FIG. 13 illustrates a flow diagram of the processes in a method within the AMS [320] involved in issuing a landing clearance ATC command to an aircraft, in accordance with an example embodiment.

FIG. 14 illustrates a flow diagram of the processes in a method within the AMS [320] involved in updating CPDLCDU [140] or DAM [161] while an aircraft is rolling during a takeoff operation [320] with the possibility the takeoff will be aborted, in accordance with an example embodiment.

FIG. 15 illustrates a flow diagram of the processes in a method within the AMS [320] involved in updating CPDLCDU [140] or DAM [161] while an aircraft is breaking during a landing operation, in accordance with an example embodiment.

FIG. 16 illustrates a flow diagram of the processes in a method within the AMS [320] involved with managing a Go-Around or Missed Approach, in accordance with an example embodiment.

FIG. 17 illustrates a flow diagram of the processes in a method within the AMS [320] involved with accepting an aircraft handoff from Approach ATC, in accordance with an example embodiment.

FIG. 18 illustrates a flow diagram of the processes in a method within the AMS [320] involved with an aircraft handoff operation to Departure ATC, in accordance with an example embodiment.

FIG. 19 illustrates a flow diagram of the processes in a method within the AMS [320] involved with automatically accepting an aircraft handoff from Ground ATC, in accordance with an example embodiment.

FIG. 20 illustrates a flow diagram of the processes in a method within the AMS [320] involved with an aircraft handoff operation to Ground ATC, in accordance with an example embodiment.

FIG. 21 illustrates a flow diagram of the processes in a method within the AMS [320] involved in Timing runway crossings during landing operations, in accordance with an example embodiment.

FIG. 22 illustrates a flow diagram of the processes in a method within the AMS [320] involved in simultaneously managing multiple runway operations, in accordance with an example embodiment.

FIG. 23 illustrates a flow diagram of the processes in a method within the AMS [320] involved with predicting taxiway congestions and hotspots, in accordance with an example embodiment.

FIG. 24 illustrates a flow diagram of the processes in a method within the AMS [320] involved in avoiding congested taxiways and hotspot crossings when assigning routing to and from a runway, in accordance with an example embodiment.

FIG. 25 illustrates a flow diagram of the processes in a method within the AMS [320] to maximize takeoff operations on long runways, in accordance with an example embodiment.

FIG. 26 illustrates a flow diagram of the processes in a method within the AMS [320] involved in issuing a turbulence advisory during landing or takeoff clearance, in accordance with an example embodiment,

FIG. 27 illustrates a flow diagram of the processes in a method within the AMS for displaying ATC commands and allowing Pilot confirmation through the CPDLCDU [140] or DAM [161], in accordance with an example embodiment.

FIG. 28 illustrates a flow diagram of the processes in a method within the AMS [320] to automatically recognize and reply to Pilot requests over ATC voice frequency, in accordance with an example embodiment.

FIG. 29 lists an example of the recognized Pilot requests and responses over existing ATC voice frequency supported by the system, in accordance with an example embodiment.

FIG. 30 illustrates the location of the exit flashing AFL (airfield lighting) [10] to notify a Pilot where to exit the runway, in accordance with an example embodiment.

FIG. 31 illustrates the location of the closed runway flashing AFL (airfield lighting) [10] to notify Pilots of a closed runway, in accordance with an example embodiment.

FIG. 32 illustrates a flow diagram of the processes in a method within the AMS [320] to dispatching emergency personnel when the Landing Gear is not locked, in accordance with an example embodiment.

FIG. 33 lists the types of CPDLCDU [140] screens available to the Pilots and flight crews sent from the AMS [320], in accordance with an example embodiment. The example embodiment showing CPDLCDU [140] also refers to control messages supported by DAM [161].

FIG. 34a illustrates an example output of the onboard CPDLCDU [140] associated to a “hold short” ATC directive on a runway prior to a takeoff clearance to a specific aircraft, in accordance with an example embodiment.

FIG. 34b illustrates an example pilot interface of the onboard DAM [161] associated to a “hold short” ATC directive on a runway prior to a takeoff clearance to a specific aircraft, in accordance with an example embodiment.

FIG. 35a illustrates an example output of the onboard CPDLCDU [140] associated to a “lineup and wait” ATC directive on a runway prior to a takeoff clearance to a specific aircraft, in accordance with an example embodiment.

FIG. 35b illustrates an example pilot interface of the onboard DAM [161] associated to a “lineup and wait” ATC directive on a runway prior to a takeoff clearance to a specific aircraft, in accordance with an example embodiment.

FIG. 36a illustrates an example output of the onboard CPDLCDU [140] that shows a generated ATC command and associated information for a takeoff clearance to a specific aircraft, in accordance with an example embodiment.

FIG. 36b illustrates an example pilot interface of the onboard DAM [161] that shows a generated ATC command and associated information for a takeoff clearance to a specific aircraft, in accordance with an example embodiment.

FIG. 37a illustrates an example output of the onboard CPDLCDU [140] during the takeoff roll of an aircraft, in accordance with an example embodiment.

FIG. 37b illustrates an example pilot interface of the onboard DAM [161] during the takeoff roll of an aircraft, in accordance with an example embodiment.

FIG. 38a illustrates an example output of the onboard CPDLCDU [140] after the aircraft is airborne, in accordance with an example embodiment.

FIG. 38b illustrates an example pilot interface of the onboard DAM [161] after the aircraft is airborne, in accordance with an example embodiment.

FIG. 39a illustrates an example output of the onboard CPDLCDU [140] that shows a generated ATC command and associated information for a landing clearance to a specific aircraft, in accordance with an example embodiment.

FIG. 39b illustrates an example pilot interface of the onboard DAM [161] that shows a generated ATC command and associated information for a landing clearance to a specific aircraft, in accordance with an example embodiment.

FIG. 40a illustrates an example output of the onboard CPDLCDU [140] that shows the update sent by the AMS [320] for a breaking operation of a landing aircraft, in accordance with an example embodiment.

FIG. 40b illustrates an example pilot interface of the onboard DAM [161] that shows the update sent by the AMS [320] for a breaking operation of a landing aircraft, in accordance with an example embodiment.

FIG. 41a illustrates an example output of the onboard CPDLCDU [140] that shows the information displayed during a Missed Approach, in accordance with an example embodiment.

FIG. 41b illustrates an example pilot interface of the onboard DAM [161] that shows the information displayed during a Missed Approach, in accordance with an example embodiment.

FIG. 42a illustrates an example output of the onboard CPDLCDU [140] that shows the information displayed for a Go-Around operation, in accordance with an example embodiment.

FIG. 42b illustrates an example pilot interface of the onboard DAM [161] that shows the information displayed for a Go-Around operation, in accordance with an example embodiment.

FIG. 43a illustrates an example output of the onboard CPDLCDU [140] that allows flight crew to request a runway exit from a list of exits, in accordance with an example embodiment.

FIG. 43b illustrates an example pilot interface of the onboard DAM [161] that allows flight crew to request a runway exit from a list of exits, in accordance with an example embodiment.

FIG. 44 illustrates an example output of the onboard CPDLCDU [140] that allows flight crew to select a routing from a list of routes, in accordance with an example embodiment.

FIG. 45 illustrates an example output of the onboard CPDLCDU [140] that allows the flight crew to report a runway breaking action, in accordance with an example embodiment.

FIG. 46 illustrates an example output of the onboard CPDLCDU [140] that allows the flight crew to report runway conditions, in accordance with an example embodiment.

FIG. 47 illustrates an example output of the onboard CPDLCDU [140] that allows the flight crew to report bird activity, in accordance with an example embodiment.

FIG. 48 illustrates an example output of the onboard CPDLCDU [140] that allows the flight crew to report debris on runway, in accordance with an example embodiment.

FIG. 49a illustrates an example of the onboard CPDLCDU [140] menu, in accordance with an example embodiment.

FIG. 49b illustrates an example of the onboard DAM [161] menu, in accordance with an example embodiment.

FIG. 50 illustrates a flow diagram of the processes in a method within the AMS [320] involved with A Pilot runway exit request, in accordance with an example embodiment.

FIG. 51 illustrates a flow diagram of the processes in a method within the AMS [320] involved with calculating breaking speeds and runway exits while an aircraft is landing or aborting a takeoff, in accordance with an example embodiment.

FIG. 52 illustrates a flow diagram of the processes in a method within the AMS [320] involved with calculating aircraft progress on a taxiway, in accordance with an example embodiment.

FIG. 53 illustrates a flow diagram of the processes in a method within the AMS [320] involved with a Request Release operation from Departure ATC, in accordance with an example embodiment.

FIG. 54 illustrates a flow diagram of the processes in a method within the AMS [320] involved with determining if an aircraft cleared a junction, in accordance with an example embodiment.

FIG. 55 illustrates a flow diagram of the processes in a method within the AMS [320] involved with calculating junction congestions and hotspots levels, in accordance with an example embodiment.

FIG. 56 illustrates a flow diagram of the processes in a method within the AMS [320] involved in LGRC [355] image processing for confirming locked gear of a landing aircraft, in accordance with an example embodiment.

FIG. 57 illustrates a flow diagram of the processes in a method within the AMS [320] involved in issuing a “hold short” ATC command to an aircraft, in accordance with an example embodiment.

FIG. 58 illustrates a flow diagram of the processes in a method within the AMS [320] involved with runway capacity balancing and takeoff to landing ratios, in accordance with an example embodiment.

FIG. 59 illustrates a flow diagram of the processes in a method within the AMS [320] involved with Pilot report of breaking action, in accordance with an example embodiment.

FIG. 60 illustrates a flow diagram of the processes in a method within the AMS [320] involved with Pilot report of runway conditions, in accordance with an example embodiment.

FIG. 61 illustrates a flow diagram of the processes in a method within the AMS [320] involved with Pilot report of birds, in accordance with an example embodiment.

FIG. 62 illustrates a flow diagram of the processes in a method within the AMS [320] involved with Pilot report of debris on a runway, in accordance with an example embodiment.

FIG. 63 illustrates a flow diagram of the processes in a method within the AMS [320] involved with taking over an aircraft and activating the autopilot [150], in accordance with an example embodiment.

FIG. 64 illustrates a flow diagram of the processes in a method within the AMS [320] involved with grounding all airborne aircrafts, in accordance with an example embodiment.

FIG. 65 lists the codes for common terms used within the patent application.

FIG. 96 illustrates a flow diagram of the processes in a method within AMS [320] for filtering and merging of data from multiple sources and producing a Dynamic Map for each aircraft with its own relevant map view, information and menu options, and, sending it to DAM [161] to be displayed to pilot.

FIG. 97 illustrates a flow diagram of the processes in a method for triggering the breaks of an aircraft taking a wrong turn or passing the hold-short bar.

FIG. 98 illustrates a flow diagram of the processes in a method for marshalling of aircraft steering and engine power for maneuverability within the airport

FIG. 99 illustrates the interface with a moving airport diagram instead of a dynamic map

FIG. 100 illustrates a block diagram for supported protocols, data interchange models and frameworks to support common requirements and standards such as EUROCONTROL SESAR SWIM and FAA NextGen.

FIG. 101 illustrates a flow diagram of the processes in a method within the DAM [161], involved in processing a Control Message and sending it to AMS [320] to in accordance with an example embodiment

FIG. 102 illustrates a flow diagram of the processes in a method within the DAM [161], involved in processing a pilot voice as a Control Message and sending it to AMS [320] to in accordance with an example embodiment.

FIG. 103 illustrates an example of the process used in recording and storing avionics data as well as cockpit sounds.

FIG. 104 illustrates an example of a pilot selection menu.

FIG. 105 illustrates an example of flow for automated departure control

FIG. 106 illustrates an example of CWP (Controller Working Position) display

### DETAILED DESCRIPTION OF PREFERRED EMBODIMENTS

The following detailed description is merely exemplary in nature and is not intended to limit the invention or the application and uses of the invention. Furthermore, there is no intention to be bound by any expressed or implied theory presented in the preceding technical field, background, brief summary or the following detailed description. The detailed description refers to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined. In order to increase clarity, example embodiments are described with reference to the following drawings, where like numerals refer to like elements throughout. Furthermore, well-known features that are not necessary for the understanding of the example embodiments may not be shown in the illustrations, block diagrams and flow diagrams within the figures are merely illustrative and may not be drawn to scale. In order to emphasize certain features, the drawings may not be to scale. It should be understood that although two elements may be described below, in one embodiment, as being “connected,” in alternative embodiments similar elements may be “coupled,” and vice versa. Thus, although the diagrams shown herein depict example arrangements of elements, additional intervening elements, devices, features, or components may be present in an actual embodiment. The illustrations, drawings, flowcharts and block diagrams in the figures illustrate the architecture, functionality, and operation of possible implementations of Systems, hardware, methods and computer program products according to various embodiments of the present invention. In this regard, each block in the flowchart or block diagrams may represent a module, segment, or portion of program code, which comprises of one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based Systems that perform the specified functions or acts, or combinations of special purpose hardware and computer instructions. The terminology used herein is for the purpose of describing particular embodiments only and is not intended to be limiting of the invention. As used herein, the singular form “a”, “an” and “the” and “with” and “or” are intended to include the plural form as well, unless the context clearly indicates otherwise. It will be further understood that for clarity of explanation within the invention, the term “process” may refer to the term “method” and/or state and/or an event within the method itself. It will be further understood that the term “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As will be appreciated by one skilled in the art, the disclosed subject matter may be embodied as a System, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “System.” Furthermore, the present invention may take the form of a computer program product embodied in any tangible medium of expression having computer-usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor System, apparatus, device, or propagation medium including a portable computer diskette, a hard disk, a random access memory (RAM), a read-only memory (ROM), an erasable programmable read-only memory (EPROM or Flash memory), an optical fiber, a portable compact disc read-only memory (CDROM), a portable pluggable device (USB), an optical storage device, a transmission media such as those supporting the Internet or an intranet, electrical connection with one or more wires, a local area network connection (LAN), a wide area wireless network connection (WAN), or a magnetic storage device. Note that the computer-usable or computer-readable medium could even be paper or another suitable medium upon which the program is printed, as the program can be electronically captured, via, for instance, optical scanning or photographic device with optical character recognition (OCR) processing abilities of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution System, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire, optical fiber cable, RF, Satellite, Cellular network, Microwave transmissions and the like. Computer program code for carrying out operations of the present invention may be written in any combination of one or more programming languages, including an object oriented or procedural programming language or script-enabled language such as C, C++, Pascal, Python, Visual Basic, Perl, Delphi, SQL, lisp, Matlab or the like. The program code may execute entirely or partially, as a stand-alone package, or a program or module or service, on any computer hardware type such as a Server or on any computer or airborne device such as CPDLC [110] or FANS [120] or FMS [130]. Any Server or computer or airborne device such as CPDLC [110] or FANS [120] or FMS [130] may be connected to any other Server or computer or airborne device such as CPDLC [110] or FANS [120] or FMS [130] through any type of network, including a local area network (LAN) or a wide area network (WAN), RF, satellite, or any type of Air Traffic Network (ATN) protocol support for transferring data for the Aircraft industry. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular or any use contemplated.

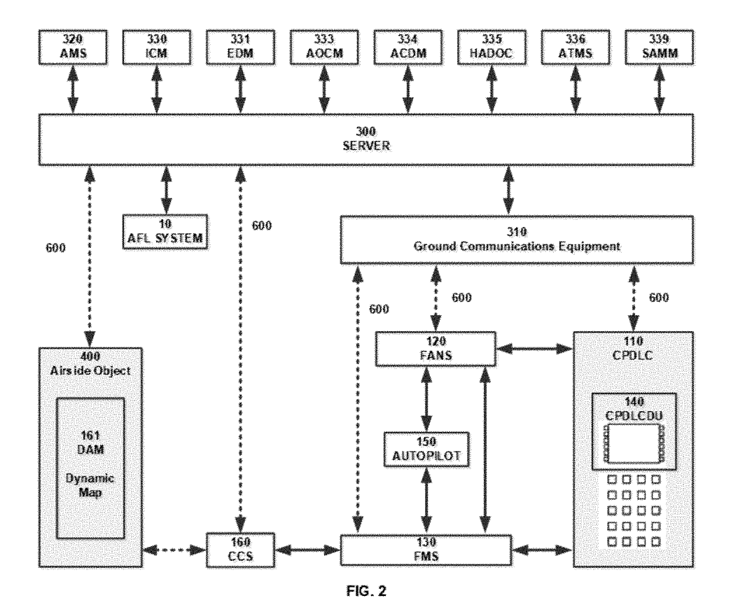

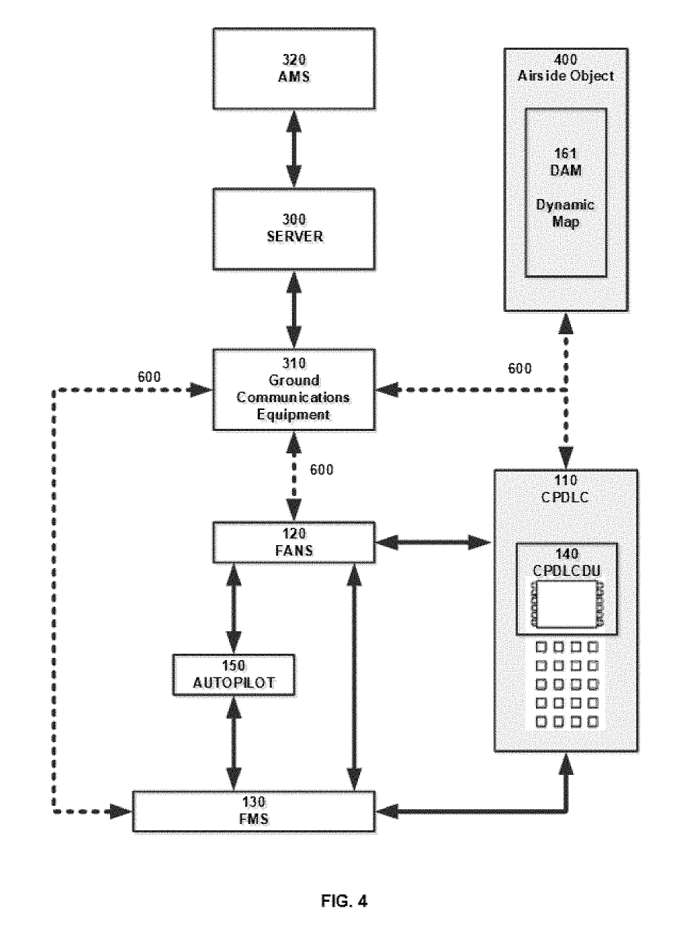

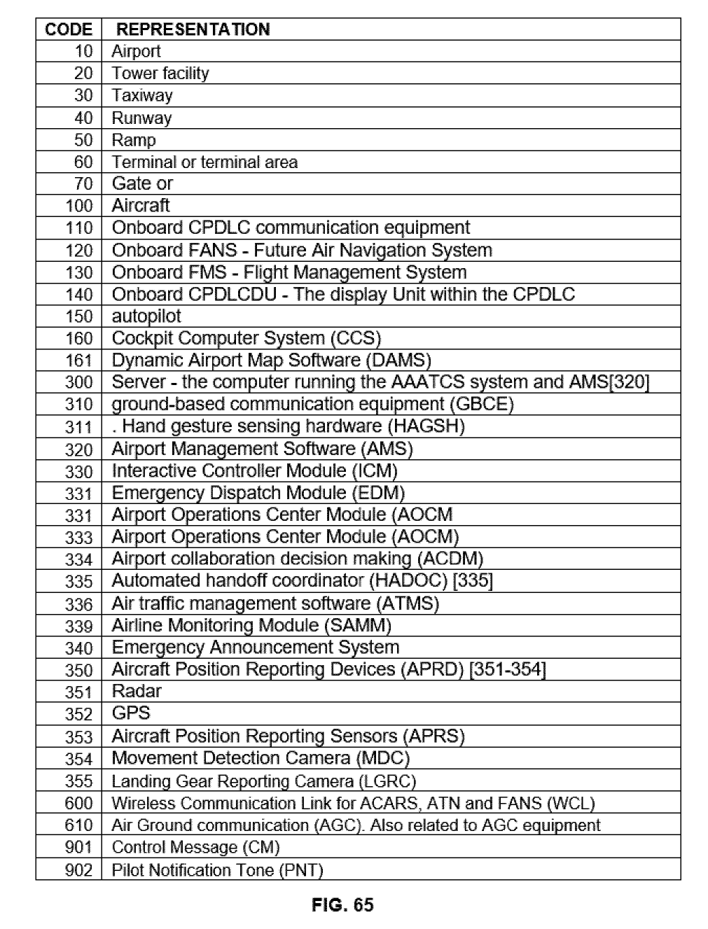

To increase the clarity of the invention, it should be understood that the system is comprised of multiple methods, hardware, software package and embodiments, and therefore all methods and hardware and software package and embodiments should be assumed to rely and be “connected” or “coupled” to at least one or more method or hardware or software package or embodiment within the system, to comprise the AAATCS as an operable and industrialized system. To further increase the clarity and readability of the invention, terms with numerical reference are listed numerically in FIG. 65, and, the following terms are used within the description, figures, illustrations, diagrams, claims and embodiments of the invention application: AAATCS refers to the patent application for a system known as Automated Airport Air Traffic Control System with Flight Takeover. Control Messages (CM) refer to all message types including but not limited to control messages, image data of all formats, binary data, text messages, ASCII codes, weather maps, statuses, whereby the Messages and Control Messages are both used throughout the invention for ease of reading, and mean the same Control Message (CM). To further increase the clarity and readability of the invention, the terms cockpit and flight-deck, or deck, are interchangeable and mean the same cockpit, and unless specified otherwise, it applies to all devices, equipment, display, displays, crew, crew members and pilots. Aircraft [100] refers to any transport vehicle allowed within a controlled aerodrome, able to change altitude and is controlled either by a person or persons within the object, or controlled remotely by a person or persons, or, is controlled by an onboard computer, including but not limited to aircraft, helicopter, unmanned-vehicle (UAV), personal aerial vehicle (PAV), remote piloted aircraft (RPAS), air balloon, shuttle, airborne vehicle, reusable rocket, glider and alike. Server [300] refers to any computer hardware device allowing execution of programs, modules and services on an operating system without the need of human interaction, while allowing connections to and from computers and electronic devices over a network of either wired or wireless connections. Airport, refers to any authorized designated area for aircraft [100] takeoff and landing operations. AFL (airfield lighting) [10] refers to any controllable lighting system. Tower [20], refers to any control facility providing Air Traffic Control services for an Airport and nearby area. Taxiway refers to any road aside from the runway within an airport, authorized for the movement of aircraft [100]. Runway refers to any road or area designated for aircraft [100] takeoff and landing operations. Ramp, refers to any area designated for the parking of aircraft [100], including deicing area. Gate, refers to any area within a Terminal area where an aircraft is not in movement. Terminal refers to any building and nearby area where several aircraft either did not start the flight or completed their flight. Radar [351] refers to any electronic device and/or computer software with output of Aircraft Position information received from an aircraft radar device, in the form of data, including flight number, longitude, latitude, altitude, speed and direction. GPS [352] refers to any electronic device and/or computer software with output of Aircraft position information received from a satellite, in the form of data, including flight number, longitude, latitude, altitude, speed and direction. Aircraft Position Reporting Sensors (APRS) [353] refer to any electronic device with an output signal when an aircraft [100] is detected in its range. Movement detection camera (MDC) [354] refers to any digital camera device sending image data to the AMS [320] for processing position information of an aircraft [100] from the image. ACARS refers to a wireless ground-air communication protocol and data link known as Aircraft Communications Addressing and Reporting System, allowing text messages to be communicated between Controllers and onboard equipment. ATN refers to a wireless ground-air communication protocol and data link known as Aeronautical Telecommunication Network, allowing text messages to be communicated between Controllers and onboard equipment via an aircraft's Communication Management Function (CMF). FMS [130] refers to the Flight Management System aboard an Aircraft, responsible for managing the flight operations including altitude, speed direction and routing. FANS [120] refers to an onboard communication protocol and data link known as the Future Air Navigation System, where ACARS communication protocol is used to communicate messages between Controllers and the FMS [130] onboard the aircraft [100]. CPDLC [110] refers to a wireless ground-air communication protocol and data link Controller-Pilots Data Link Communications for exchanging text-based messages between Controllers and pilots. CPDLCDU [140] refers to the CPDLC Display Unit aboard an aircraft [100], allowing pilots to see text messages sent by Controllers from the ground and send back messages to the controller on the ground. Heads-up display (HUD) refers to glass-display, or touch-based glass-display hardware in cockpit for graphical display and bidirectional interaction of messages associated to aircraft operations, between pilots and AMS [320] via CCS [160], running DAM [161]. Cockpit Computer System (CCS) [160] refers to computer hardware within the cockpit or UAV operator consul with human interface using a touch-screen or a HUD, and, communicating messages between AMS [320] and DAM [161]. Dynamic Map (DAM) [161] refers to a software, executed on the CCS [160], to interact functionality and messages between the AMS [320]. Landing Gear Reporting Cameras (LGRC) [355] refers to any digital camera device sending image data to the AMS [320] to process the image and identify when the Landing Gear of a landing aircraft [100] is not locked prior to the touchdown. Aircraft Position Reporting Device (APRD) [350] refers to any electronic device able to report any type of Aircraft Position, including longitude, latitude, altitude, speed, direction, or location on a runway or location on a taxiway. Typically, (APRS) [353] and (MDC) [354] or associated computer programs report aircraft location within the airport or airside, while radar [351] and GPS [352] or associated computer programs report aircraft longitude, latitude, altitude, speed and direction. Control Message (CM) refers to a text message sent from the ground in order to control aircraft operations, a Control Message is sent by the AMS [320] on the Server [300] through the GBCE [310] using the WCL [600] or AGC [610] to the onboard FANS [120] or FMS [130] or CPDLC [110], to control the autopilot [150] or, to display messages and interact with the flight crew via the DAM [161] or CPDLCDU [140]. Emergency Announcement System (EAS) [340 refers to the broadcasting system sounding an alert within an emergency facility such as a fire station or ambulance station]. RF refers to any radio frequency used as ATC frequency for voice communication between a controller and pilots, and/or between two or more Controllers and/or between controller and emergency personnel. Autopilot [150] refers to the automated flying mechanism of an aircraft [100] based on onboard FMS [130]. SATCOM refers to any satellite communication protocol or data link, primarily used for retaining longitude, latitude, altitude, speed and direction of aircraft. To allow for easier understanding of the invention, instead of referring to equipment communication links and protocols for ACARS, FANS [120], ATN CMF, RF, SATCOM CPDLC [110] individually, ground-based communication equipment (GBCE) [310] refers to all above communication equipment types as a single communication equipment, and, wireless communication links and protocols (WCL) [600], refers to all above communication link and protocol types as a single communication link and protocol. Air/Ground Communication (AGC) [610] refers to existing communication infrastructure and protocols allowing for aviation data interchange between any software or system on the ground, with any software or system aboard an aircraft that comply with SESAR or NEXTGEN or SWIM data interchange guidelines, such as AMQP, HTTPS and alike. Hand gesture sensing hardware (HAGSH) [311] refers to sensory hardware attached to a computer instead of a mouse, such as Microsoft Kinect or Leap Motion, or the like, allowing a computer user to move hands in the air and achieve same functionality as a mouse or touch-screen. Airport Management Software (AMS) [320] refers to the computer program responsible for the AAATCS. controller Module (ICM) [330] refers to a CWP (Controller Working Position) with a computer program allowing ATC personnel to interact and manage the AAATCS either by data entry, mouse or by hand gestures and using HAGSH [311]. Emergency Dispatch Module (EDM) [331] refers to a computer program allowing emergency and security personnel to view information and interact with the software regarding emergency situations within the airport or airside either by data entry, mouse or by hand gestures and using HAGSH [311]. Airport Operations Center Module (AOCM) [333] refers to a computer software running on a workstation connected on a network with the AMS [320] to allow airport operations center personnel to visualize and manage airport operations, capacity and queues on runways taxiways, junctions and hotspots, either by data entry, mouse or by hand gestures and using HAGSH [311]. Airport collaboration decision making (ACDM) [334] refers external network infrastructure of computers connected over a network to the Server [300], and exchanging aircraft and airport scheduling with the AATCS. Automated handoff coordinator (HADOC) [335] refers to a computer software running on a workstation connected on a network with the AMS [320] to allow any arrivals or departure controller to visualize and manage associated airport automated operations associated to position tasks either by data entry, mouse or by hand gestures and using HAGSH [311], including handoffs, slotting, halt departures and arrivals, coordinate emergency situations to be dispatched by the AAATCS. Air traffic management software (ATMS) [336] refers to a computer software running on a workstation connected on a network with the AMS [320] to allow Flow control and network operations personnel to visualize and manage overall airport flow capacity, halt all ground-traffic, departures and arrivals, either by data entry, mouse or by hand gestures and using HAGSH [311]. Strategic Airline Monitoring Module (SAMM) [339] refers to a computer program allowing airlines to communicate with the Pilot via DAM [161] or CPDLCDU [140] and exchange information and Control Messages with the onboard FANS [120], FMS [130] and autopilot [150]. “Line-up and wait” or “position and hold” and alike, refer to commands given by ATC to prepare an aircraft for takeoff on the runway and wait for a takeoff clearance. “Missed Approach” or “Go Around” and alike refer to procedures where a landing aircraft needs to climb in altitude instead of land. “Unable” refers to a response where a flight crew or controller is unable to comply with a request or command. “Say again” refers to a request over ATC frequency to repeat the last communication. “Read-back” is an operation typically performed by a flight crew whereby the flight crew repeats the command given by ATC as a confirmation. Flight crew refers to at least one Pilot or person aboard an aircraft, qualified to operate the aircraft. [234] Furthermore, To increase the clarity of the invention and understanding of the drawings diagrams and flow charts, when describing communication or Control Messages between AMS [320] and the CPDLCDU [140] or the autopilot [150], it is to be understood the communication or Control Messages are sent via the Server [300] through the proper WCL [600] to the proper avionics (FANS [120] or FMS [130]) to communicate or relay the endpoint AMS [320] and the CPDLCDU [320], and vice versa when endpoint AMS [320] and the CPDLCDU [140] sends or receives Control Messages with the AMS [320]. When describing communication or Control Messages between AMS [320] and the DAM [161], and vice versa when endpoint AMS [320] and the DAM [161] sends or receives Control Messages with the AMS [320] via CCS [160] through the AGC [610]. The above are explained within FIG. 2 for the data communication flow and FIG. 4 for communication of Control Messages.

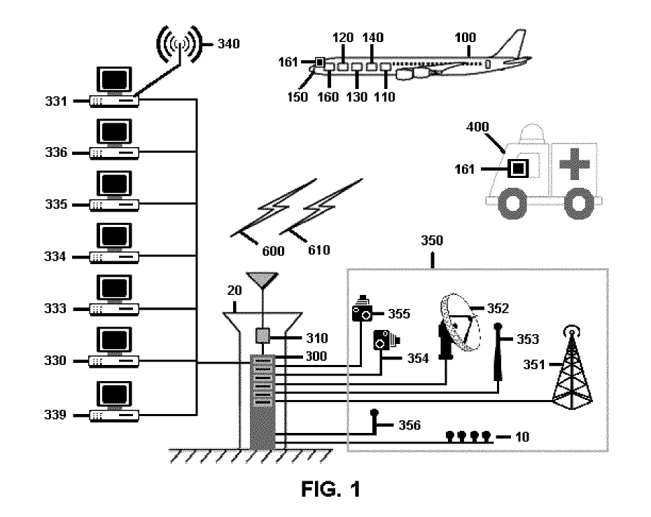

First technical solution is to automate routine airport ATC operations, specifically runway and taxiway associated operations. This automation is achieved by the said AAATCS patent application as shown in FIG. 1, comprising a Server [300] executing Airport Management Software [320], to process and communicate ATC voice commands over ATC radio frequency (RF) and, concurrently communicate data via a wireless communication link (WCL) [600] through the ground-based communication equipment (GBCE) [310] with onboard aircraft [100] CPDLC communication unit [110] and onboard FANS [120], to provide messages and commands in the form of data and, The CPDLC communicates commands and data with the flight crew via the DAM [161] or CPDLCDU [140], and, the FANS [120] exchanges commands, data and control messages with both the onboard (FMS) [130], and with the Autopilot [150]. Reporting equipment [350] including Radar [351], GPS [352], Aircraft Position Reporting Sensors (APRS) [353], movement detection cameras (MDC) [354] and Landing Gear Reporting Cameras (LGRC) [355] are attached to the Server [300] on a secure network from various airport locations. For the reasons stated above and for other reasons stated below which will become apparent to those skilled in the art upon reading and understanding the specification and example embodiments address these as well as other issues associated with the associated art.

Second technical solution is to present a new type of ground-air communication protocol allowing ATC to send control messages to the aircraft for execution. The communication protocol is an uplink allowing an ATC to send Control Messages from the ICM [330] via AMS [320] to the FANS [120] and/or FMS [130] for execution. The control messages for execution vary based on the operation, location and state of the aircraft. For the reasons stated above and for other reasons stated below which will become apparent to those skilled in the art upon reading and understanding the specification and example embodiments address these as well as other issues associated with the associated art.

Third technical solution is to allow the flight crew to see and respond to airport associated ATC messages, commands, data and options through the DAM [161] or onboard CPDLCDU [140] via the FANS [120] and/or the FMS [130] or DAM [161] to and from a Server actively executing an Airport Management Software (AMS) [320]. For the reasons stated above and for other reasons stated below which will become apparent to those skilled in the art upon reading and understanding the specification and example embodiments address these as well as other issues associated with the associated art.

Forth technical solution is to automatically, or allow ATC to manually activate the autopilot [150] and overtake any aircraft by sending a Control Message from the ICM [330] via AMS [320] to the FANS [120] and/or FMS [130] to turn on the autopilot [150] and disable it from being turned off from within the aircraft [100]. ICM [330] notifies ATC of the situation by an alert sound and message, and allows ATC to manage the aircraft [100] and turn the autopilot [150] on and off. In addition, ICM [330] allows ATC or the Airline to send a new flight-plan to the FANS [120] and/or FMS [130] and redirect the aircraft [100] using the autopilot [150] to any particular route and landing location. For the reasons stated above and for other reasons stated below which will become apparent to those skilled in the art upon reading and understanding the specification and example embodiments address these as well as other issues associated with the associated art.

Fifth technical solution is to provide the Control Message only to the relevant aircraft on the DAM [161] or CPDLCDU [140] for the flight crew. The Control Message is sent by the AMS [320] to the DAM [161] or CPDLC [110] aboard the aircraft and displays the data on the CPDLCDU [140]. For the reasons stated above and for other reasons stated below which will become apparent to those skilled in the art upon reading and understanding the specification and example embodiments address these as well as other issues associated with the associated art.

Sixth technical solution is to allow for the pilot to select “ACCEPT” and “UNABLE” options on the DAM [161] or CPDLCDU [140] for all ATC commands, messages and data. For the reasons stated above and for other reasons stated below which will become apparent to those skilled in the art upon reading and understanding the specification and example embodiments address these as well as other issues associated with the associated art.

Seventh technical solution is to show the flight crew all the data associated to the operation on the AMS [320] send all the additional relevant information needed for the takeoff or landing operation to the DAM [161] or CPDLCDU [140] for the flight crew to see, thus lowering the congestion on the ATC radio frequency, and making the information available for the flight crew during the full operation without the need to remember it. For the reasons stated above and for other reasons stated below which will become apparent to those skilled in the art upon reading and understanding the specification and example embodiments address these as well as other issues associated with the associated art.

Eighth technical solution is to refresh and show the flight crew all the data associated to the landing or takeoff operation as the data changes on the DAM [161] or CPDLCDU [140], for example, as the wind direction and/or speed changes, the information is refreshed every time on the DAM [161] or CPDLCDU [140] for the pilot to see with a sign showing there are changes since the initial data was given, this provides the flight crew with important update to make the necessary changes for the landing or takeoff operation. For the reasons stated above and for other reasons stated below which will become apparent to those skilled in the art upon reading and understanding the specification and example embodiments address these as well as other issues associated with the associated art.

Ninth technical solution is to show the flight crew all the data associated to the exit operation on the CPDLC in real-time with the frequency to switch to. In addition, the AMS, flashes the lights of the closest taxiway to exit, thus allowing aircraft to use the proper exit without mistakes in low visibility where the exits illumination is unclear, and thus allowing more runway operations in a safe manner. For the reasons stated above and for other reasons stated below which will become apparent to those skilled in the art upon reading and understanding the specification and example embodiments address these as well as other issues associated with the associated art.

Another technical solution is to automatically send the new departure data to the relevant onboard DAM [161] or FMS [130] and/or CPDLCDU [140], while displaying the flight crew with the notification of the change made on the DAM [161] or CPDLCDU [140]. For the reasons stated above and for other reasons stated below which will become apparent to those skilled in the art upon reading and understanding the specification and example embodiments address these as well as other issues associated with the associated art.

Tenth technical solution is to simultaneously send all airborne aircrafts near any selected airport, area, country or continent an immediate flight-plan to follow as if it was hijacked, thus, grounding all airborne aircraft in the most efficient manner. This operation is possible since all airports with AMS [320] are interconnected on a network, and allows alerting Controllers through ICM [330] at all relevant airports with AMS [320] of the situation immediately and automatically. This substantially lowers the workload of all Controllers dealing with the grounding of the aircrafts. For the reasons stated above and for other reasons stated below which will become apparent to those skilled in the art upon reading and understanding the specification and example embodiments address these as well as other issues associated with the associated art.

Eleventh technical solution is to take several photos of the landing gear mechanism from under the aircraft prior to the landing at high-resolution with a high-speed digital camera, and compare them by a LGRC process to ensure the angle of the landing gear mechanism in relation to the aircraft chassis is the same in all pictures. In the case where LGRC detects inconsistency, a notification is sent to the ATC through the ICM [330], and, a vocal alert is sent over the ATC frequency to the pilot from the AMS [320] along with information displayed on the CPDLC for the flight crew to consider a go-around or a missed approach. In addition, the AMS [320] flashes the runway lights [FIG. 31] of the runway when the LGRC [355] detects a problem, thus allowing the aircraft to visually understand there was no confirmation of a locked landing gear. For the reasons stated above and for other reasons stated below which will become apparent to those skilled in the art upon reading and understanding the specification and example embodiments address these as well as other issues associated with the associated art.

Twelfth technical solution is to automatically send the new departure data to the relevant onboard FMS [130], while displaying the flight crew with the notification of the change made on the DAM [161] or CPDLCDU [140]. In addition, the AMS [320] controls the threshold lights of the closed runway and flashes them, allowing all aircraft on final approach to visually understand the runway is closed and the need for a go-around or a missed approach. For the reasons stated above and for other reasons stated below which will become apparent to those skilled in the art upon reading and understanding the specification and example embodiments address these as well as other issues associated with the associated art.

Thirteenth technical solution is to allow Pilots and Airline Operators to set preferred taxiway routes to each of the runways within the airport from different areas of the Airport where the Airline operates. This reduces congestions, waiting for crossings, safety hotspots and direct fuel costs.

Fourteenth technical solution is to maximize the utilization of takeoff operations from junctions based on aircraft type, weight, historical takeoff information and current wind conditions. For example, a B737 can takeoff from an intersection on most long runways.

Fifteenth technical solution is to maximize the use of data communication for exchanging information between Pilots and the ATC service, and only use the ATC radio frequency as a backup.

Sixteenth technical solution is to calculate the landing to takeoff ratio of each runway and to balance future takeoffs by diverting from runways at overcapacity.

Seventeenth technical solution has two parts, the first part calculates the historical responsiveness of a particular pilot to an ATC command from a historical database, and average taxiing speed and time to cross a junction or a runway, and an expedite directive is only issued to aircrafts historically passing a set average speed and crossing time. In addition, as a second part of the solution, aircrafts receiving an expedite directive are monitored for performance and can be marshalled to increase speed, the heading and break, as covered by another technical solution.

Eighteenth technical solution is to provide constantly updated information on a Dynamic Map within the cockpit with relevant traffic that may be crossing downfield or affecting the operation, any turbulence from last runway operation that may have affect the aircraft, parallel runway operations that may affect the operation, wind speed, wind direction, initial climb altitude, departures frequency, departure altitude, initial flight heading or navigational aid or GPS guided route, breaking action, bird, FOD and alike.

Nineteenth technical solution is a Dynamic Map within the cockpit, constantly updating information with all relevant aircraft and airport vehicles that are nearby or may affect the aircraft during runway operations. In addition, if selected by a pilot, a synthesized voice constantly provides updates of information relevant to the aircraft, in pilot's selected language.

Twentieth solution is an automated handoff coordination, whereby all departures are released automatically based on current sector traffic, and, can be managed and administered by a departure controller by managing multiple selectable configurable templates. The departure controller can always manually administer any flight. Templates include optimized departure sequence for departure headings and handoff altitudes for any combination of runways, for any given time span for any day of the week.

Twenty first solution is a standalone automated system for managing Tower operations, through a single interface, whereby a controller can change the settings, and the system automatically controls the associated traffic based on the settings and rules prescribed by the controller

Twenty second technical solution is to marshal the maneuvering system, wheel breaks system, and the engine power management system of any aircraft via the communication link and the onboard FMS. Controlling of aircraft is automated when there is a calculated future collision, or, marshalled manually by the commanding tower controller.

Twenty third technical solution displays emergency personnel the best route to take to the pre-calculated final resting position of the aircraft, on a portable device, based on current aircraft location, profile and associated physics. In addition, the display includes information associated to the aircraft type, number of people onboard, and the calculated or last reported amount of fuel.

Twenty forth technical solution calculates the possibility of a runway overshoot depending on altitude, remaining runway length from current position, runway breaking action, approach profile and aircraft physics, to provide through a cockpit device an audible notification for a possible overshoot, with a visual notification, so the pilot can make a final decision if to go-around or land.

Twenty fifth technical solution is providing a display in a cockpit device, displaying updated notifications to airman, as well as messages that have been administered by airport operations control, or commanding controller. In Addition, if a notification or message is associated to an area or an object, it is highlighted on a Dynamic Map.

Twenty sixth technical solution is a menu display of selectable and available predefined routes, or optional progressive taxi routes, including each route's estimated times to reach the destination. Each selection of an item displays the route on the Dynamic Map, including current traffic, and by moving the finger on the device over the displayed route path, the pilot is shown the anticipated traffic at any given future point in time in relation to the position within the path.

Twenty seventh technical solution displays possible FOD as given by external FOD system, as well the ability for a pilot to report an FOD. A pilot reports FOD simply by selecting the position of the FOD on the map and selecting the FOD displayed menu options. The process is similar for reporting birds and breaking action.

Twenty eighth technical solution communicates with other external applications for all airport layout and airside associated operations using AIXM to comply with EUROCONTROL and FAA mandates. When a parameter of field is not yet supported by AIXM, it is exported as an extended or user-defined class or object or extended data or metadata.

Twenty ninth technical solution is a constant process of calculating taxi routes for all current and future aircraft movements, based on current and future traffic positions of aircrafts based on destination and routes, where result of calculations compile a list of complete routes including their paths and time to destination from any current position for each aircraft, as well as proposed progressive taxi route for each aircraft. The list is then stored for future menu options on a per-aircraft basis. In addition, the calculations account for aircraft weight type, restricted areas and routes and alike.

Thirtieth technical solution is to automatically marshal the breaks systems to the aircraft via the communication link and the onboard FMS to control the wheel lock mechanism, or similar device. The breaks are marshalled, or by the commanding controller.

Thirty first technical solution is a device with an Dynamic Map, where full ATC commands services are seen and heard in pilot's preferred language, all associated operational information, notifications and options are provided for each phase of the operation. The display is constantly updated with fresh information, including nearby traffic, and conditions affecting the transition of the aircraft from one operation to another.

Thirty second technical solution displays the pilot a satellite image of the airport to easily understand the current location in relation to airport buildings and alike, which are unavailable in most airport diagrams. In addition, distances to the next junction are always updated, and, when nearing a junction to hold short or make a turn, a graphical alert and synthesized voice tell the pilot which way to turn, or heading, as well as any special restrictions and rules for next operation, such as speed and alike. Nearby traffic is always shown, with heading, operation type and other options.

Thirty third technical solution is to externally mount a camera on terminal building overlooking the surface markings near a gate sleeve, and the gate sleeves, mounted high on the terminal in relation to the surface area and gate sleeve, takes pictures at a specified rate, processes by the system, sending pictures and displays the pictures to the pilot as a visual representation to make taxi maneuvering decisions during gate taxi operations such as pushback and alike

Thirty forth technical solution is a the marshalling of several aircraft takeover, defined by the tower commanding control and authorized by a secondary controller from another facility, is automatically executed to send multiple flight paths to a group of selected aircrafts.

Thirty fifth technical solution is a handheld unit for airport airside personnel or any vehicle moving within the airport, having the same situational awareness and taxi route-selection functionality as a pilot. In addition, any authorized airport personnel or operator within a moving vehicle within the airport, can request a closure of any airside area for maintenance.

Thirty sixth technical solution is to provide pilots with a count-down timer of anticipated time to next command or operation. This greatly increases pilot alertness, and readiness to respond in good time.

Thirty seventh technical solution is to flash the airside lights based on the direction and exit, or junction an aircraft should take. This ensures pilots do not take wrong paths at junctions or miss their exit.

Thirty eighth technical solution is to record all avionics data and cockpit sounds, and send them for storage for later replay. This also eliminates the need to look for a black-box in case of a crash.

Thirty ninth technical solution is to send the data in real-time to servers for retention until flight is closed.

Fortieth technical solution is to time the pushbacks so the flow of taxiways and runway use is optimized.

Forty first technical solution is to time the aircrafts, each with own speed, to lower the numbers of stops at junctions.

Forty second technical solution is to timing the pushback operation so aircrafts taxi without significant queueing until reaching runway.

Forty third technical solution is to provide optimal taxi speed per aircraft per taxiway part between junctions, thus lowering the number of required stops between runway and gate.

Forty forth technical solution is to Allow controllers to select a predefined airport configuration template, having defined active runways, routes per aircraft type and airline for each type of operation. The selection is done from a list of available templates depending on active runways. Preconfigured templates include support for acute scenarios such as emergency landings with rerouting rules and the like.

Forty fifth technical solution is to update braking action based on aircraft weight, approach speed, previous braking of aircrafts of same type.

Forty sixth technical solution is to Provide DH information including braking action of the aircraft type, too high/too fast as calculated final resting area is available from descent rate, speed, anticipated touch-down area and aircraft type.

Forty seventh technical solution is to provide a Dynamic Map displaying available routes and time to gate for each route.

Forty eighth technical solution is to Send a control message to the aircraft, whereby the pilot is alerted, and brakes are applied aboard the breaching aircraft. Signal can either be processed by autopilot recognizing the control message signal, or by manufacturer system that decides on action based on control message sent.

Forty ninth technical solution is to Allow pilot to select a preferred route from several fastest available routes displayed on a Dynamic Map.

Fiftieth technical solution is to Relieve congestions by better pushback timing and maximizing utilization of multiple taxi route segments.

fifty first technical solution is to assign taxiing speed for each aircraft and restrict movement to route or entry to restricted areas.

fifty second technical solution is to Utilize all available taxiway segments with optimal taxi speeds per taxiway segment.

fifty third technical solution is to Send a control message to the aircraft avionics with the probability level of an accident, whereby the pilot is alerted, and brakes are applied aboard the breaching aircraft.

fifty forth technical solution is to alert to all pilots aboard affected aircraft on Dynamic Map with visual and audible alerts. Also, alert the controller on a CWP.

fifty fifth problem dealt with by this disclosure is that wake separation does not account for the combination of crosswinds and multiple dependent operations Solution.

fifty sixth technical solution is to visually display a route on Dynamic Map showing the route distance to next junction, turns to make, and utilizing the control message or signal sent for violating route boundary.

fifty seventh technical solution is to Continuously display all relevant operational information on Dynamic Map. The information content depends on operation type.

fifty eighth technical solution is to continuously display all closed or restricted runways, taxiways or junctions or gates or stands or terminals or areas in a shade of red, where a pilot can easily understand closed versus open runways, taxiways and junctions.

fifty ninth technical solution is to Provide an automated mean to decide visual separation by using positioning information of all aircrafts and vehicles.

Sixtieth technical solution is to flash the runway lights [FIG. 31] of the runway when the LGRC [355] detects a problem, thus allowing the aircraft to visually understand there was no confirmation or front gear is not locked.

Sixty first technical solution is to driver's dynamic map within vehicle, displaying all other traffic, routes and emergency information.

Sixty second technical solution is to driver's dynamic map within vehicle and wrist-PDA showing maintenance slots, where and when to start, where and when to finish, and duration allowed.

Sixty third technical solution is to Use of ADSB, radar technology and the like, to know exact aircraft and vehicle position, speed and heading information.

Sixty forth technical solution is to Provide a single screen with constant updates of all the required compiled and calculated operational information, where the controller does not need to process inputs.

Sixty fifth technical solution is to Multiple cameras located at junctions and selected locations provide a shorter visual range and better sight to junction traffic coupled with single controller map of airside objects positions from ADSB, radar and the like.

Sixty sixth technical solution is to connect at least 2 systems on separate physical computer networks, regardless of system locations.

Sixty seventh technical solution is to Additional systems can be added on additional networks to enable multiple area redundancy control and backup centers, to provide multiple tower ATC services for unlimited number of airports.

Sixty eighth technical solution is to add fully autonomous and/or automated departures control with support for request release, full climb instructions and time slotting assignment per flight, with selectable templates to cater to rush and capacity at multiple airports with multiple active runway configurations.

Sixty ninth technical solution is to Provide several short final angles, using dynamic wake model to include crosswinds, thereby lowering the separation between aircrafts and increasing runway capacity.

Seventieth technical solution is to allow controller s to interact with the system in own language or via technologies such as touch screen or finger/hand gesture equipment. The system then relays the information to pilots in their own language via a Dynamic Map.

Seventy first technical solution is to stream information to a Dynamic Map aboard the aircraft, whereby all traffic and operational information is displayed in pilots native language, independent of ATC services.

Seventy second technical solution is to Provide bird information to pilots on a Dynamic Map with alerts if future positions of both the aircraft and the birds endangers aircraft operation.

Seventy forth technical solution is to Send a control message to the aircraft's autopilot for immediate execution of marshalled movement.

Seventy third technical solution is to Allow the autonomous and/or automated system to send control messages to the avionics and marshal all aircraft operations at or near the airport.

Another technical solution is to Provide a fully autonomous and/or automated ATC system for an airport with minimal supervision of qualified shift manager as set by regulations.

Seventy fifth technical solution is to automatically assign new routing to all affected aircrafts reroute traffic as per new runway. Another technical solution is to By using electronic data feeds from weather sources, the system prepares for each scheduled flight a list of best possible routes, while taking into considerations airline and pilot historical and preferred routes, security associated routings over areas that airlines do not fly over, closed airspaces, military airspaces, environmental hazardous areas such as storms, volcanos and ash. Once the pilot selects from the list of routes, the system provides a clearance. Once the pilot approves the clearance, the clearance is then loaded into the FMS aboard the aircraft, loaded to the Dynamic Map for future reference, and optionally printed for the pilot as a paper backup. This process is done without the need for interaction with a controller, and can be executed from any device with internet access several hours prior to the flight, or via the Dynamic Map once in the cockpit.

Seventy seventh technical solution is to provide the pilot best several routes from departing to arriving airport via the Dynamic Map, thus allowing the pilot to select from best possible pre-approved route with considerations for future weather and environment changes (pre-cleared with other systems such as EUROCONTROL and FAA). The selected clearance delivery route is then kept within the dynamic map, without any interaction between the pilot and a controller.

FIG. 1 is a perspective view of the hardware, computers and devices used by the system, including an aircraft [100] in communication with the Server [300]. The aircraft [100] includes a FANS communications System [120] and a Controller-Pilot Data Link Communications (CPDLC) [110]. FANS [120] and the FMS [130] both send and receive messages to and from the Server [300] via WCL [600]. The FANS [120] relays Control Messages between the Server [300] and the FMS [130] and/or autopilot [150]. The CPDLC [110] relays Control Messages between the Server [300] and the DAM [161] or CPDLCDU [140] to interact with a Pilot. The Interactive controller Module ICM [330] is connected to the Server [300] and allows an ATC to interact and manage AMS [320] operations within the AAATCS. Landing Gear Reporting Cameras (LGRC) [355] are connected to the Server [300] and send images to the AMS [320] to confirm the landing gear is locked. Emergency Dispatch Module (EDM) [331] notifies emergency personnel in the event of an emergency operation or when AMS [320] detected the landing gear is not locked. Radar [351] and Global Positioning System (GPS) [352] are connected to the Server [300] and provide the AMS [320] updated aircraft location and altitude for within or near the Airport. Aircraft Reporting Sensors (APRS) [353] are connected to the Server [300] and send a signal to the AMS [320] when an aircraft is in range. Movement Detection Cameras (MDC) [354] are connected to the Server [300] and provide the AMS [320] with images of taxiways and junctions for identifying traffic congestions or hotspots. AMS [320] is connected to the AFL (airfield lighting) [10] for flashing applicable lights to each aircraft for its own operation.

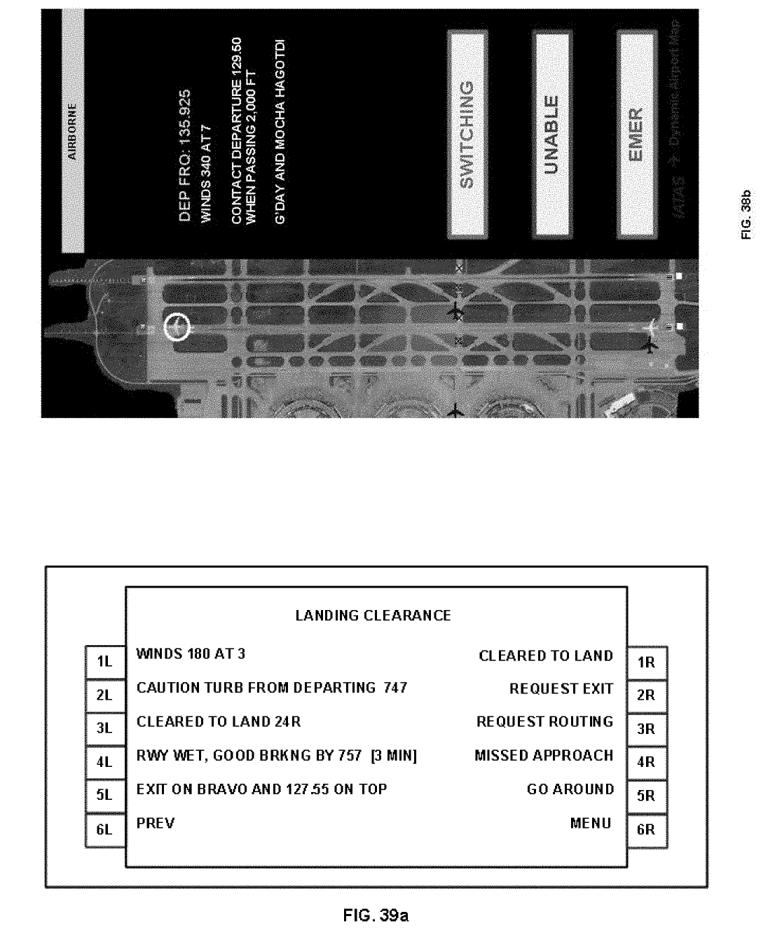

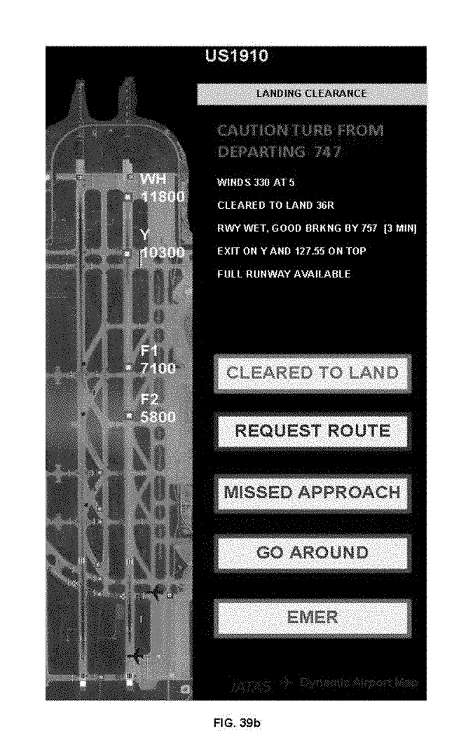

FIG. 2 is a diagram that further illustrates the data flow between the Server [300] and each of the computers and systems [110,120,130, 140 and 150] aboard the aircraft [100]. The AMS [320] processes system Control Messages and sends them to all other equipment through the server [300]. The ICM [330] allows the ATC to send and receive Control Messages to and from the AMS [320] via the Server [300]. The EDM [331] receives Control Messages from the AMS [320] via the Server [300]. The CPDLCDU [140] permits the pilot to receive and send Control Messages to and from the AMS [320] or through DAM [161] via the Server [300], GBCE [310] and FANS [120], for example, the AMS [320] sends a “Landing clearance” Control Message [FIG. 13] to the aircraft [100] and the DAM [161] or CPDLCDU [140] will display the associated data [FIG. 39]. The Autopilot [150] sends and receives messages to and from the Server [300] via FANS [120] and/or FMS [130], for example, the Server [300] sends a Control Message to the FANS [120] and/or FMS [130] to turn on the autopilot [150] and lock access to it if the aircraft [100] deviates from its course or when the aircraft [100] is squawking any type of distress code (7500 for example). The FMS [130] sends and receives Control Messages to and from the Server [300] via FANS [120]. For example, the Server [300] sends a Control Message to the FMS [130] with rerouting instructions to execute in the case of a Missed Approach or a hijack. Alternatively, the Server [300] sends a Control Message to a DAM (Dynamic Map) [160] aboard an Airside Object [400] or at a remote location controlling an Airside Object [400], the Control

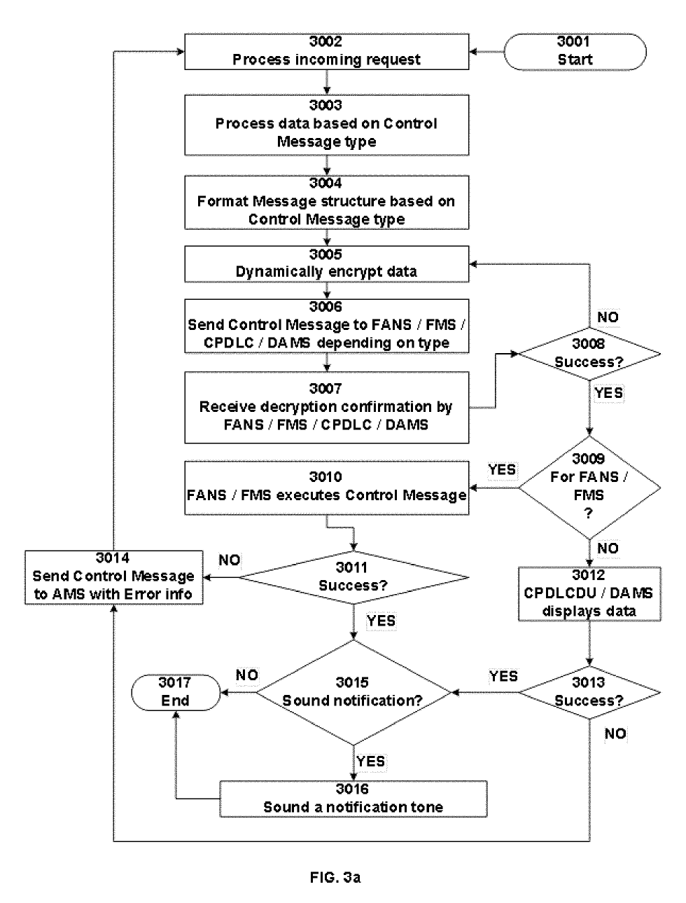

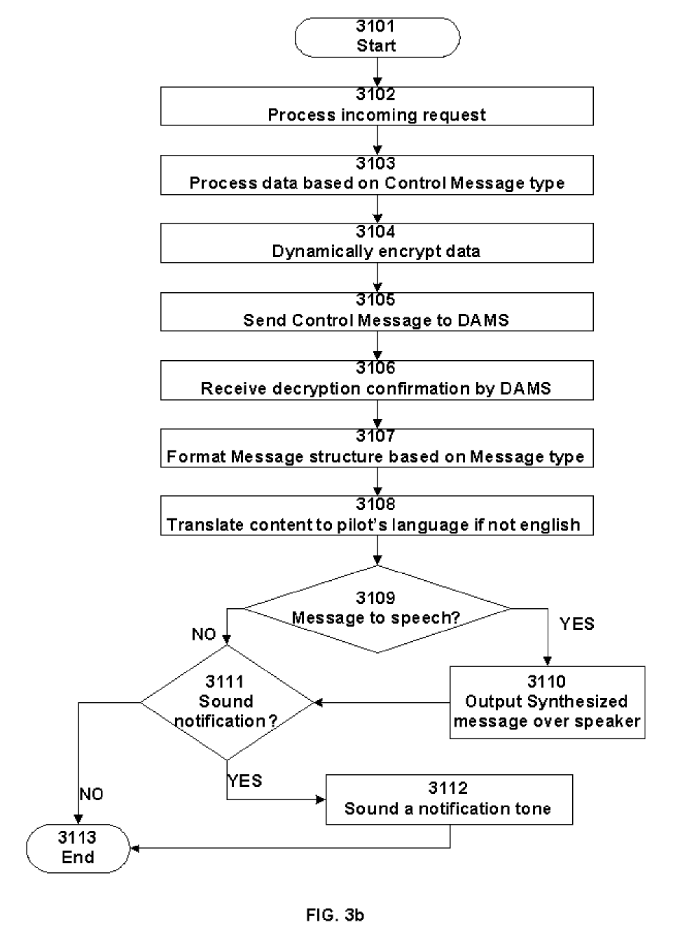

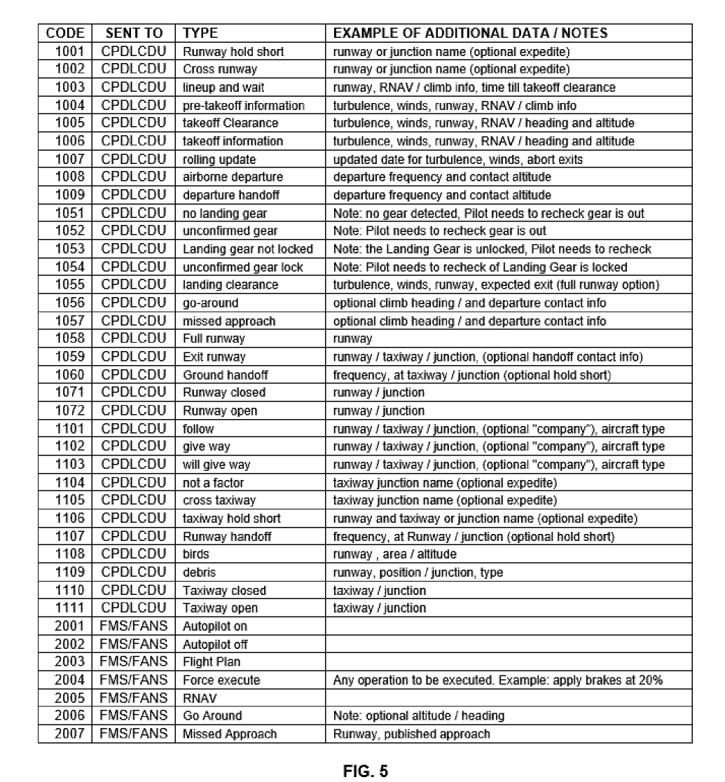

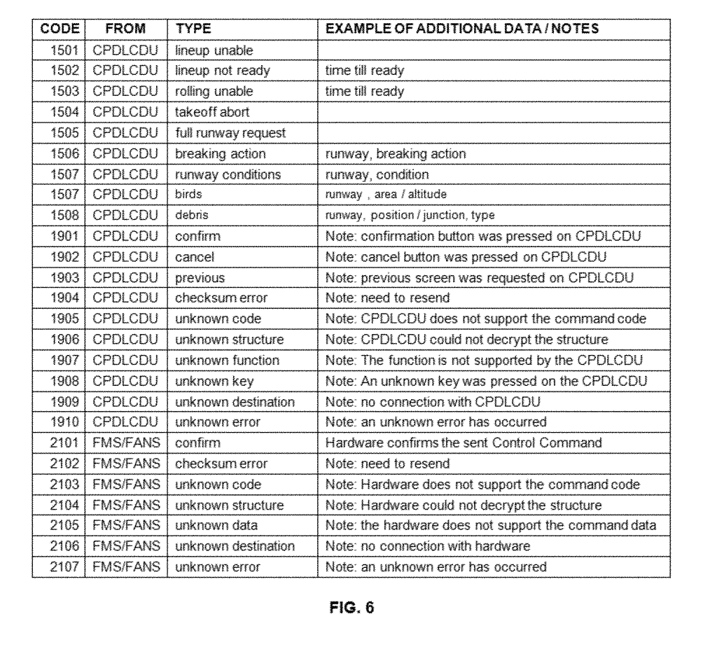

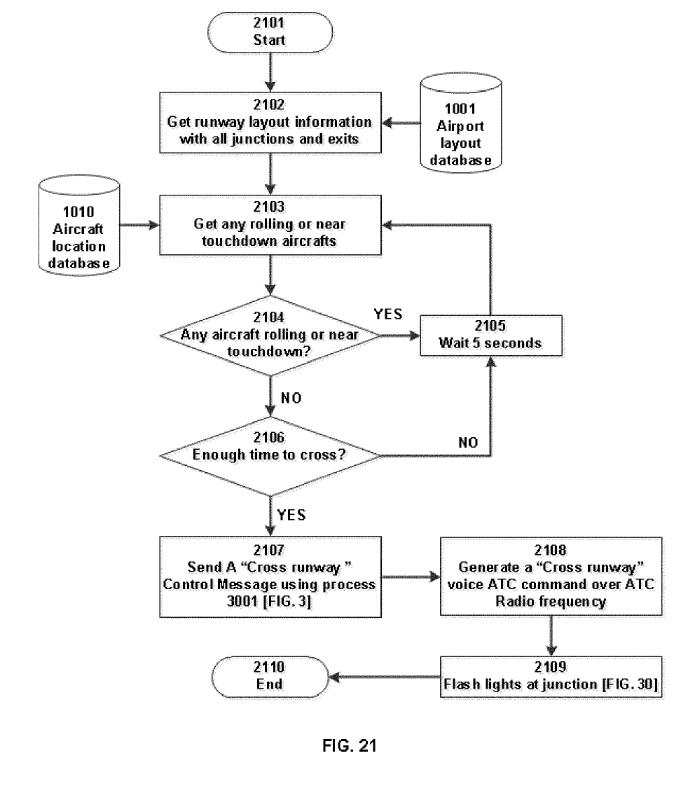

FIG. 3a illustrates a flow diagram of the processes in a method within the AMS [320] involved in sending a Control Message (CM) to an aircraft for FMS [140], FANS [120] or CPDLCU [140]. The process is used for sending equipment onboard an aircraft [100] a command for execution or, to communicate with the flight crew via the DAM [161] or CPDLCDU [140]. 3002 processes the incoming request to send a CM, including the message type and associated data [FIG. 5] to be sent with the CM. 3003 processes the data to be included within the CM and 3004 formats the CM data for use at the destination (DAM [161] or FANS [120] and/or FMS [130] and/or CPDLCDU [140] and/or autopilot [150]). Once a CM is ready to send, 3005 encrypts the CM for safe transmission and, 3006 transmits the CM to the equipment aboard the aircraft [100] via WCL [600] through GBCE [350] as shown in FIG. 4. To ensure the CM was transmitted successfully in 3006, once the destination equipment (DAM [161] or FANS [120] and/or FMS [130] and/or CPDLCDU [140]) onboard the aircraft [100] receives the CM, a CM is generated by the destination equipment (DAM [161] or FANS [120] or FMS [130] or CPDLCDU [140]), and a response code is sent back [FIG. 6] to 3007. If the received CM in 3007 was unsuccessful, the message is encrypted again in 3005 and retransmitted in 3006 until the CM is received and a confirmation is returned to 3007. Once the CM was sent successfully to the aircraft [100], the AMS [320] awaits a response from the aircraft [100]. Depending on the type of CM sent by 3006, when the sent CM type is for the flight crew (3009), the DAM [161] deciphers and displays the CM content, or CPDLC [110] deciphers the CM and display CM content on the CPDLCDU [140] (3012). A code for success or fail is returned by 3013 to the AMS [320] via a CM in 3014 for possible further processing. A tone notification is generated by 3016 if the sent CM requires one (3015). When the sent CM was for the FANS [120], it is deciphered by the FANS [120], and processed. When the sent CM type was for the FMS [130], it is deciphered by the FMS [130] and processed. When the sent CM was for the autopilot [150], it is deciphered by the FMS [130] and sent to the autopilot [150] for processing. When a sent CM is directed at the FANS [120] or FMS [130] or autopilot [150], a code for success or fail is returned by 3011 to the AMS [320] via a CM in 3014 for possible further processing and a tone notification is generated by 3016 if the sent CM requires one (3015). For example, the process is called by process 2107 [FIG. 21] to send a runway crossing CM. Process 3002 looks for the code associated with the “cross runway” and outputs “1002”. 3003 processes the runway and junction data required for the “1002” CM. Process 3004 formats the CM and produces an output of: “1002;140;24L;A1”, 1002 is the CM code, 140 is for the CPDLCDU, and, 24L; is the runway and A1 is the junction on runway24L. 3005 encrypts the CM and outputs data in an unreadable form to humans, such as “BN4Q2W62YGF47NIQ3W3F” (as an example). 3006 transmits the said encrypted CM by 3005. 3007 receives the code 2101 from the FANS [120] as a confirmation the CM was received. The FANS [120] decrypts the encrypted CM in 3007, and sends it to the DAM [161] for display or CPDLC [110] in 3009 for display by the CPDLCDU [140] in 3012. The CPDLCDU [140] display was successful in 3013, 3015 processes the CM code to confirm a tone notification is needed. 3016 sounds a notification tone. 3014 returns a success code to the AMS [320] by 3017 after the display on the DAM [161] or CPDLCDU [140] in 3012 and tone notification in 3016 are complete, and the process of sending and confirming the CM transmission is complete.

FIG. 3b illustrates a flow diagram of the processes in a method within the AMS [320] involved in sending a Control Message (CM) to an aircraft for the DAM [161], where the process is similar, however, the infrastructure used, as shown in Fig. where Air/ground communication using the CCS [160] is used to communicate between the server [300] and DAM [161] aboard the aircraft. In addition, as seen in FIG. 2, DAM [161] interfaces and is able to exchange control messages with onboard avionics such as the FMS and FANS [120], and alike.

FIG. 4 illustrates a block diagram of the data communication to further illustrate FIG. 3a in methods involved in sending a Control Message (CM) between the AMS [320] and the various onboard aircraft equipment [110,120,130,140,150,160,161]. All ATC commands are processed as a CM within AMS [320], and are sent to an aircraft [100] FANS [120] or DAM [161] or CPDLC [110] for the CPDLCDU [140] via the server [300]. The data flow between the server [300] and an aircraft [100] is through the GBCE [310] via WCL [600] or AGC [610]. For example, when a runway crossing CM is processed [FIG. 21], a CM is generated [FIG. 3] and the CM is sent from the server [300] to the DAM [161] or CPDLCDU [140] via the GBCE [310], transmitted to the aircraft [100] via the WCL [600]. Once the CM is transmitted to the aircraft, it is received by the equipment based on the WCL protocol. In the case of a runway crossing CM, the DAM [161] receives and displays the takeoff clearance information, or CPDLC [110] receives the CM and sends it to the CPDLCDU [140] for displaying the takeoff clearance information. The output of the CM in process 3004 prior to the encryption would be: “1002;140;24L;A1”, 1002 is the CM code, 140 is for the CPDLCDU, and, 24L; is the runway and A1 is the junction on runway 24L. Alternately the CM [FIG. 3] is generated and the CM is sent from the server [300] to the CPDLCDU [140] via the GBCE [310], transmitted to the airside object [400] via the WCL [600]. Once the CM is transmitted to the aircraft, it is received by the equipment based on the WCL protocol. In the case of a runway crossing CM, the DAM [160] receives the CM and interprets the CM and performs either the displaying of the information on the screen, or alerting via an audible or visual alert, or executes a command within the DAMS related to the CM, as an example to display a selection menu for the operator.

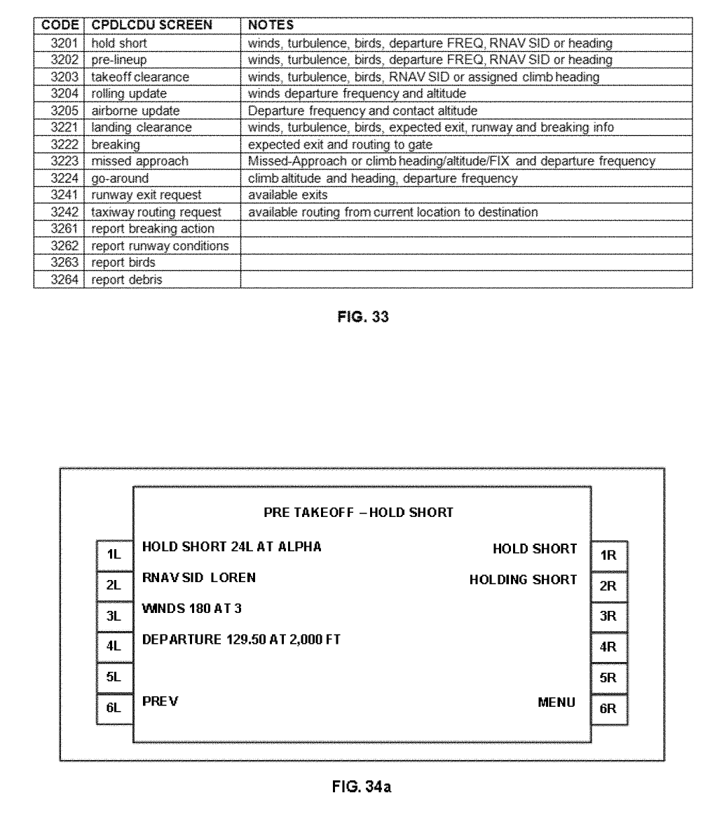

FIG. 5 lists an example of Control Messages (CM) sent to the aircraft [100] by the AMS [320]. Each CM includes a reference code used in decoding a CM aboard the aircraft [100]. The list also illustrates the destination of each message sent by the AMS [320] and the data included within the message processed by processes 3003 and 3004 [FIG. 3]. The format of the CM message is: Code;Destination;data1;data2;data3 . . . dataN. For example, code 1001 is for the DAM [161] or CPDLCDU [140] aboard the aircraft [100] and is an ATC directive to hold short of a particular runway junction to be displayed on the DAM [161] or CPDLCDU [140] as shown in FIG. 34. The CM output of process 3004 [FIG. 3] is: 1001;140;24L;A1. 1001 is the CM code, 140 is the code for the CPDLCDU, 24L;A1 is the junction of runway 24L at A1. Each CM includes a reference code used by the AMS [320] CM from the aircraft [100]. The list also illustrates the destination of each message sent by the AMS [320] and the data included within the message processed by?

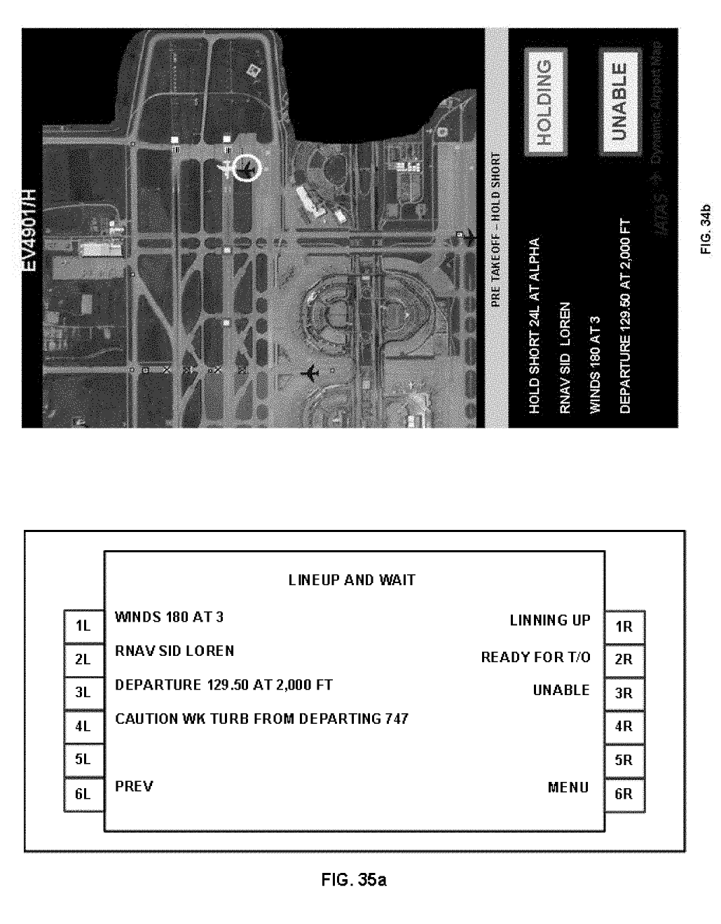

FIG. 6 lists an example of incoming Control Messages (CM) sent to the AMS [320] from any onboard aircraft equipment [110,120,130,140]. The list also illustrates the source of each message sent to the AMS [320] for processing. For example, After the AMS [320] sends a code 1003 [FIG. 5] to “lineup and wait” to the CPDCLDU [140], the Pilot will confirm the ATC directive by selecting “Lining up” [FIG. 35] and the CPDCLDU [140] will return code 1901.

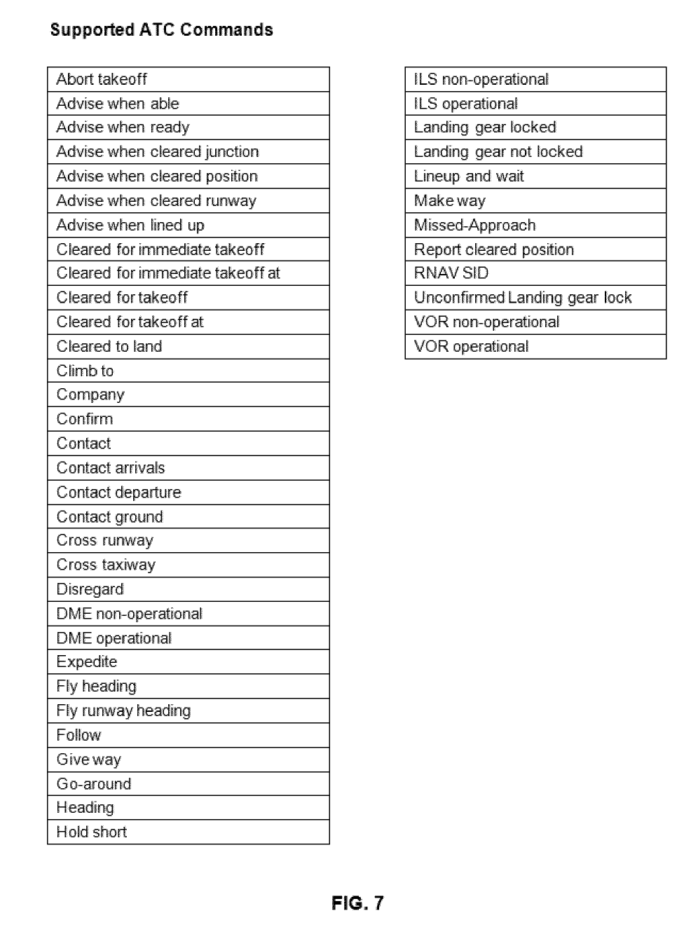

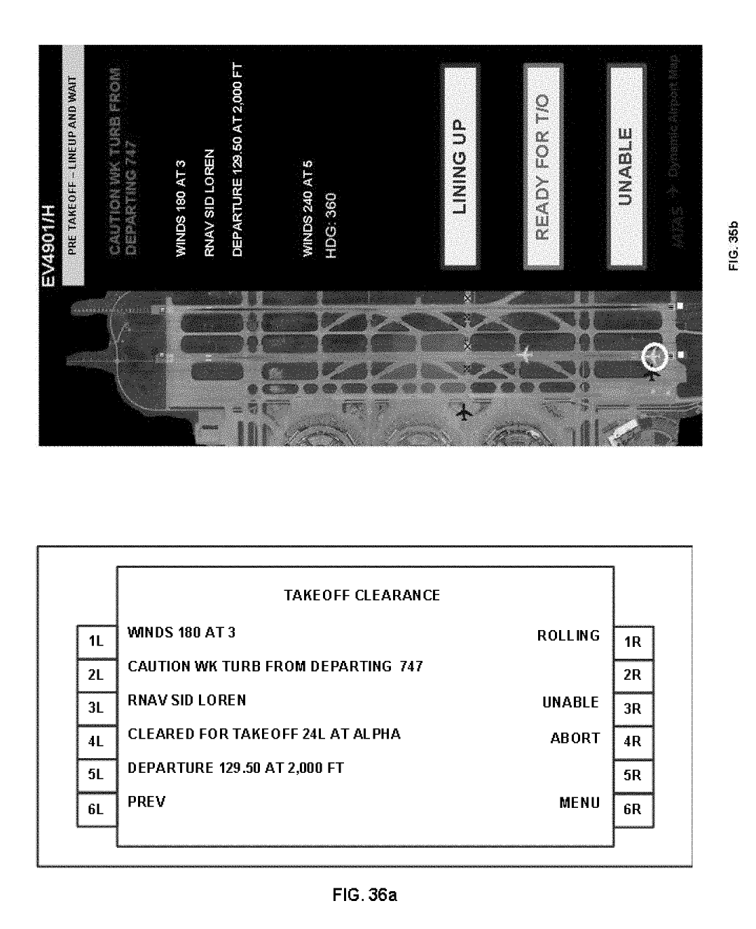

FIG. 7 lists an example of supported ATC commands processed by the AMS [320] as voice commands over the ATC radio frequency. For example, when a takeoff clearance is issued in process 1207 [FIG. 12] by the AMS [320] to the Pilot of flight AC4554 over the DAM [161] or CPDLCDU [140] FIG. 36a or DAM [161] to takeoff [FIG. 36b] from runway 24L at Alpha junction with departure RNAV SID LOREN, A voice command is generated by process 1208 over the ATC frequency saying“AC4554, Cleared for takeoff runway 24L AT ALPHA, RNAV LOREN”.

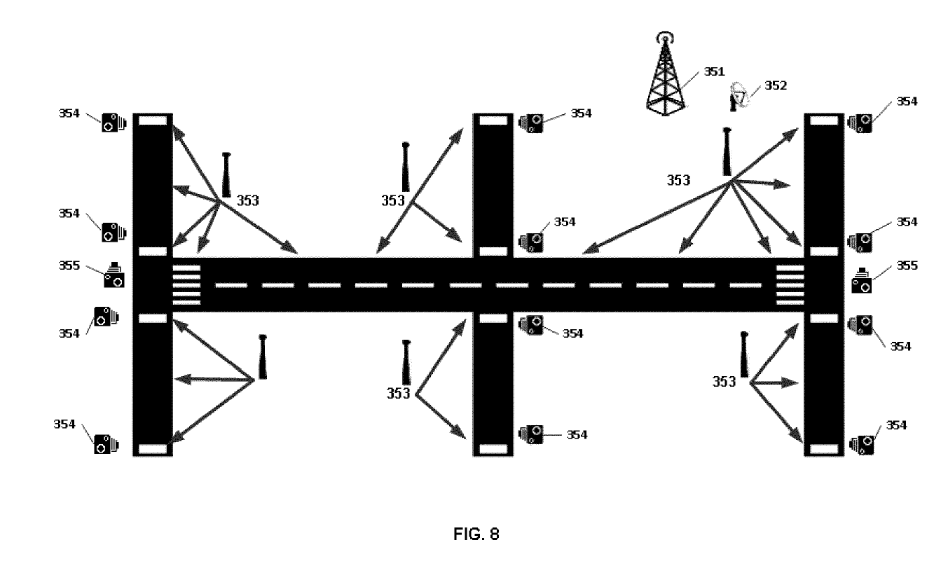

FIG. 8 illustrates an example of locations for the various Aircraft Position Reporting Devices (APRD) [350], in relation to a runway and taxiway, used by the AMS [320] for updating the Aircraft Locations Database [1010]. The use of a sensor within the illustration may refer to an aircraft [100] location reported by a satellite or a radar device as oppose to a physical sensor. The APRD [350] includes: Aircraft Position Reporting Sensors (APRS) [353]; Movement Detection Cameras (MDC) [354]; Landing Gear Reporting Cameras (LGRC) [355]. APRS [353] locations are at the start of the runway, the touchdown, the lineup area if different from the touchdown area; and, on any exit or crossing or ramp from either direction on either side. In addition to the above, an APRS [353] is placed every 250 feet along the runway starting from the runway pavement, regardless of the marking. The APRS [353] at the end of the lineup position sends a signal to the AMS [320] every time the lineup area has been triggered by either a landing or departing aircraft [100], this signals the AMS [320] the next takeoff can lineup on the runway. Additional APRS [353] at taxiway junctions and runway exits signal AMS [320] when an aircraft exits the runway. The additional APRS [353] placed along the runway every 250 feet signal the AMS [320] of the current location on the runway for calculating breaking speeds and runway exits while an aircraft is landing or aborting a takeoff [FIG. 51].

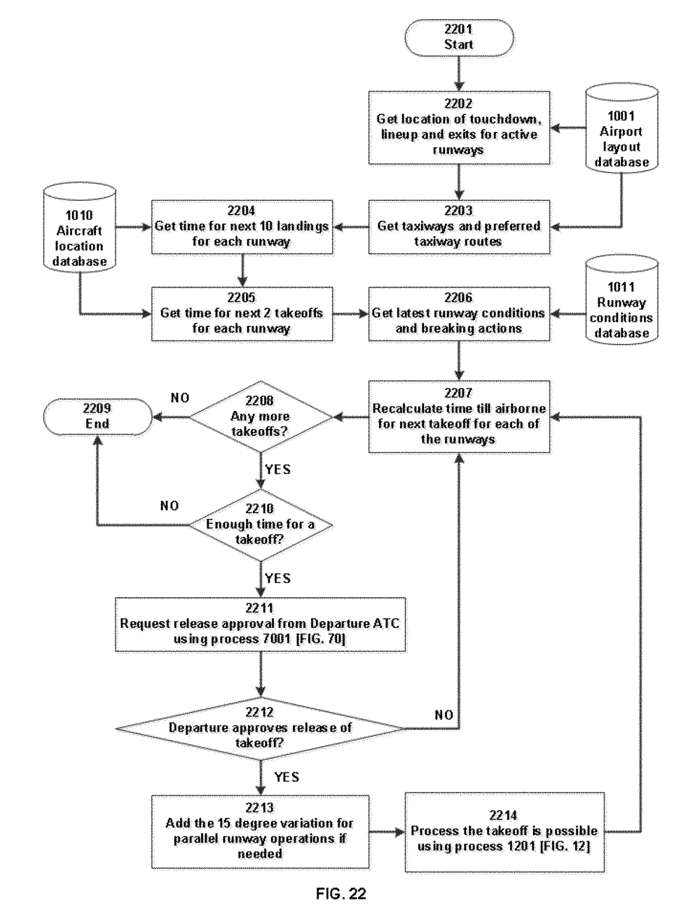

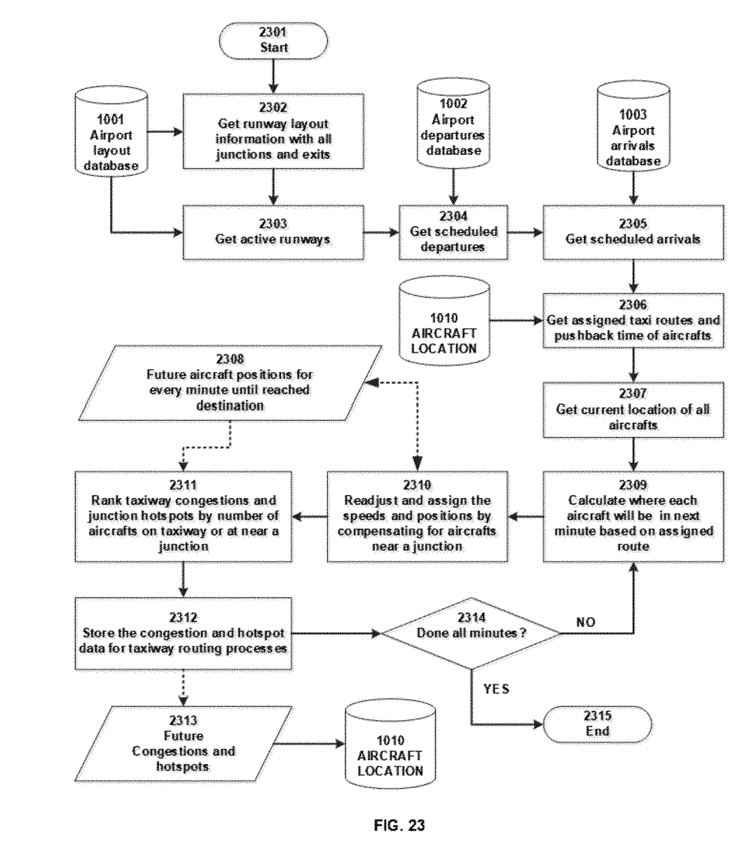

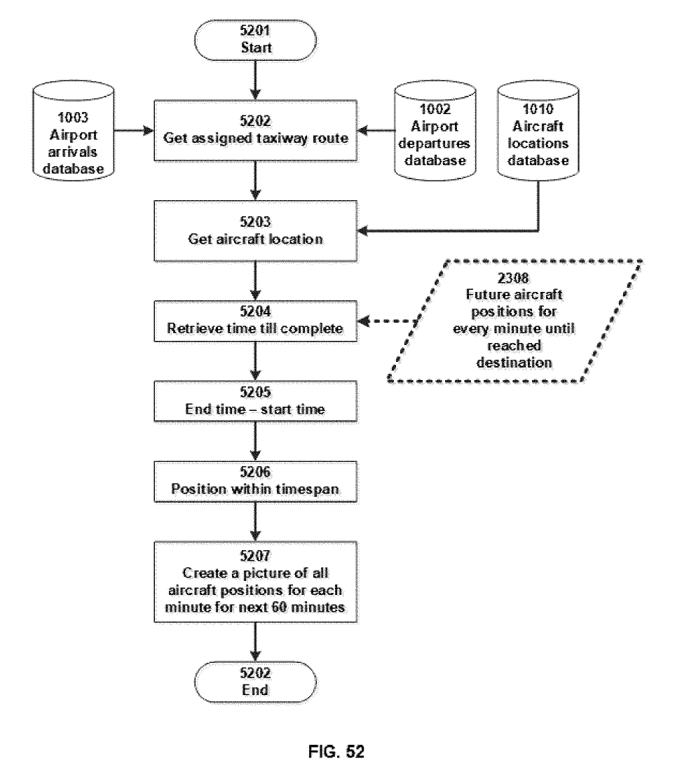

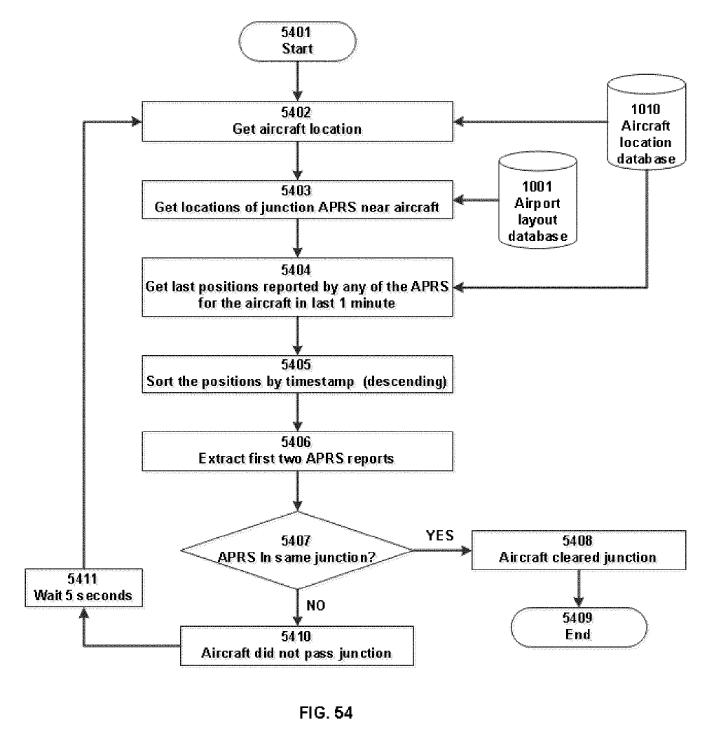

APRS [353] are also placed at all taxiway junctions and every 100 feet along each taxiway from the start of any taxiway pavement or junction, regardless of the markings. APRS [353] at taxiway junctions send a signal to the AMS [320] every time an aircraft passes its range, allowing AMS [320] to determine if an aircraft completed crossing a junction [FIG. 54] and directing the next aircraft [100] to cross the junction. Additional APRS [353] placed along the taxiway every 100 feet to signal the AMS [320] of the current location of an aircraft, allowing AMS [320] to calculate aircraft progress on a taxiway [FIG. 52], and predicting the taxiway congestions level [FIG. 23].

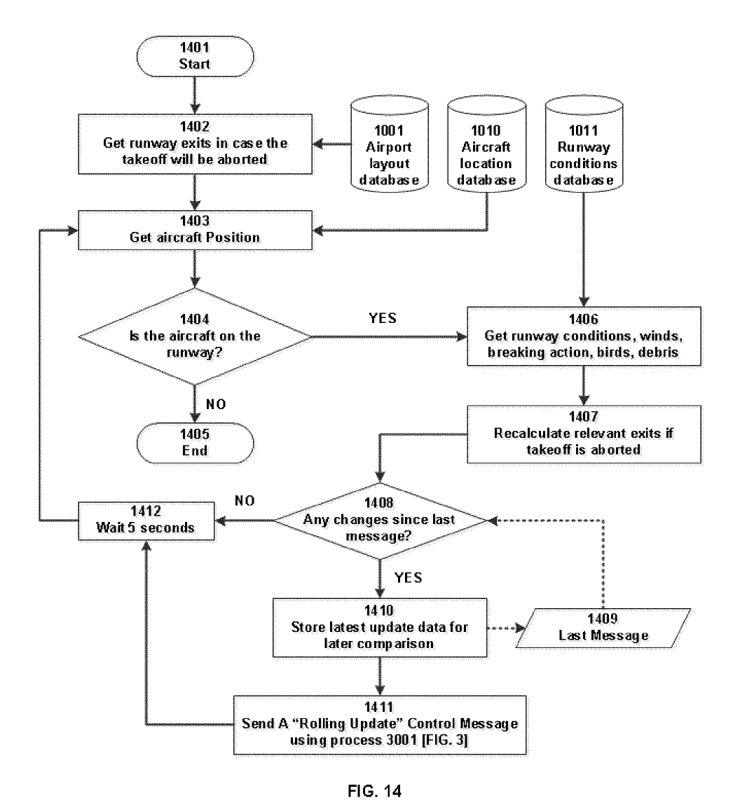

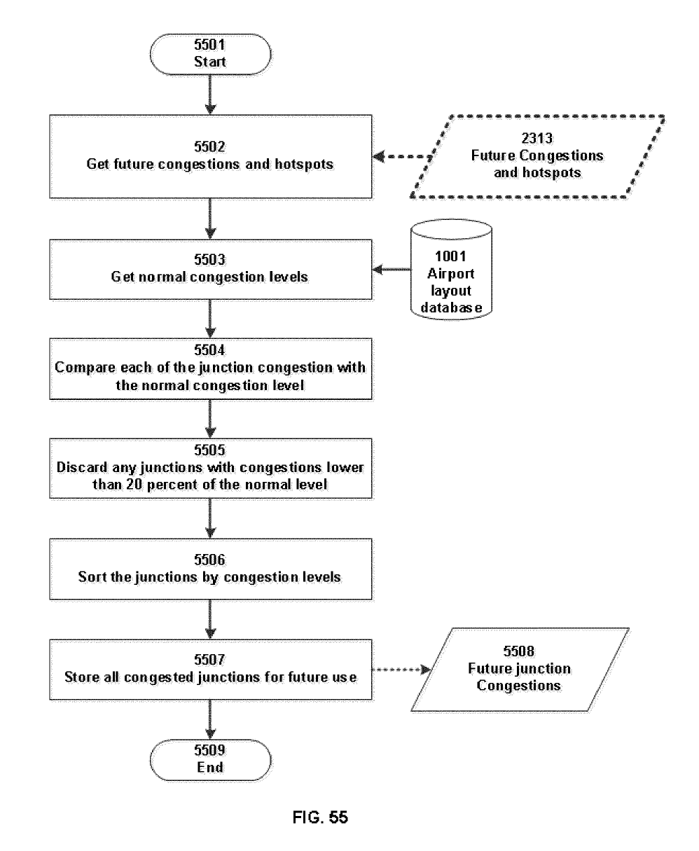

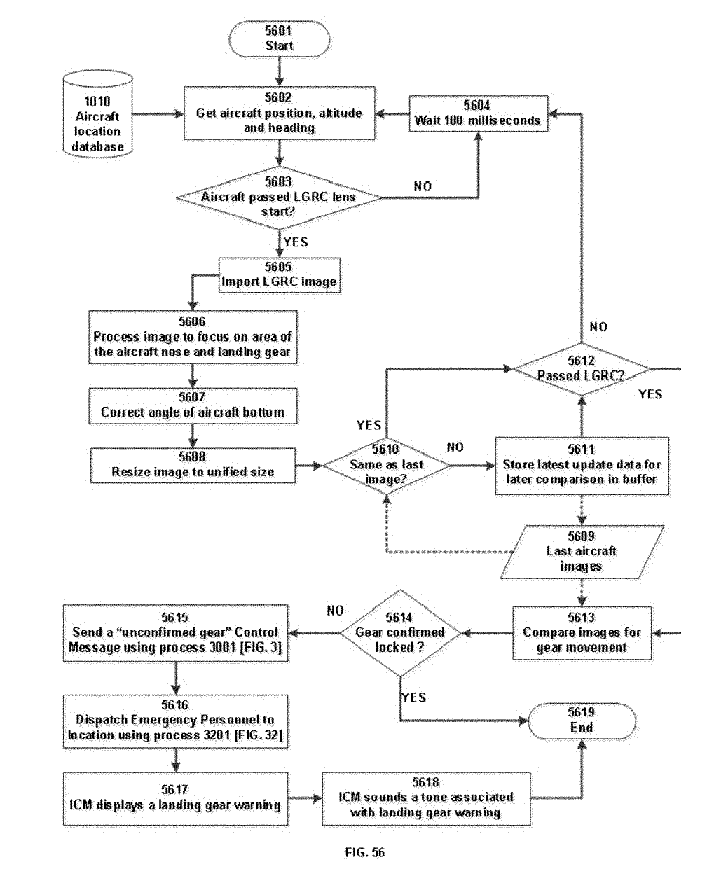

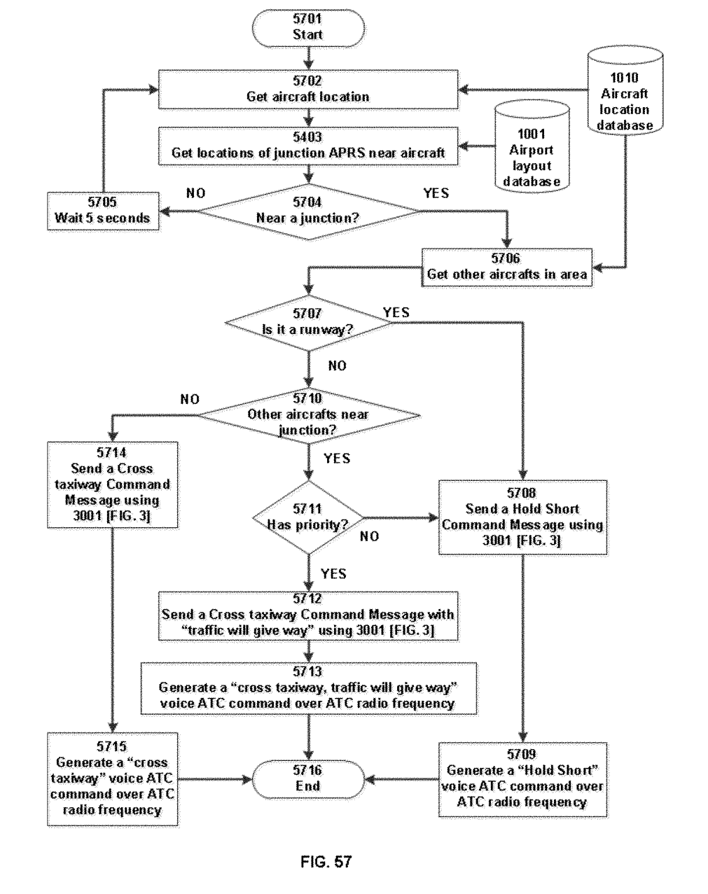

MDC [354] is a physical digital camera capturing images and is placed at every taxiway junction, providing images to the AMS [320] for calculating junction congestions and hotspots [FIG. 55] along with the APRS [353] at taxiway junctions. The LGRC [355] is a physical high-speed digital camera capturing images of the landing gear of a landing aircraft. Each image is sent to the AMS [320] for processing to confirm the landing gear is locked [FIG. 56]. When the landing gear is not confirmed to be locked, the AMS communicate a go-around command [FIG. 16] to an aircraft [100] and/or an alert notification through the ICM [330] to a standby ATC to reconfirm if the landing gear is locked.

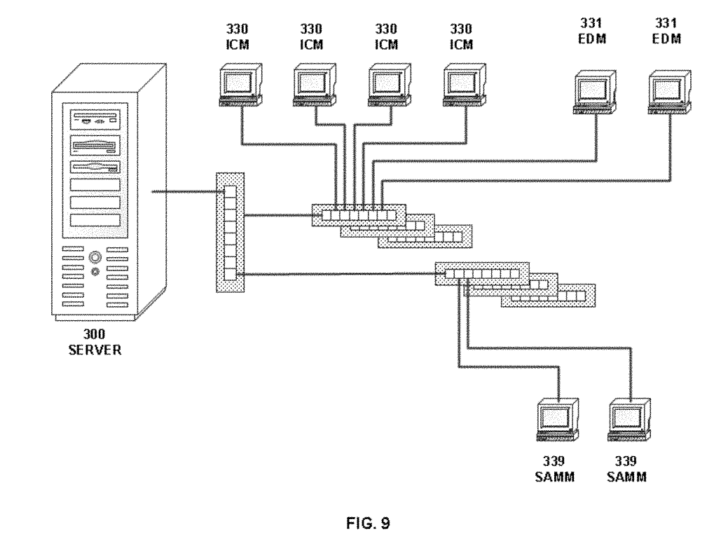

FIG. 9 illustrates an example for a typical Airport topology, with Server [300] connectivity with ICM [330], EDM [331] and SAMM [339]. Typically, an ICM [330] is at every ATC position, including; departure ATC; arrivals ATC; and Ground ATC. There is no physical limit to the number of ICM [330] stations aside network restrictions such as IP addressing and alike. An EDM [331] is typically placed at every Emergency unit, including; Fire station; ambulance post or station; security post or station; and Police post or station. There is no physical limit to the number of EDM [331] stations aside network restrictions such as IP addressing and alike. A SAMM [339] is typically placed at every airline operations facility, There is no physical limit to the overall number of SAMM [339] stations not the number of SAMM [339] stations per airline facility, aside network restrictions such as IP addressing and alike.

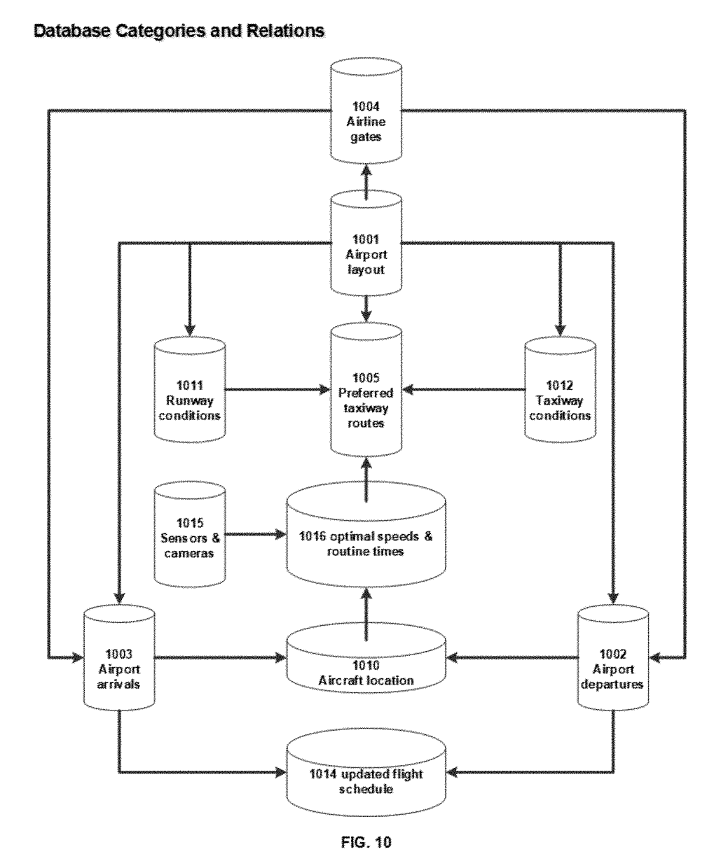

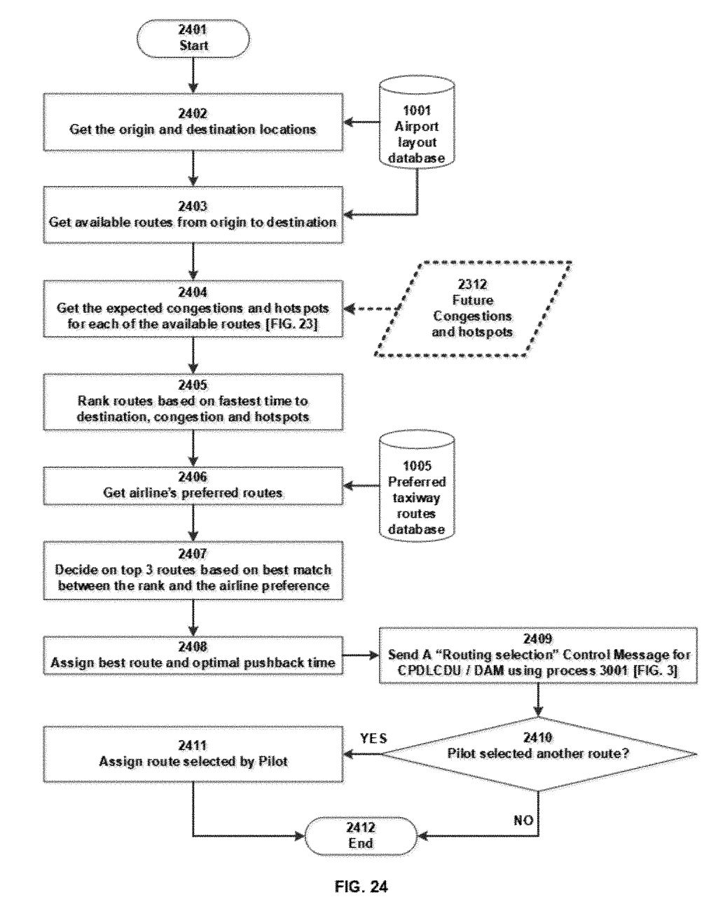

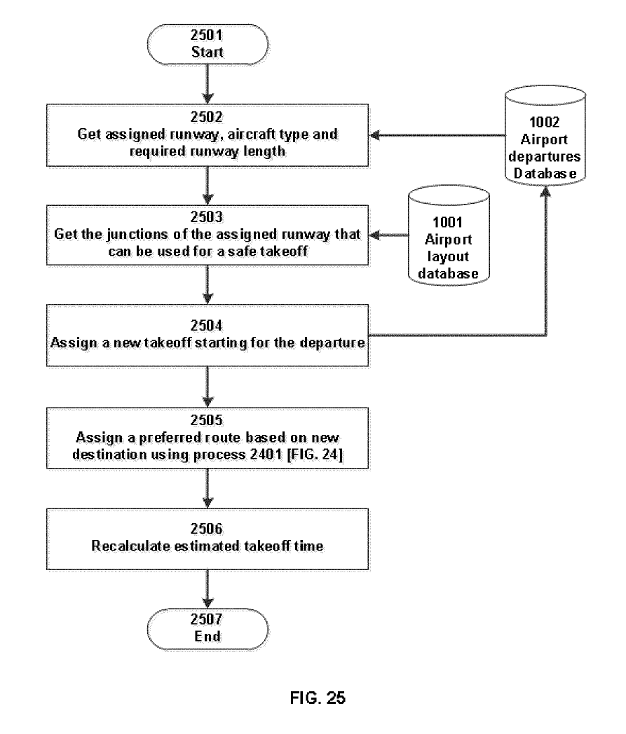

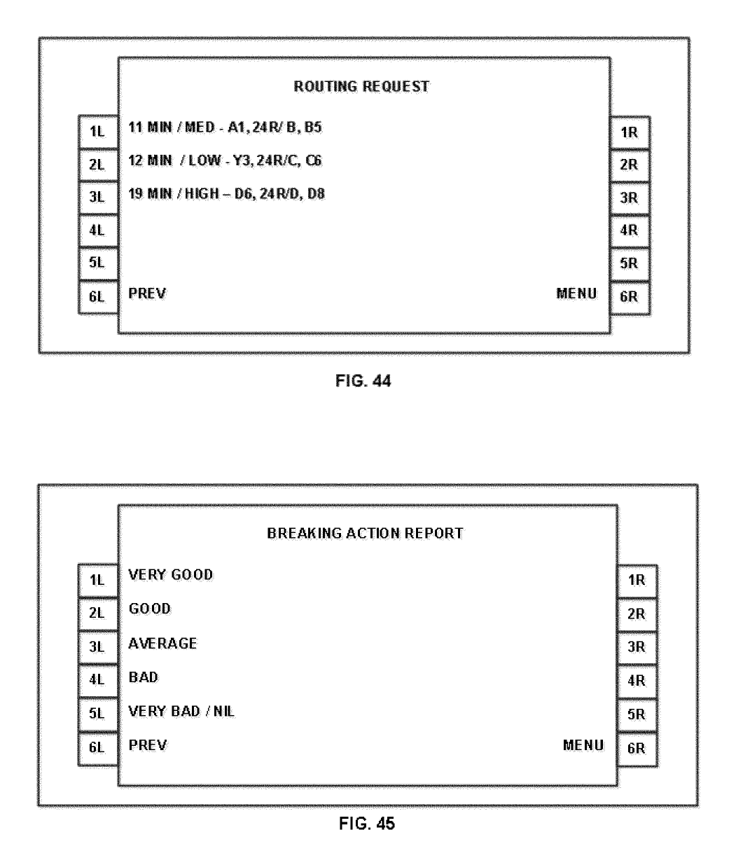

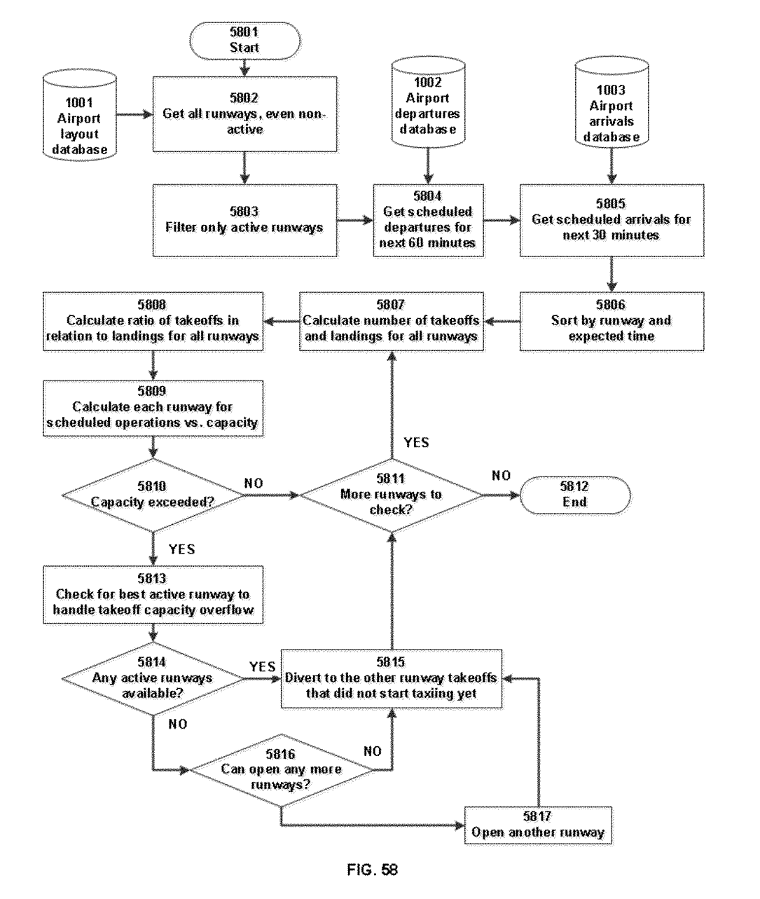

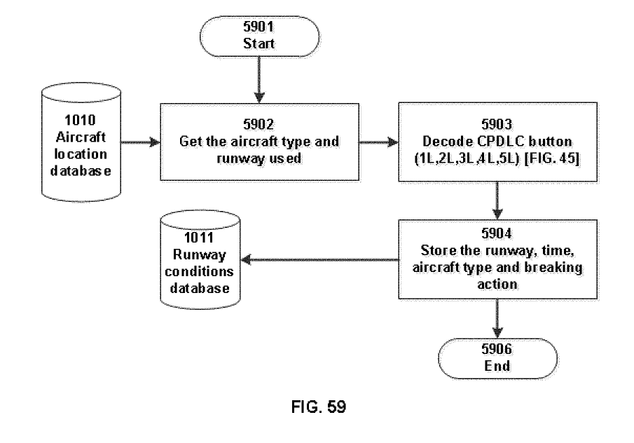

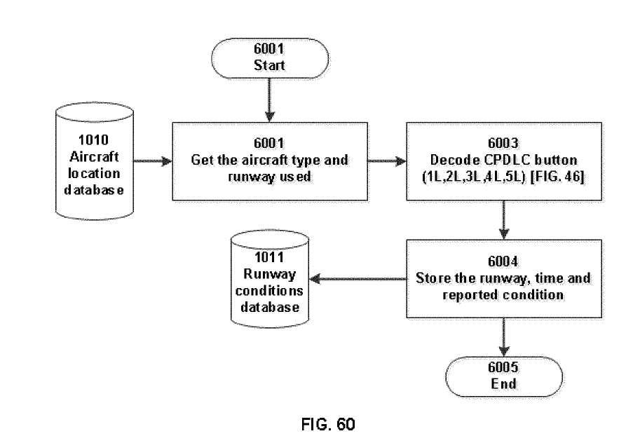

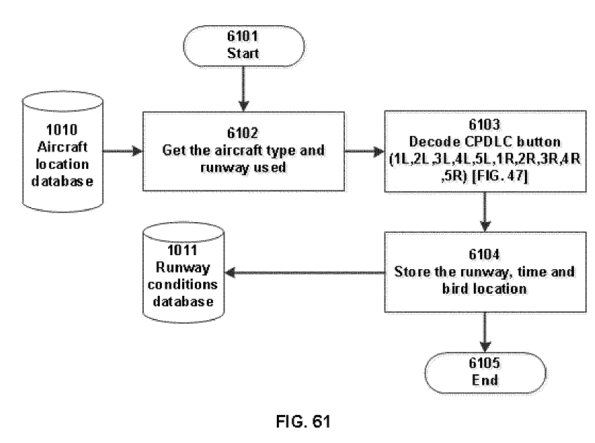

FIG. 10 illustrates the relationships between the various database categories used by AMS [320]. The databases include: Airport layout [1001]; Airport departures [1002]; Airport arrivals [1103]; Airline gates [1004]; Preferred taxiway routes [1005]; Aircraft locations [1010]; Runway conditions [1011]; Taxiway conditions [1012]; Junction conditions [1013]; updated flight schedules [1014]; sensor an camera information [1015]; and calculated current and future optimal pushback times, optimal taxi speeds and routing times [1016]. To increase the clarity of the invention, each data category within the system is shown as a separate database. In practice, the data may reside in a single database or split into several databases in any combination. Airport layout database [1001] stores the Airport static data for locations and procedures, including; names of runways, taxiways and junctions; ATC frequencies, zones, perimeters and handoff points; preferred runways, runway RNAV SIDs, and missed approach procedures for each runway; and taxiway routes; known congestion areas and hotspots. The data is entered during the Airport setup process, but is easily managed by authorized personnel through the ICM [330]. Airport departures database [1002] stores upcoming and current departure flights, from one hour prior to the departure through thirty minutes after the aircraft was handed-off to departure ATC. The scheduling data is automatically updated from several sources, including: ICM [330]; SAMM [339]; the Airport scheduling system; IATA and/or ICAO systems; and, depending on the geographic location, from the National or Continental Flight Grid. The main reason for storing data one hour prior to scheduled departure is the need for the system to process anticipated runway use, including the prediction processing runway capacity balancing and takeoff to landing ratios [FIG. 58]; predicting taxiway congestions [FIG. 23]; and avoiding the taxiway congestions and hotspots [FIG. 34]. The main reason for retaining data for aircrafts thirty minutes after handoff to departure ATC is the possibility of a non-scheduled landing when a departing aircraft has an emergency. Airport arrivals database [1003] stores upcoming and current arriving flights, from thirty minutes prior to scheduled touchdown, until the flight is closed. The scheduling data is automatically updated from several sources, including: ICM [330]; SAMM [339]; and the Airport scheduling system. The main reason for storing data thirty minutes prior to scheduled touchdown is the need for the system to process anticipated runway use, including the prediction processing of runway capacity balancing and takeoff to landing ratios [FIG. 58]; predicting taxiway congestions [FIG. 23]; and avoiding the taxiway congestions and hotspots [FIG. 24] on the way from the runway to the gate. Airline gates database [1004] stores common relationships between gates and airline operators to assist the AMS [320] in processing routing and predicting congestion areas within the Airport. The Preferred taxiway database [1005] stores historical and current data for every taxiway combination at different hours, congestion levels and weekdays, AMS [320] uses the data to calculate congestions and hotspots [FIG. 55], as well as allow pilots to select from a list of routes [FIG. 44]. Runway conditions database [1011] stores updated information for each runway at the Airport including: runway conditions; latest breaking action reported by each aircraft type; relevant turbulence information from current or previous runway operation; preferred RNAV SIDs; current wind direction and speed; areas of debris on the runway; runway status; ILS status; current ATC frequencies; and, locations of bird alerts. The information from the runway conditions database is typically used within MS [320] methods and processes to provide Pilots with current information for the runway operation. The Taxiway conditions database [1012] is typically used for storing current status of each taxiway, current congestion levels and future expected traffic, and used by processes for determining best routing to and from runways.

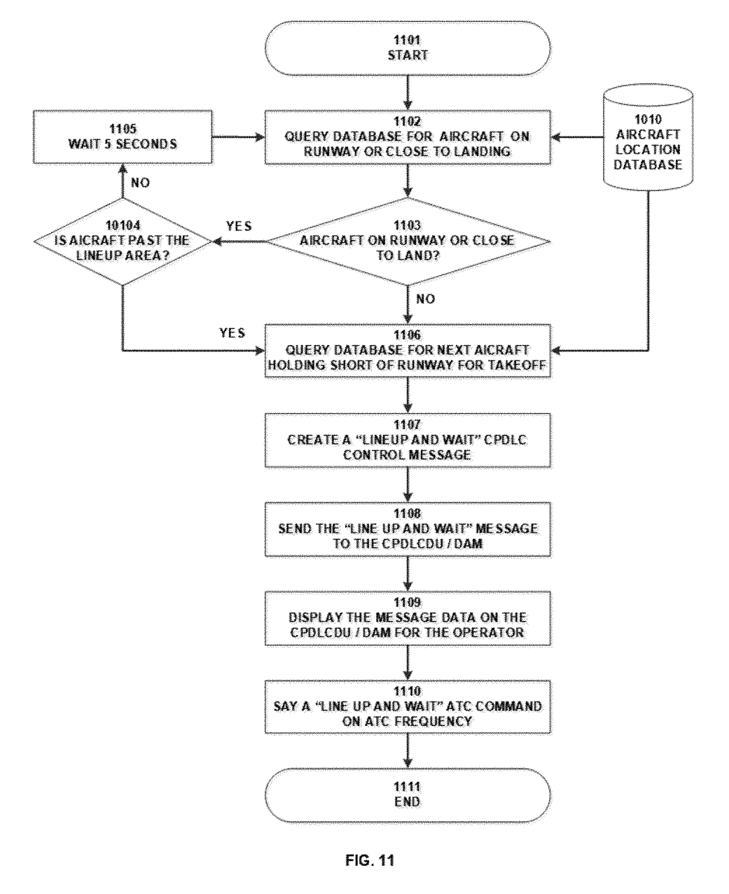

FIG. 11 illustrates a flow diagram of the processes in a method within the AMS [320] involved in issuing a “lineup and wait” ATC command to an aircraft. 1102 receives current data from the aircraft locations database [1010] on any aircraft currently on the runway or any aircraft that will be landing on the runway shortly. 1103 further checks if the aircraft has passed the lineup area where the next aircraft to takeoff will be. If the aircraft has not passed the lineup position in 1103, it means there is a landing operation taking place and need to wait 1104, and recheck again for aircraft positions 1102. As long as the runway is either clear or a landing aircraft has passed the lineup area, 1105 receives from the aircraft locations database [1010] the closest aircraft to the runway waiting for a takeoff operation. 1106 is processed as a “line-up and wait” Control Message through process 3001 [FIG. 3] and, 1107 outputs a “line-up and wait” voice command over the ATC frequency directed at the flight crew aboard the aircraft. The above example supports “line-up and wait” from any runway junction, for example, “line-up and wait runway 24L at ALPHA”. In addition, the process supports the “expedite” directive within the control message and voice commands. 1108 displays the message data on the DAM [161] or CPDLCDU [140]. 1109 outputs the audio equivalent in pilot's selected language.

FIG. 12 illustrates a flow diagram of the processes in a method within the AMS [320] involved in issuing a takeoff clearance ATC command to an aircraft. 1202 receives current data from the aircraft locations database [1010] on any aircraft currently on the runway. 1203 checks if there are any aircraft received by the 1202 process. If there is an aircraft on the runway, there is a need to wait 1204, and recheck again for aircraft positions 1202. As long as the runway is clear 1204 receives from the database [1011] the latest runway conditions applicable for the takeoff operation including; wind direction and speed; and possible alert on birds. 1206 receives aircraft departure data including the RNV SID or departure heading and/or initial climb altitude, and, contact information for departure ATC including frequency and altitude for switching to the departure ATC frequency. 1206 includes turbulence advisory from previous runway operation when relevant, 1207 creates a takeoff clearance Control Message processed by 3001 [FIG. 3], and 1208 outputs the takeoff clearance ATC directive over the ATC radio frequency. The process supports takeoff clearance from any runway junction, for example, “cleared for takeoff runway 24L at ALPHA”. In addition, the process supports the “immediate” and “expedite” directives within the control message and voice commands.

FIG. 13 illustrates a flow diagram of the processes in a method within the AMS [320] involved in issuing a landing clearance ATC command to an aircraft. 1302 receives current data from the aircraft locations database [1010] on any aircraft currently on the runway. 1303 checks if there is any aircraft received by the 1202 process. If there is an aircraft on the runway, there is a need to issue go around Control Message 1314 using process 1601 [FIG. 16]. If there is no aircraft on the runway, 1304 gets the runway conditions applicable for the landing operation including; wind direction and speed; and possible alert on birds. 1305 gets the assigned gate, associated runway exit and ATC Ground frequency. 1306 adds turbulence advisory information if applicable and 1308 outputs the landing clearance ATC directive over the ATC radio frequency if a landing clearance is issues. If a landing clearance is not given in time, 1309 outputs a go-around or missed approach ATC directive over the ATC radio frequency.

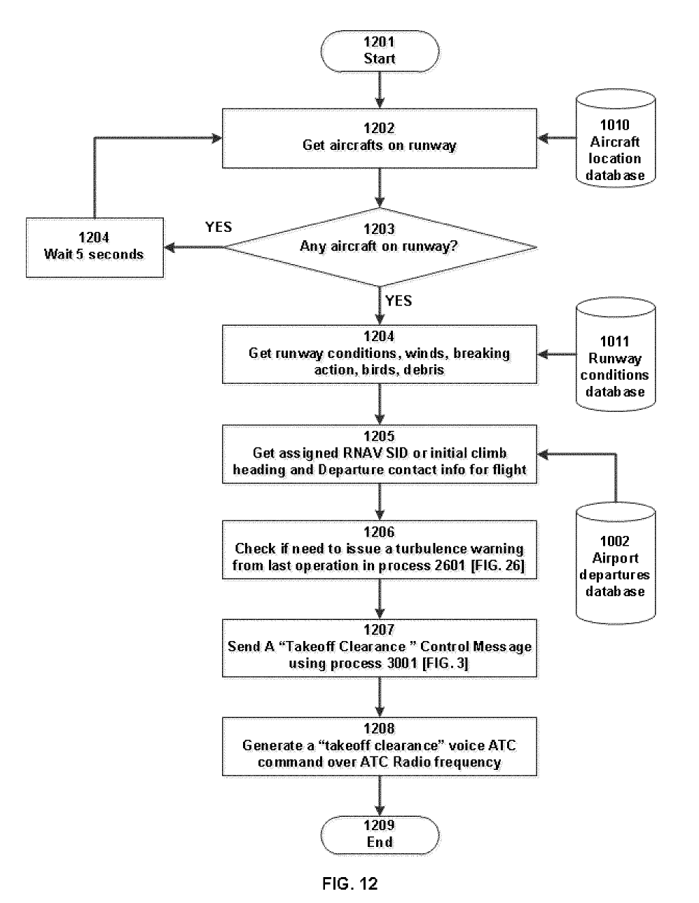

FIG. 14 illustrates a flow diagram of the processes in a method within the AMS [320] involved in updating DAM [161] or CPDLCDU [140] while an aircraft is rolling during a takeoff operation with the possibility the takeoff will be aborted. After the flight crew aboard an aircraft [100] confirms the takeoff clearance 1402 by manually actuating the button [141] associated with the “rolling” function on the DAM [161] or CPDLCDU [140]. 1403 receives all possible runway exits from the Airport Layout Database [1001] in case the takeoff is aborted and needs to exit the runway. 1404 receives the latest aircraft location from the aircraft location database [1010], 1405 checks if the aircraft is still rolling or airborne. If the aircraft is no longer on the runway, the process ends. Once 1405 determined the aircraft is still on the runway, 1406 receives from the airport conditions database [1011] the latest runway conditions applicable for the takeoff operation, including turbulence from previous runway operation, wind direction and speed and possible alert on birds. 1407 calculates the possible exits in case the takeoff is aborted. 1408 checks if there are any changes since the last message sent to the DAM [161] or CPDLCDU [140], if there are no changes since the last update sent to the DAM [161] or CPDLCDU [140] the process waits for a few seconds 1412 and restarts by receiving the latest Aircraft Position 1404. If there were changes since the last update sent to the DAM [161] or CPDLCDU [140], 1409 prepares a new DAM [161] or CPDLCDU [140] message containing any changes in the runway conditions from 1406 and, with the exit information from 1407 in case the takeoff is aborted. 1410 sends the Control Message to DAM [161] or CPDLCDU [140] for display, 1411 displays the updated information on the DAM [161] or CPDLCDU [140] for the flight crew. The process waits for a few seconds 1412, and restarts by receiving the latest Aircraft Position 1404. The process continues for as long as the aircraft is on the runway unless the takeoff was aborted or the aircraft is airborne.

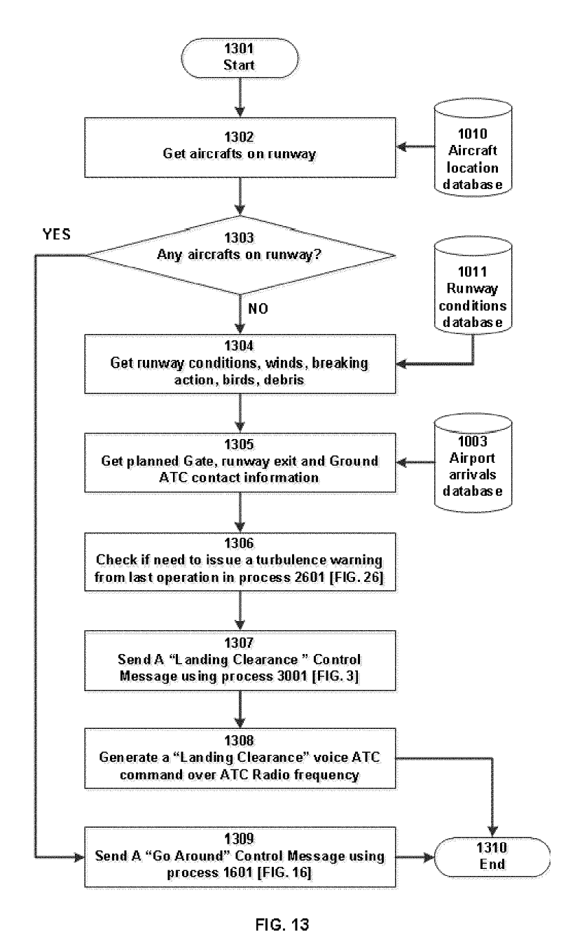

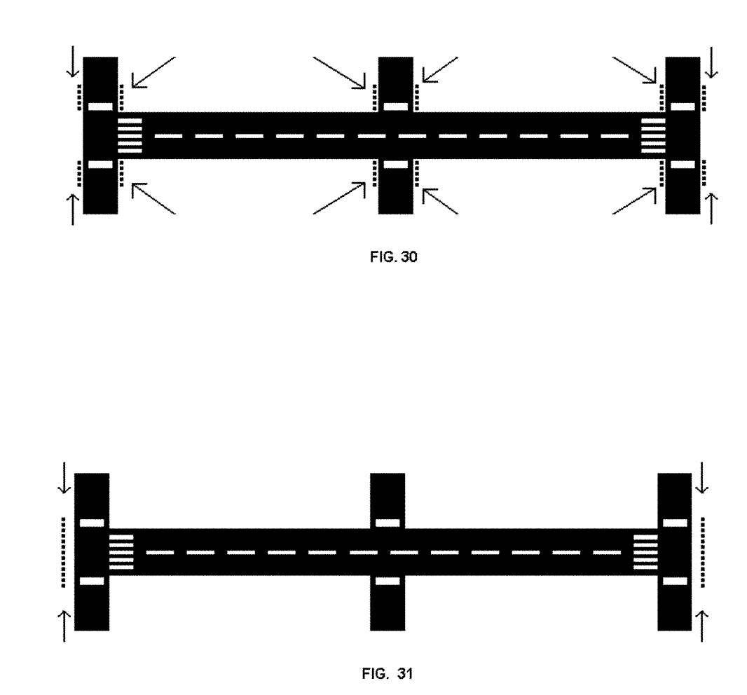

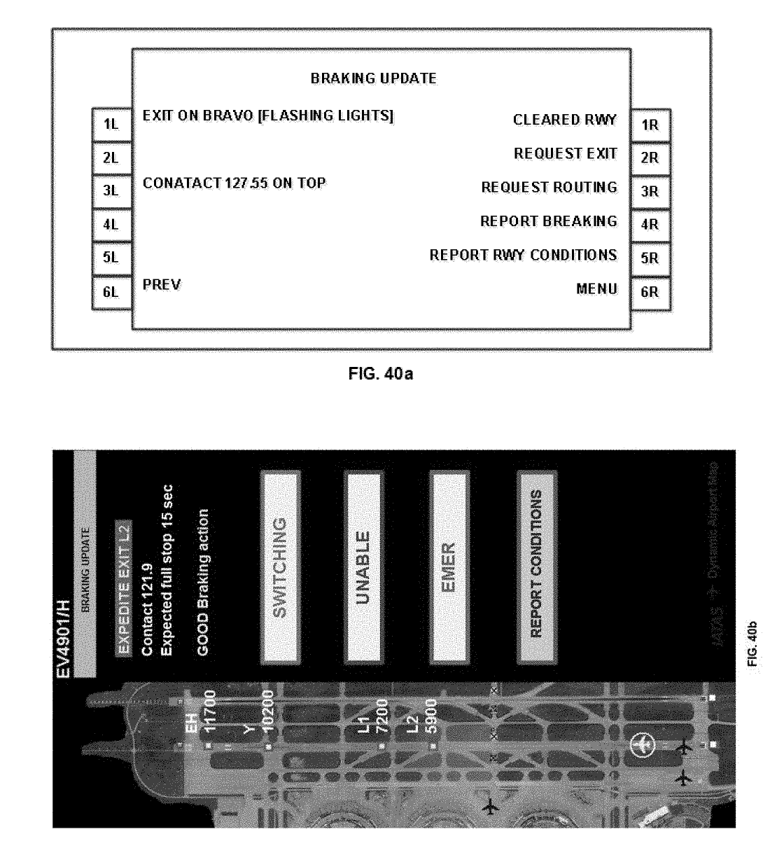

FIG. 15 illustrates a flow diagram of the processes in a method within the AMS [320] involved in updating DAM [161] or CPDLCDU [140] while an aircraft is breaking during a landing operation. Once the landing aircraft [100] is over the runway area, regardless if a touchdown occurred, 1502 gets the available exits for the runway in use. 1503 is constantly updated with the latest aircraft [100] location on the runway from the Aircraft Location Database [1010], 1504 determines if the aircraft has landed and has started breaking. 1505 stops flashing the exit AFL (airfield lighting) [10] [FIG. 30] if 1504 has determined that the aircraft is no longer on the runway and the process is terminated. 1507 gets the latest runway conditions from the Runway Conditions Database [1011] and 1508 receives the updated list of available runway exists from process 5101 [FIG. 51]. 1510 compares the latest data with the last sent Control Message stored in 1409. If there is no change from last sent Control Message in 1510,1514 waits and restarts the process from 1503 for as long as the aircraft is landing, breaking or is still on the runway. If the latest information is different than the last sent Control Message [1510] stored in 1409, 1511 stores the latest Control Message in 1509 for the next time 1510 is executed. Once 1511 stores the latest Control Message in 1509, 1512 uses process 3001 [FIG. 3] to display the latest information to the flight crew [FIG. 40]. The exit lights processed by 1508 will flash for as long as the aircraft [100] has not passed the exit or cleared the runway. As 1508 output changes an exit, the prior exit AFL (airfield lighting) [10] stop flashing. 1514 waits and restarts the process from 1503 for as long as the aircraft is landing, breaking or is still on the runway.

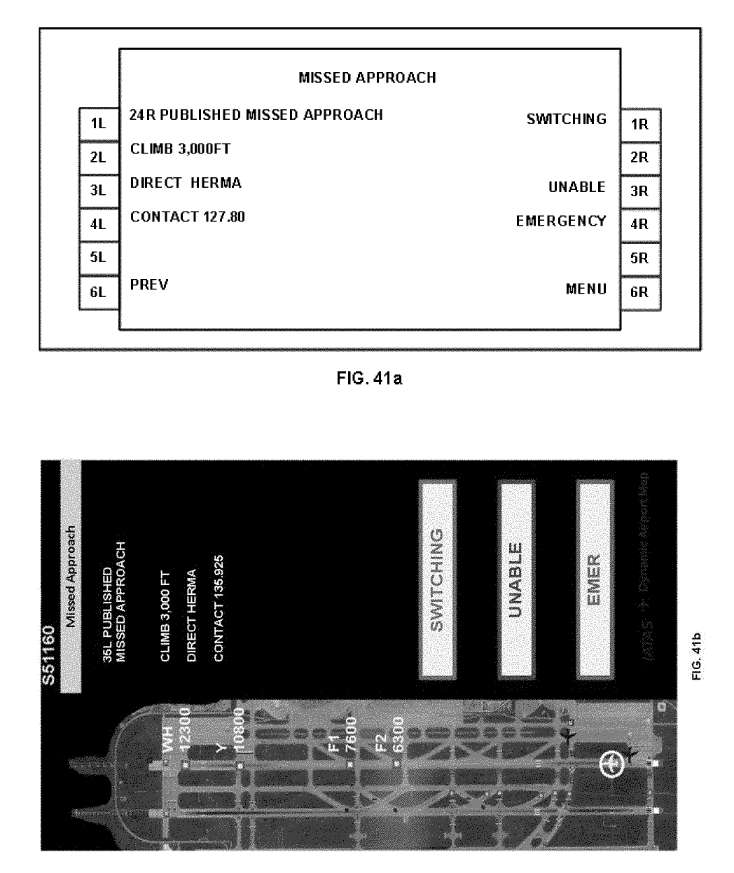

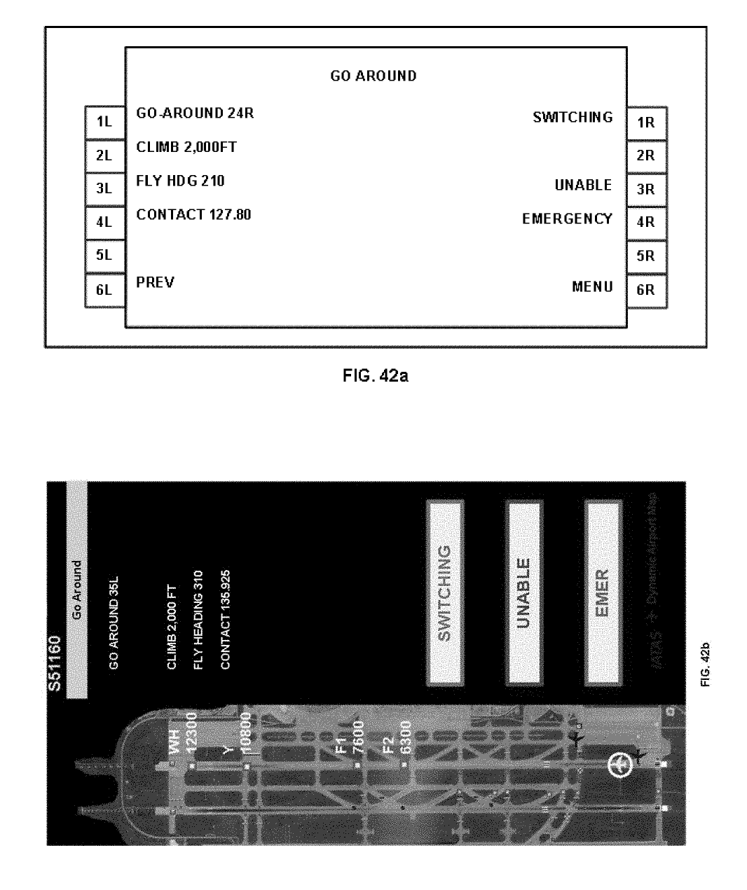

FIG. 16 illustrates a flow diagram of the processes in a method within the AMS [320] involved with managing a Go-Around or Missed Approach. Once a Pilot requests a Go-Around or a Missed Approach, 1602 gets information associated to missed approach and go-around from the Airport Layout Database [1001]. 1603 decides on a missed approach or go-around based on the incoming request. For Go-Around, 1604 sends a confirmation through process 3001 [FIG. 3] to update the DAM [161] or CPDLCDU [140] with relevant information associated to the Go-Around [FIG. 42], 1605 outputs a “Go-Around” voice command over the ATC frequency directed at the flight crew aboard the aircraft. In addition, 1606 notifies the departure ATC of the go-around through the ICM [330] display and 1607 sounds a tone associated to a go-around over the ICM [330] to ensure the departure ATC is notified. For a Missed Approach, 1610 sends a confirmation through process 3001 [FIG. 3] to update the DAM [161] or CPDLCDU [140] with relevant information associated to the Missed Approach [FIG. 41], 1611 outputs a “Missed Approach” voice command over the ATC frequency directed at the flight crew aboard the aircraft. In addition, 1612 notifies the departure ATC of the Missed Approach through the ICM [330] display and 1613 sounds the tone associated to a Missed Approach over the ICM [330] to ensure the departure ATC is notified. In both Go-Around and Missed Approach, 1608 flashes the runway lights [FIG. 31] to notify the pilot not to land.

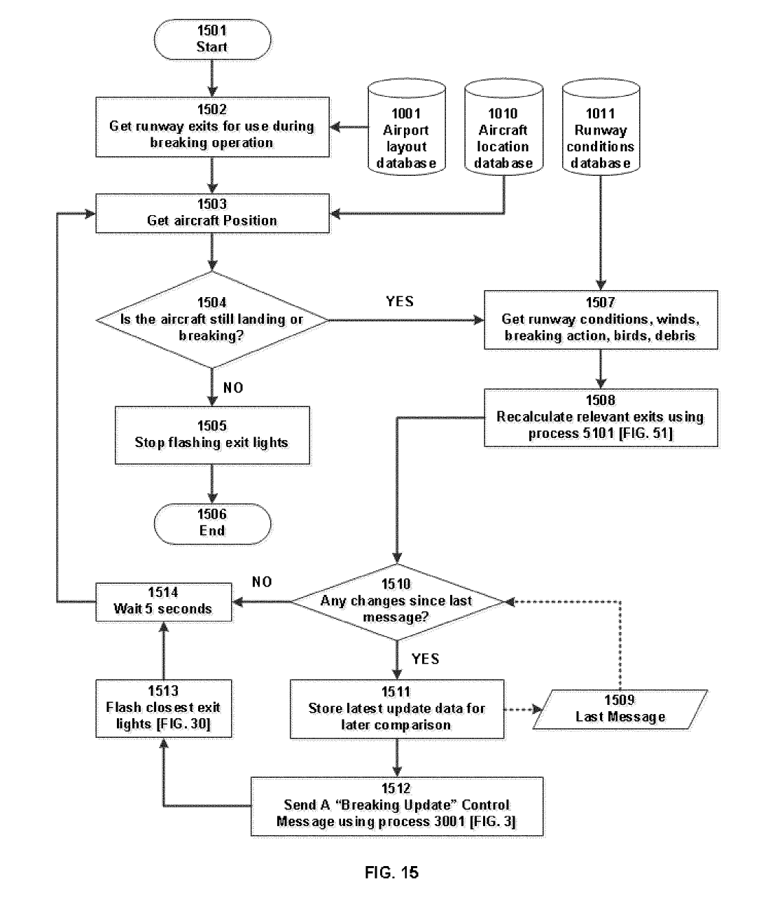

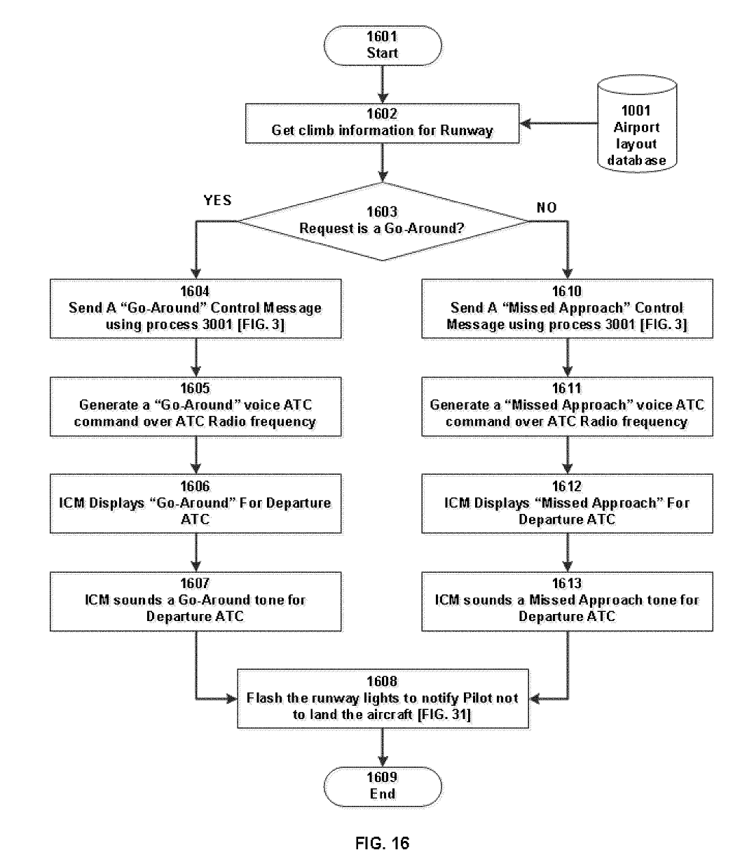

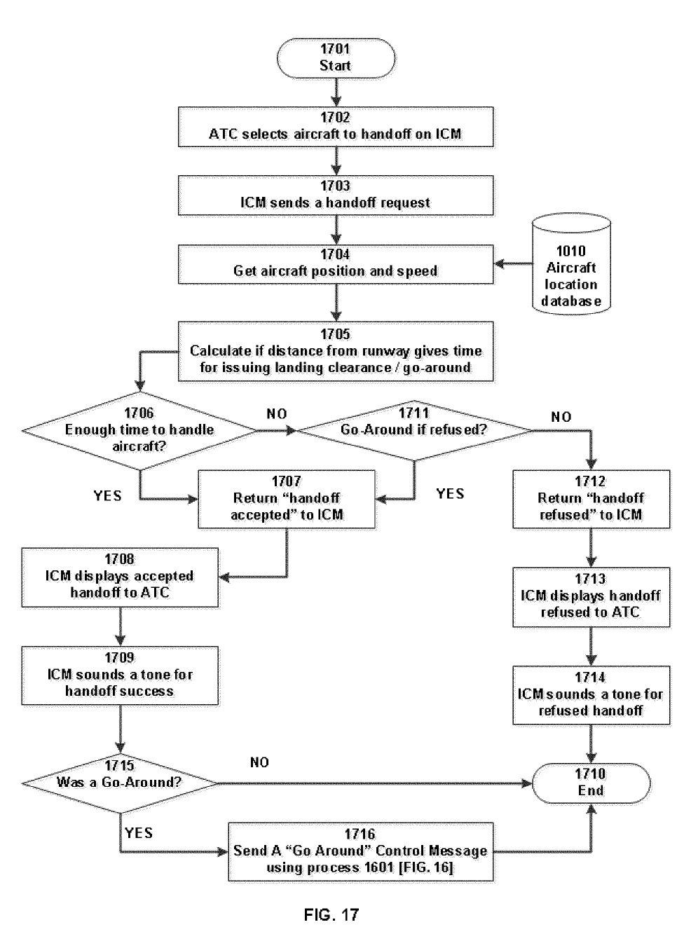

FIG. 17 illustrates a flow diagram of the processes in a method within the AMS [320] involved with accepting an aircraft handoff from Approach ATC. The ATC selects the aircraft to handoff via the ICM [330] 1702, the ICM [330] sends the AMS [320] a handoff request for the aircraft 1703, 1704 receives the latest location and speed from the aircraft from the location database [1010] for the aircraft being handed off. 1705 calculates if there is enough time to handle the aircraft after the handoff. 1706 decides to accept the handoff based on the calculations in 1705. If 1706 decides to accept the handoff, 1707 sends the ICM [330] a message for accepting the handoff operation. Once the handoff is accepted, 1708 displays the handoff was accepted on the ICM [330] and sounds an audio tone associated with accepting a handoff 1709. If 1706 decides there is not enough time to handle the aircraft, 1711 further checks ATC allows automated go-around if a handoff is refused. If ATC allows automated go-around and, if a handoff is refused, 1707 sends the ICM [330] a message for accepting the handoff operation, 1708 displays the handoff was accepted on the ICM [330] and sounds an audio tone associated with accepting a handoff 1709. 1715 will issue a go-around directive via process 1601 [FIG. 16] when 1711 checks if ATC allows for automated go-around on refused handoffs. If 1711 outputs false, 1712 sends the ICM [330] a message for refusing the handoff operation. Once the handoff is refused, 1713 displays the handoff was refused on the ICM [330] and sounds an audio tone associated with refusing a handoff 1714. 1715 checks if a control message should be issued for either a go-around or missed approach.

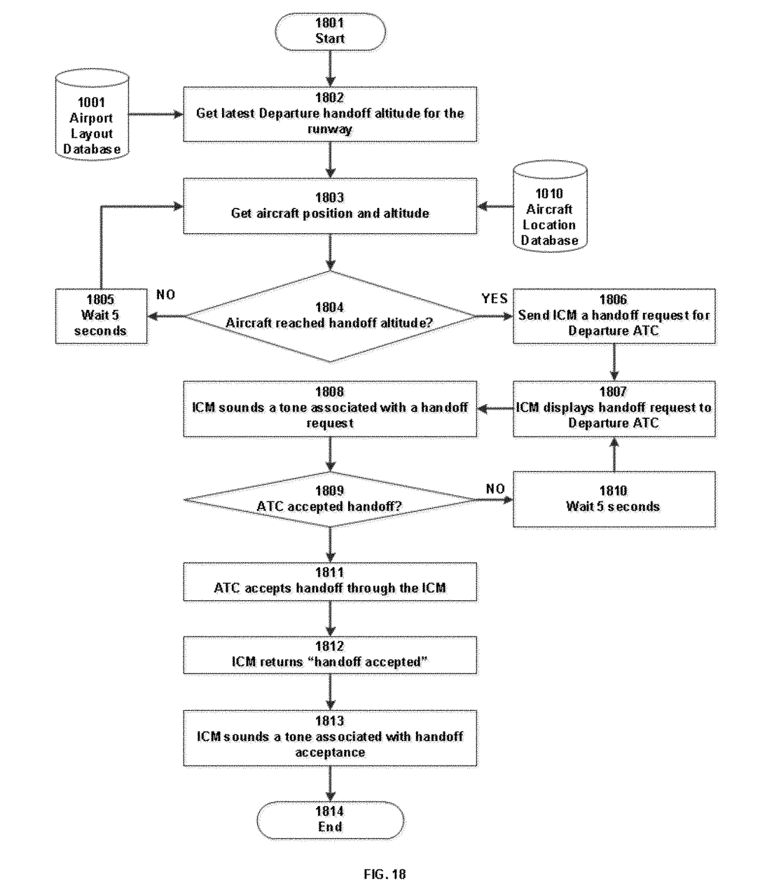

FIG. 18 illustrates a flow diagram of the processes in a method within the AMS [320] involved with an aircraft handoff operation to Departure. Once an aircraft is airborne, 1802 receives the latest Departures handoff altitude and frequency associated with the runway. 1803 receives the altitude of the aircraft, and 1804 checks for the aircraft altitude to be above the handoff altitude from 1802. As long as the aircraft has not reached the handoff altitude, the aircraft altitude is checked every few seconds in 1805. Once the aircraft reached the handoff altitude, AMS [320] sends ICM [330] a handoff request message 1806, to display to the ATC for acceptance 1807 and sound a tone associated with a handoff request 1708. Once the ATC accepts the aircraft handoff request from the ICM [330] in 1809 over the ICM [330], the ICM [330] sends AMS [320] a message of handoff acceptance 1811, and sounds a tone to the ATC over the ICM [330] associated with a handoff acceptance 1813. Until ATC accepts the handoff in 1809, 1810 waits and redisplays the handoff request 1807 and sounds the handoff request tone in 1808 every few seconds.

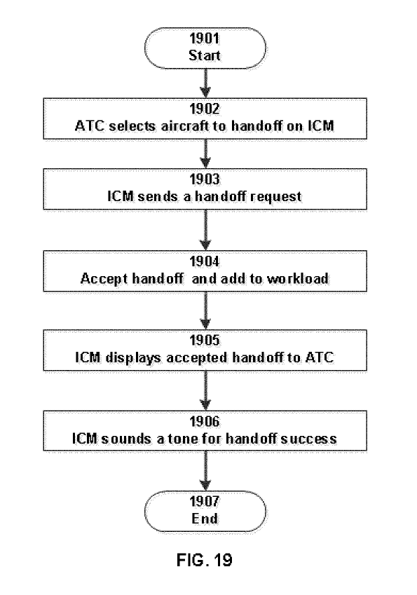

FIG. 19 illustrates a flow diagram of the processes in a method within the AMS [320] involved with automatically accepting an aircraft handoff from Ground ATC. Once ATC selected the aircraft for handoff [100] through the ICM [330] 1902, the ICM [330] sends a ground handoff request to AMS [320] 1903, 1904 accepts the handoff and adds to the overall workload of the AMS [320] and displays the success in 1905. The ICM [330] displays the handoff acceptance to the ATC 1705 and sounds a tone to the ATC over the ICM [330] associated with a handoff acceptance 1706. Depending on regulations, it is typical for Pilots switch to Ground ATC frequencies and the handoff between Controllers is not required.

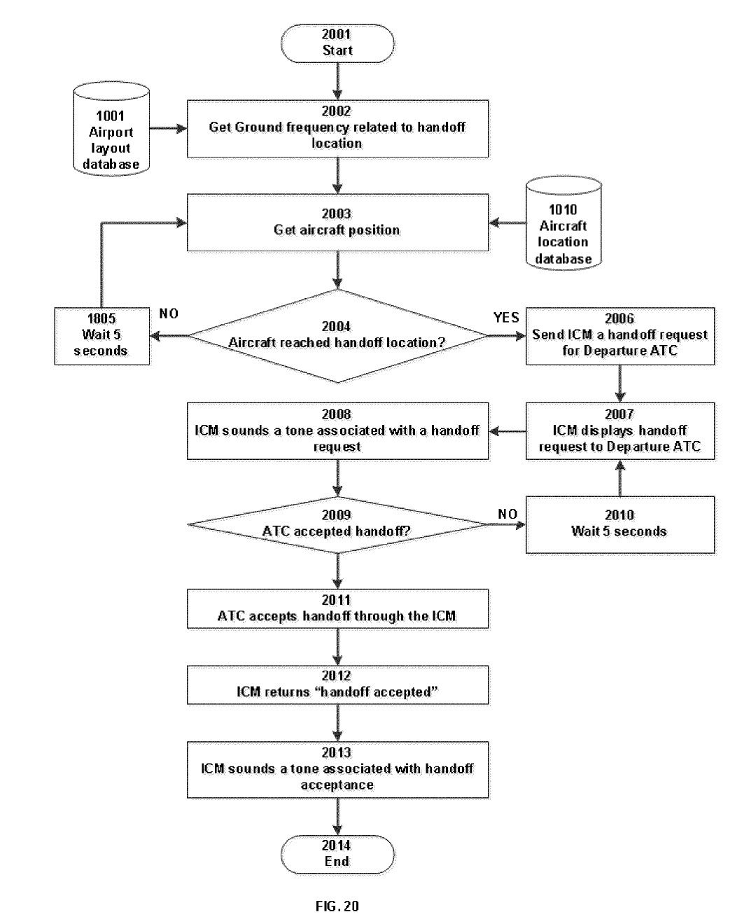

FIG. 20 illustrates a flow diagram of the processes in a method within the AMS [320] involved with an aircraft handoff operation to Ground ATC. Once an aircraft has crossed the runway or is exiting the runway from a landing, 2002 receives the ATC frequency associated with the runway. 2003 receives the aircraft position, and 2004 checks for the location of the aircraft in relation to the handoff location from 2002. As long as the aircraft has not reached the handoff location, the aircraft location is rechecked every few seconds 2005. Once the aircraft reached the handoff location, AMS [320] sends ICM [330] a handoff request message 2006, to display to the ATC for acceptance 2007 and sound a tone associated with a handoff request 2008. Once the ATC accepts the aircraft handoff request from the ICM [330] in 2009 over the ICM [330], the ICM [330] sends AMS [320] a message of handoff acceptance 2011, displays the acceptance in 2012 and sounds a tone to the ATC over the ICM [330] associated with a handoff acceptance 2013. Until ATC accepts the handoff in 2009, 2010 waits and redisplays the handoff request 2007 and sounds the handoff request tone in 2008 every few seconds. Depending on regulations, it is typical for Pilots to switch from Ground frequency and the handoff between Controllers is not required.

FIG. 21 illustrates a flow diagram of the processes in a method within the AMS [320] involved in Timing runway crossings during landing operations. 2102 gets the exits and taxiways associated to the runway from the Airport Layout Database [1001]. 2103 gets current runway operation and the next scheduled landing from the Aircraft Location Database [1010]. 2104 checks if there is any aircraft rolling or is during a landing and did not passed the crossing junction. As long as 2104 outputs false, 2105 waits and retries to check in 2103 of any aircraft operations. Once a takeoff roll or a landing passed the crossing junction, 2106 will further check is there is sufficient time to complete the crossing operation prior to the next operation. If there isn't enough time, 2105 will wait and locations of other aircraft operations will be rechecked again in 2103. Once 2106 calculates there is enough time to cross the runway, 2107 uses process 3001 [FIG. 3] to display the Pilot the ATC command to cross the Runway. In addition, 2108 outputs a “cross runway” voice command over the ATC frequency directed at the flight crew aboard the aircraft. 2109 sends signal to the AFL [10] and flashed the lights at the crossings.

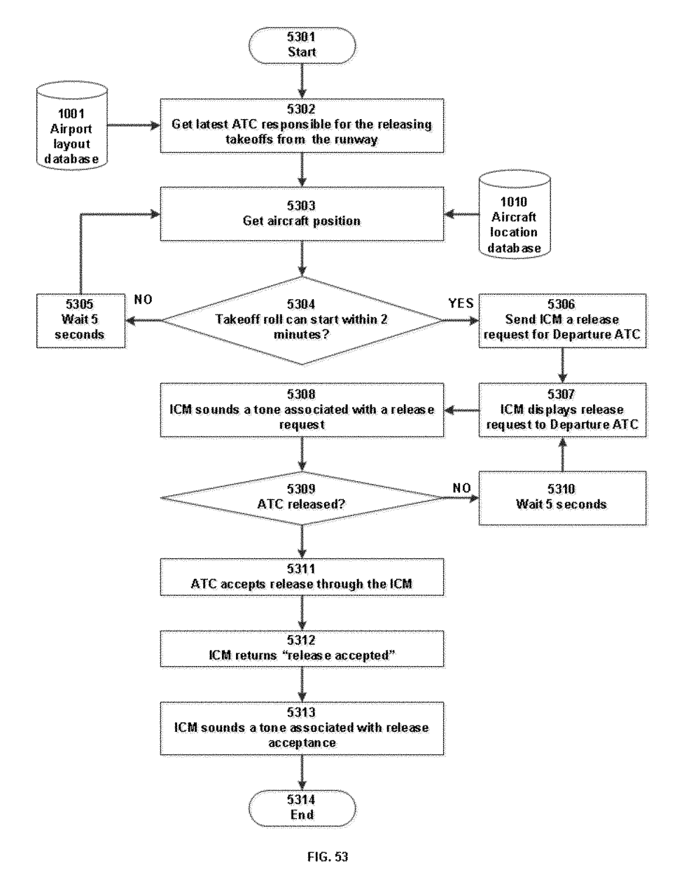

FIG. 22 illustrates a flow diagram of the processes in a method within the AMS [320] involved in simultaneously managing multiple runway operations. 2202 retrieves active runways in use from the Airport Layout Database [1001]. 2203 extracts all taxiways for each of the active runways from the Airport Layout Database [1001]. 2204 retrieves the next 10 scheduled landings and 2205 retrieves the next 2 takeoffs for each of the active runways from the Aircraft Locations Database [1010]. 2206 retrieves the updated runway conditions for each of the active runways from the Runway Conditions Database [1011]. Once all the data is pulled, 2207 calculates the time when an aircraft on each of the runways used for takeoffs will be airborne. After 2007 calculates airborne time for each of the active runways, 2208 checks for the next takeoff scheduled for each of the runways. As long as there are no scheduled takeoffs left on any of the active runways, the process is complete 2209. For as long as there are still scheduled takeoffs on any of the runways, 2210 checks if there is enough time to execute the takeoff operation on each runway. If there is no time on all of the runways for a takeoff the process is terminated 2209 and 2202 will be executed again after the next landing on any of the runways. As long as there is enough time for a takeoff on at least one runway, 2211 will request release from departure ATC using process 5301 [FIG. 53] for each takeoff. For every release approved by departure ATC 2212, during parallel takeoff operations without an RNAV SID, 2213 applies the 15 degree rule on the heading of the takeoff. Each of the takeoffs are handled by process 1201 [FIG. 12]. The processes is repeated for as long as 2202 calculates there is enough time for at least one takeoff.

FIG. 23 illustrates a flow diagram of the processes in a method within the AMS [320] involved with predicting taxiway congestions and hotspots. 2302 extracts all runways, taxiways, junctions and routes from the Airport Layout Database [1001]. 2303 retrieves the active runways in use. 2304 retrieves the scheduled departures with their assigned routes to the runway from the Aircraft Location Database [1010]. 2305 retrieves the scheduled arrivals with their assigned routes after landing from the Aircraft Location Database [1010]. 2306 processes all the assigned routes of all the departures and arrivals retrieved by 2304 and 2305. 2307 processes the current locations of all aircrafts moving on taxiways and runways. Once all the data is readily available for processing, 2309 calculates the future anticipated position for each aircraft for every minute until the flight has either departed or closed. 2310 readjusts the location of each aircraft positions based on the number of aircrafts at each junction at the each point in time. The location data is stored in 2308 for each aircraft for every minute. 2308 is used internally within the process for in-memory positions of all airside objects by 5 second intervals for a period of up-to 240 minutes. 2311 ranks each taxiway and junction based on the number of aircrafts in the area and 2312 stores the data for every minute for every taxiway and junction to be used by processes associated to calculating aircraft progress on a taxiway [FIG. 52], calculating junction congestions [FIG. 55], congestion avoidance [FIG. 24] and allowing a Pilot to select from preferred list of routes to and from a runway [FIG. 44]. After 2312 stores the data, 2314 forces process 2309 to be executed sixty times resulting in future congestion data for sixty minutes available to the above processes.

FIG. 24 illustrates a flow diagram of the processes in a method within the AMS [320] involved in avoiding congested taxiways and hotspot crossings when assigning routing to and from a runway. 2402 extracts all runways, taxiways, junctions from the Airport Layout Database [1001]. 2403 extracts all available routes based on origin and destination endpoints. 2404 retrieves the taxiway and junction congestion data from process 2301 [FIG. 23]. 2405 ranks all origin to destination endpoint routes based on the congestions and hotspots data. 2406 retrieves the preferred routes for each of the airline from the Preferred Taxiway Routes Database [1005]. 2407 processes the preferred airline routes with the ranked routes from 2405 and assigns the best possible route to the aircraft based on airline preference, anticipated congestion levels, expected taxi time and use of fuel. 2408 calculates the best pushback times for each airside object at a gate or stand by using the output from 2308 [FIG. 23]. 2409 sends the Pilot a routing selection Control Message through process 3001 FIG. 3 and the Pilot can accept the route of select another route. If a Pilot selects a different route 2410 through the DAM [161] or CPDLCDU [140] as shown in FIG. 44, the selected route will be assigned 2411.

FIG. 25 illustrates a flow diagram of the processes in a method within the AMS [320] to maximize takeoff operations on long runways. 2502 retrieves all scheduled departures and assigned takeoff runway from the Airport Departures Database [1002]. 2503 retrieves all the runway junctions that can be used for safe takeoff operations by the type of aircraft from the Airport Layout Database [1001]. 2504 assigns the new takeoff junction instead of the default start of runway location. 2505 uses process 2401 [FIG. 24] to reassign preferred routing to the runway and 2506 recalculates the estimated time for takeoff. For example: a runway totaling 11,000 feet with a junction 3,000 feet from the lineup position has a junction, leaving 8,000 feet of usable runway pavement. The 8,000 feet provide safe takeoff for a B737 in most conditions. This solution provides optimal use of runway and more spacing between takeoffs followed by a landing operation.

FIG. 26 illustrates a flow diagram of the processes in a method within the AMS [320] involved in issuing a turbulence advisory during landing or takeoff clearance, in accordance with an example embodiment, 2602 gets current runway operation from the Aircraft Locations Database [1010], the process is terminated and if the aircraft type is not classified as “Heavy” in 2603. If 2604 determines the aircraft classification is Heavy”, 2605 retrieves the current location of the aircraft. 2606 calculates the distance between the current operation and the next takeoff or landing operation. 2607 determines if the turbulence can affect the next landing of takeoff operation. If 2607 outputs false the process is terminated. If 2607 output is true, 2608 looks if the next operation is a takeoff or a landing. If the next operation is a takeoff, 2609 adds a turbulence warning to the Command Message in process 1207 [FIG. 12] and 2610 adds a turbulence warning to the voice buffer in process 1208 [FIG. 12]. If the next operation is a takeoff, 2611 adds a turbulence warning to the Command Message in process 1207 [FIG. 12] and 2612 adds a turbulence warning to the voice buffer in process 1208 [FIG. 12]. For example, a takeoff with a turbulence warning would include the phrase “caution turbulence for a departing 747” in both the Command Message and within the voice takeoff clearance over the voice ATC.

FIG. 27 illustrates a flow diagram of the processes in a method within the AMS [320] for displaying ATC commands and allowing Pilot confirmation through the CPDLCDU [140]. 2702 displays the Message sent by the Command Message from process 3012 [FIG. 3]. A CPDLC tone notification will sound (3005) every few seconds (2704) to remind the flight crew they need to attend to the Message on the DAM [161] or CPDLCDU [140], whereby in 2705 the pilot presses one of the illuminated options buttons from the right of the DAM [161] or CPDLCDU [140] (1R,2R,3R,4R,5R,6R). Each of the buttons (1R,2R,3R,4R,5R,6R) refer to the corresponding displayed options on the right side of the DAM [161] or CPDLCDU [140], only illuminated buttons can be pressed, where illuminated buttons have corresponding option text and non-illuminated do not have corresponding option text. Once the flight crew press one of the illuminated buttons 2703, 2706 processes the corresponding illuminated button and outputs the associated code [FIG. 6]. 2707 returns the code from 2706 associated to the option pressed. For example, after a takeoff clearance Control Message was sent [FIG. 12], The DAM [161] or CPDLCDU [140] shows a screen for the takeoff clearance [FIG. 36]. The flight crew can press the button “1R” for confirming the aircraft is starting with the takeoff, or button “3R” to notify that they are unable to start the takeoff roll, or button “4R” to notify they are aborting the takeoff operation. The Pilot presses the button “1R” to confirm the aircraft is starting the takeoff roll.

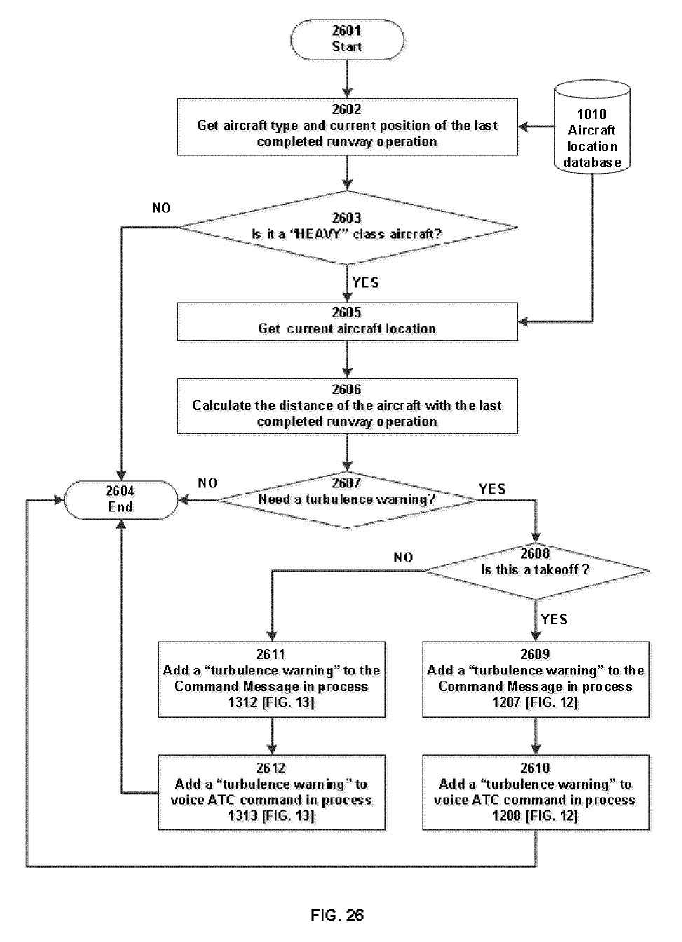

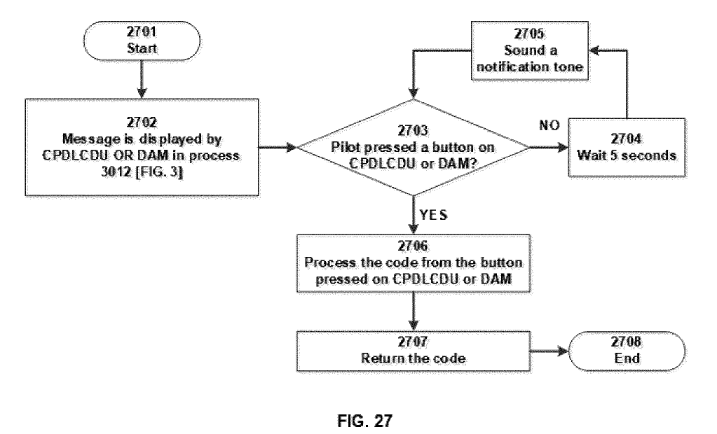

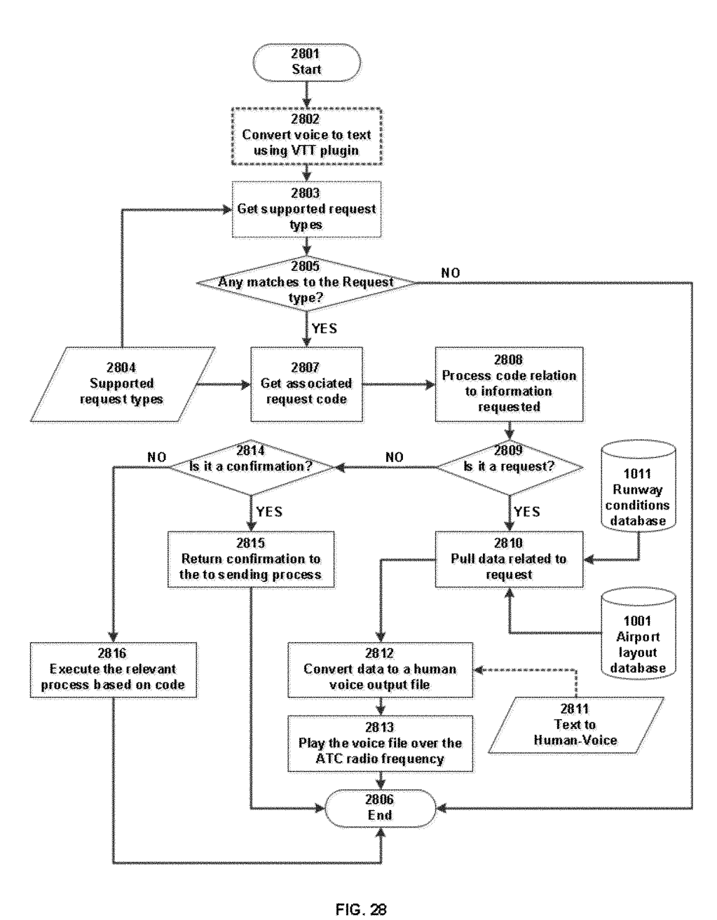

FIG. 28 illustrates a flow diagram of the processes in a method within the AMS [320] to automatically recognize and reply to Pilot requests over ATC voice frequency. 2802 sends the incoming voice to an external software package that outputs the equivalent text. 2803 looks within the data (2804) for known words that are within the text. 2805 matches the known commands, if there are no matches, the process is terminated 2806. Once there is a match between one of the words from the known words in 2804 with the incoming text, 2807 retrieves the request code associated with the matched word. 2808 processes the data associated to the code. If the code is a request in 2809, depending on the request type, 2810 retrieves the data from the appropriate database and outputs the data to 2812 converting the text to a voice. once 2812 converts the data to voice, 2813 will sound the voice over the ATC radio frequency. If the code is a confirmation for previous command 2814, 2815 returns the confirmation code to the original process that is waiting for the confirmation code. If the code is not a request and is not a confirmation, 2816 executes the process associated to the code. For example, if a Pilot presses the button “2R” in the lineup and wait on the DAM [161] or CPDLCDU [140] as shown in FIG. 35, the return code would trigger the takeoff clearance in process 1201 [FIG. 12]. Since recognition of Pilot communication of the voice ATC frequency is an external process (2802), the words associated to the commands are managed by modifying the supported request types in the data in 2804. The determining factor for adding words or phrases is the uniqueness of the sound where each word or phrase must be unique to ensure the proper functionality of the external process called by 2802.

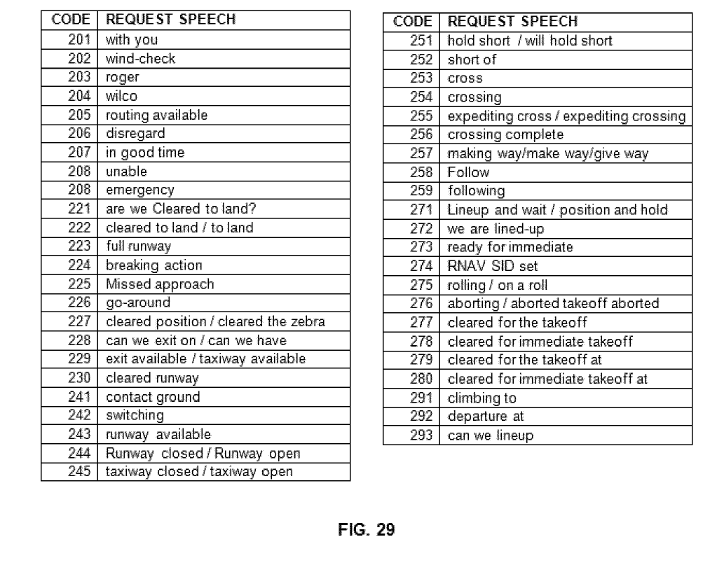

FIG. 29 lists an example of the recognized Pilot requests and responses over ATC voice frequency supported by the system. The list includes common terminology and phrases used in Pilot—ATC communication and can be modified to suite geographical areas and specific regulations. For example, in some geographical areas, “lineup and wait” is addressed as “position and hold”.

FIG. 30 illustrates the location of the exit flashing AFL (airfield lighting) [10] to notify a Pilot where to exit the runway. The exit flashing AFL (airfield lighting) [10] are located on both sides of every taxiway on every crossing. The exit flashing AFL (airfield lighting) [10] is a group of 5 lights, where the first light starts at the corner of the runway and the taxiway. The flashing sequencing is on for a few seconds and off for one second. The sequence is repeated until the aircraft has passed the junction or has exited the taxiway. The exit flashing AFL (airfield lighting) [10] are typically controlled by processes 1513 [FIG. 15] and 2109 [FIG. 21].

FIG. 31 illustrates the location of the flashing AFL (airfield lighting) [10] to notify Pilots of a closed runway. The closed runway flashing AFL (airfield lighting) [10] is a group of lights in a row, located before the start of the paved runway, the lights are spaced usually between 10 feet and 300 feet from one another and cover the complete width of the runway. The flashing sequencing is on for one second and off for a few seconds. The closed runway flashing AFL (airfield lighting) [10] are controlled by the Missed Approach and Go-Around process 1608 [FIG. 16].

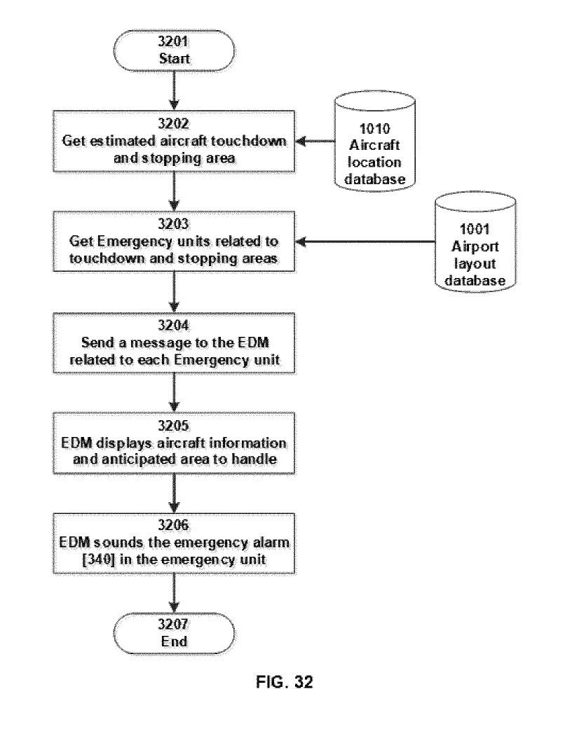

FIG. 32 illustrates a flow diagram of the processes in a method within the AMS [320] to dispatch emergency personnel when the landing gear of an aircraft is not locked prior to the landing. 3202 retrieves the estimated area the aircraft will touchdown and come to a complete stop from the Aircraft Positions Database [1010]. 3203 retrieves the emergency units relates to the areas from 3202. 3204 sends a notification to the EDM [331] to display the relevant aircraft information for emergency personnel 3205. In addition to the display of the information on the EDM [331] with a notification, 3206 sounds the Emergency Announcement System (EAS) [340] to the EDM [331]. Processes 3204 through 3206 are executed for each emergency unit covering the areas from 3203. For example, There are two fire stations responsible for a Runway, one from the touchdown area to the midfield, and the second from the midfield to the end of the runway. Since the landing aircraft has been identified by process 5601 [FIG. 56] to have a landing gear that is not locked, Both fire stations would be dispatched.

FIG. 33 lists the types of CPDLCDU [140] screens available to the Pilots and flight crews sent from the AMS [320]. Illustrations of CPDLCDU [140] screens include options for flight crew to select. Typically, the option buttons are on the right labeled: 1R; 2R; 3R; 4R; 5R and 6R. Also, in most illustrations the 6L button on the bottom left of the CPDLCDU [140] allows the flight crew to return to the previously displayed screen. The buttons 1R,2R,3R,4R,5R and 6R are used in process 2701 [FIG. 27] to decode the pressed button to the associated option code for processing in the AMS [320]. It is important to stress, that DAM [161] provide the same functionality of all listed CPDLCU [140] screens, codes and control messages.

FIG. 34a illustrates an example output of the onboard CPDLCDU [140] associated to a “hold short” ATC directive on a runway prior to a takeoff clearance to a specific aircraft generated in FIG. 57. After a hold short directive is issued by ATC, the left side contains the following information: location of where to hold short; assigned departure heading or RNAV SID; current wind direction and speed; frequency and altitude for contacting departure after airborne. The flight crew can press “1R” to acknowledge the hold short as a read-back confirmation, or “2R” to inform the system that the aircraft is holding short at the designated location [1L].

FIG. 34b illustrates an example output of the onboard DAM [161] with additional information that is unavailable on CPDLCU [140], and, providing highest safety through pilot situational awareness of locations refreshed surrounding traffic and additional functionality that are relevant to the operation, and alike, during the same aircraft operation as described in FIG. 34a.

FIG. 35a illustrates an example output of the onboard CPDLCDU [140] associated to a “lineup and wait” ATC directive on a runway prior to a takeoff clearance to a specific aircraft as generated in FIG. 11. After a lineup and wait directive is issued by ATC, the left side contains the following information: current wind direction and speed; assigned departure heading or RNAV SID; departure frequency and contact altitude; relevant turbulence information from the last runway operation prior to the takeoff. The flight crew can press the following buttons: “1R” to accept the line-up and wait directive as a read-back confirmation; “2R” to inform the system as being ready for the takeoff roll; “3R” to inform the system of not being ready to line up.

FIG. 35b illustrates an example output of the onboard DAM [161] with additional information that is unavailable on CPDLCU [140], and, providing highest safety through pilot situational awareness of locations refreshed surrounding traffic and additional functionality that are relevant to the operation, and alike, during the same aircraft operation as described in FIG. 35a.

FIG. 36a illustrates an example output of the onboard CPDLCDU during the takeoff clearance of an aircraft as generated in FIG. 12. After a takeoff clearance is issued by ATC, the left side contains the following information: current wind direction and speed; relevant turbulence information from the last runway operation prior to the takeoff; assigned departure heading or RNAV SID; the takeoff location on the runway; departure frequency and contact altitude. The flight crew can press the following buttons: “1R” to accept the takeoff clearance as a read-back and inform the system of starting the takeoff roll; “3R” to inform the system of not being ready to start the takeoff roll; 4R to inform the system of aborting the takeoff.

FIG. 36b illustrates an example output of the onboard DAM [161] with additional information that is unavailable on CPDLCU [140], and, providing highest safety through pilot situational awareness of locations refreshed surrounding traffic and additional functionality that are relevant to the operation, and alike, during the same aircraft operation as described in FIG. 36a.

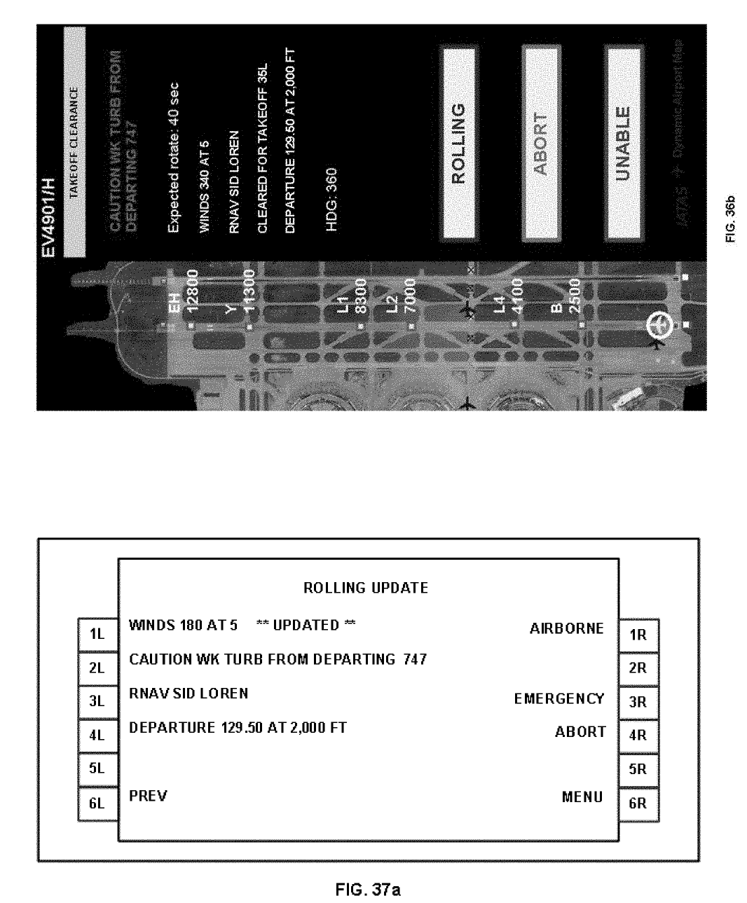

FIG. 37a illustrates an example output of the onboard CPDLCDU [140] after the aircraft starts the takeoff roll as generated in FIG. 14. Once the aircraft starts the takeoff roll the Left side contains the following information: updated current wind direction and speed; relevant turbulence information; assigned departure heading or RNAV SID; the takeoff location on the runway; departure frequency and contact altitude. The flight crew can press the following buttons: “1R” to inform the system when airborne; “3R” to inform the system of an emergency; 4R to inform the system of aborting the takeoff.

FIG. 37b illustrates an example output of the onboard DAM [161] with additional information that is unavailable on CPDLCU [140], and, providing highest safety through pilot situational awareness of locations refreshed surrounding traffic and additional functionality that are relevant to the operation, and alike, during the same aircraft operation as described in FIG. 37a.

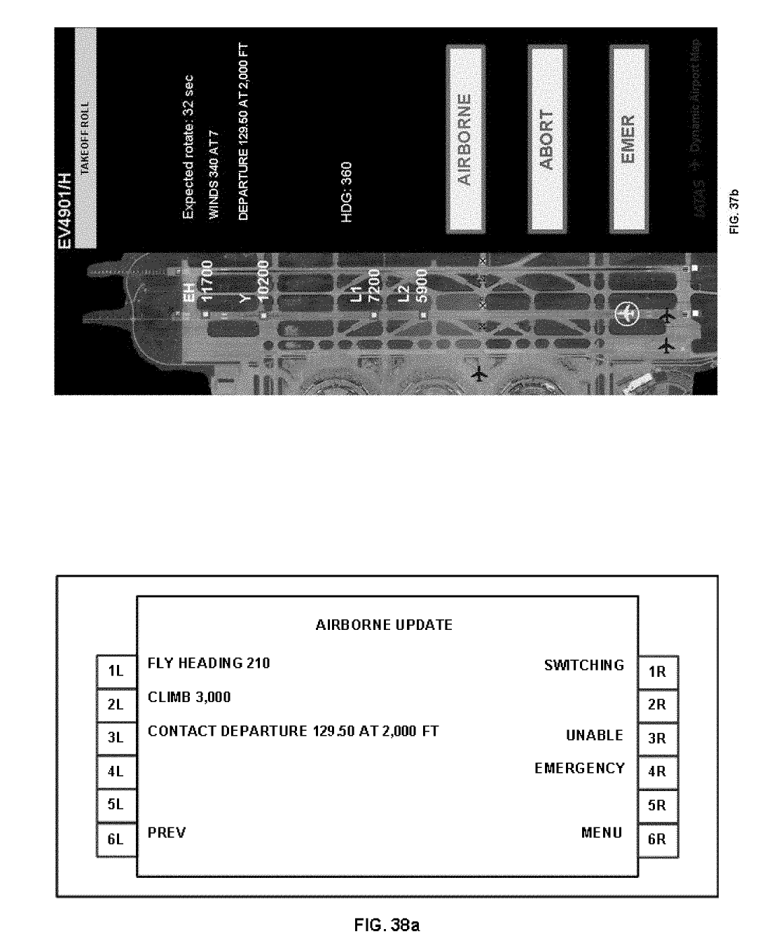

FIG. 38a illustrates an example output of the onboard CPDLCDU [140] after the aircraft is airborne, Once the aircraft is airborne, the left side contains the following information: updated current wind direction and speed; relevant turbulence information; assigned departure heading or RNAV SID; the initial climb altitude; departure frequency and contact altitude. The flight crew can press the following buttons: “1R” to inform the system of switching to departure frequency; “3R” to inform the system of not being ready to start the takeoff roll; 4R to inform the system of an emergency.

FIG. 38b illustrates an example output of the onboard DAM [161] with additional information that is unavailable on CPDLCU [140], to provide highest possible situational awareness of locations for emergency exits, updated surrounding traffic and additional functionality that are relevant to the operation, and alike, during the same aircraft operation as described in FIG. 38a.

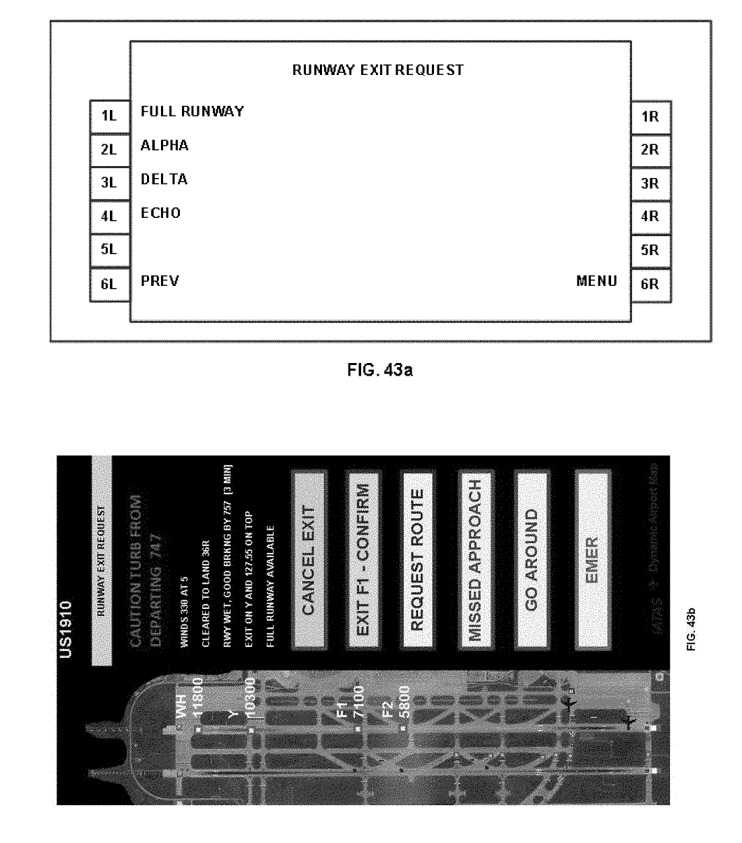

FIG. 39a illustrates an example output of the onboard CPDLCDU device that shows a generated ATC command and associated information for a landing clearance to a specific aircraft generated in FIG. 13. Once an aircraft is issued a landing clearance, the left side contains the following information: updated current wind. direction and speed; relevant turbulence information; runway clearance; runway conditions and latest breaking action reported by same or similar aircraft type; assigned exit and ground frequency to contact after exiting the runway. The flight crew can press the following buttons: “1R” to confirm the landing clearance as a read-back; “2R” request a different runway exit or full runway [FIG. 43]; “3R” select a routing [FIG. 44]; “4R” inform the system of a missed approach; “5R” inform the system of a go-around.

FIG. 39b illustrates an example output of the onboard DAM [161] with additional information that is unavailable on the CPDLCU [140], to provide additional functionality and highest possible situational awareness during the same aircraft operation as described in FIG. 39a.

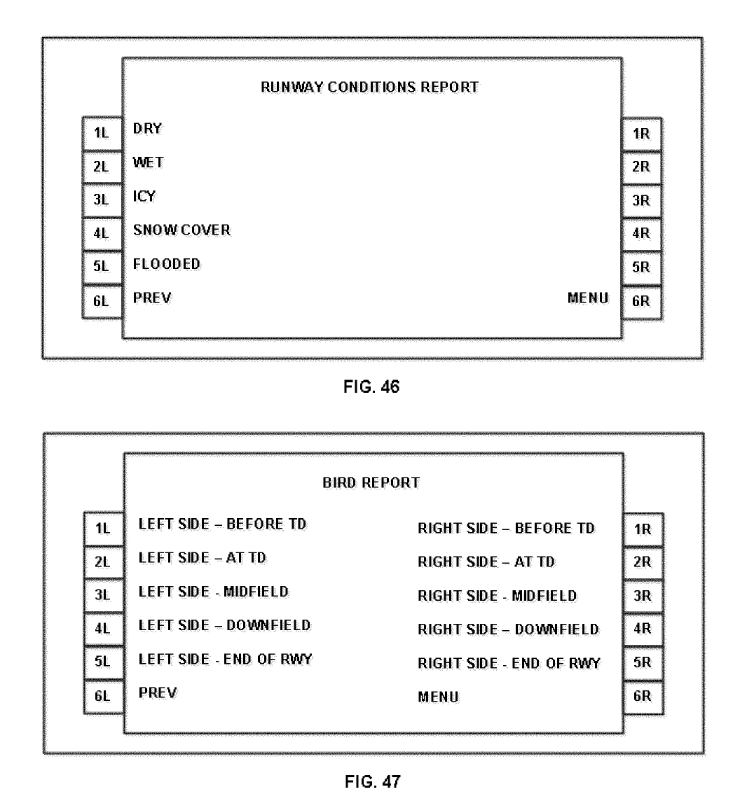

FIG. 40a illustrates an example output of the onboard CPDLCDU [140] device that shows the update sent to the CPDLCDU [140] for a breaking operation of a landing aircraft generated in FIG. 15. The left side contains the following information: assigned exit; ground frequency to contact once cleared the runway. The flight crew can press the following buttons: “1R” to inform the system of clearing the runway; “2R” request a different runway exit or full runway [FIG. 43]; “3R” request routing [FIG. 44]; “4R” report breaking action [FIG. 45]; “5R” report runway conditions [FIG. 46].

FIG. 40b illustrates an example output of the onboard DAM [161] with additional information that is unavailable on the CPDLCU [140], to provide additional functionality and highest possible situational awareness during the same aircraft operation as described in FIG. 40a.

FIG. 41a illustrates an example output of the onboard CPDLCDU [140] device that shows the information displayed during a generated in FIG. 16. The left side contains the following information: published missed approach type; climb altitude and heading if different from runway heading; direct to a NAVAID name or any published pattern for the missed approach; frequency to contact. The flight crew can press the following buttons: “1R” to inform the system of switching to another frequency; “3R” to inform the system of being unable to execute the missed approach; “4R” to declare an emergency and land.

FIG. 41b illustrates an example output of the onboard DAM [161] with additional information that is unavailable on the CPDLCU [140], to provide additional functionality and highest possible situational awareness during the same aircraft operation as described in FIG. 41a.

FIG. 42a illustrates an example output of the onboard CPDLCDU [140] device that shows the information displayed for a Go-Around operation generated in FIG. 16. The left side contains the following information: go-around type; climb altitude; heading if different from runway heading; frequency to contact. The flight crew can press the following buttons: “1R” to inform the system of switching to another frequency; “3R” to inform the system of being unable to execute the missed approach; “4R” to declare an emergency and land.

FIG. 42b illustrates an example output of the onboard DAM [161] with additional information that is unavailable on the CPDLCU [140], to provide additional functionality and highest possible situational awareness during the same aircraft operation as described in FIG. 42a.

FIG. 43a illustrates an example output of the onboard CPDLCDU [140] device that allows flight crew to request a runway exit from a list of exits generated by FIG. 50. The left side contains the available exits. The flight crew can select any of the buttons corresponding to the exit. “1R” for A full runway, “2R” for ALPHA exit, “3R” for DELTA exit, “4R” for ECHO exit. The right side of the CPDLCDU [140] is when more than 5 exits are available.

FIG. 43b illustrates an example output of the onboard DAM [161] with additional information that is unavailable on CPDLCU [140], and, providing highest safety through pilot situational awareness of locations refreshed surrounding traffic and additional functionality that are relevant to the operation, and alike, during the same aircraft operation as described in FIG. 43a.

FIG. 44 illustrates an example output of the onboard CPDLCDU [140] device that allows flight crew to select a routing from a list of routes generated by FIG. 24. The left side contains up to 5 routes. Each route includes the estimated time for the complete route as well as the congestion level (low, med, high), route path with taxiways, junctions and runway crossings. The flight crew can select any of the buttons from the left that have corresponding routes. In this example, 1L, 2L and 3L can be pressed as they have corresponding routes. Buttons 4L and 5L do not have corresponding routes and are not usable.

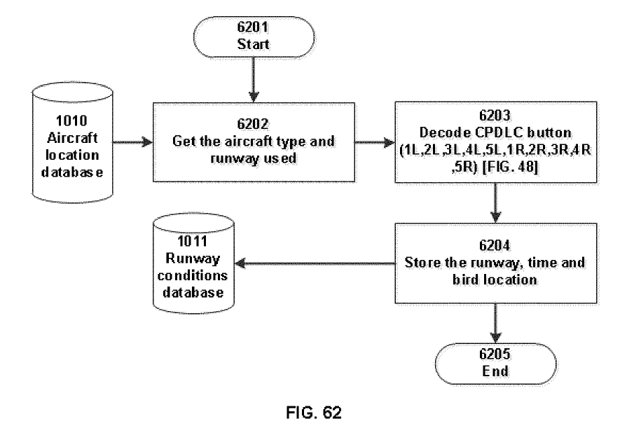

FIG. 45 illustrates an example output of the onboard CPDLCDU [140] device that allows the flight crew to report a runway breaking action, handled by FIG. 59. The left side allows flight crew to press one of buttons that correspond to one of the following breaking action types: “1L” very good; “2L” good; “3L” average or fair; “4L” bad; “5L” very bad or NIL.

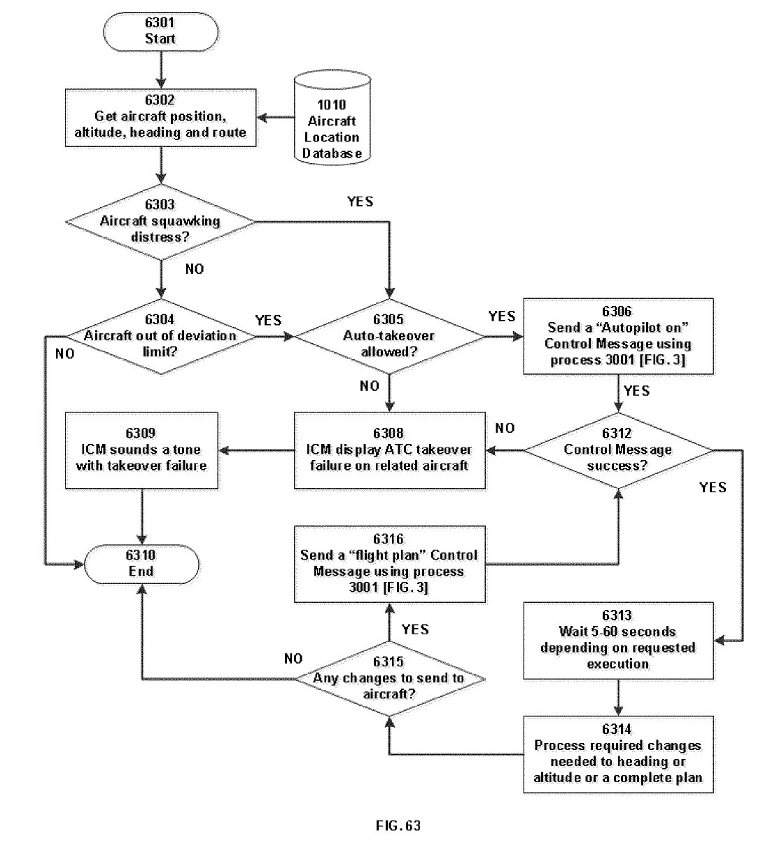

FIG. 46 illustrates an example output of the onboard CPDLCDU [140] device that allows the flight crew to report runway conditions, handled by FIG. 60. The left side allows flight crew to press one of buttons that correspond to one of the following runway conditions: “1L” dry; “2L” wet or water; “3L” icy; “4L” snow cover; “5L” flooded. Some regions have additional runway condition types that can be added on the display, such as oily, slush, sand and mud.

FIG. 47 illustrates an example output of the onboard CPDLCDU [140] device that allows the flight crew to report bird activity handled by FIG. 61. All buttons numbered 1 through 5 are used on both sides of the CPDLCDU. Flight crew can select from any of the corresponding locations from one of the following buttons: 1L; 2L; 3L; 4L; 5L; 1R; 2R; 3R; 4R; and 5R. each of the buttons refer to a location in reference to the runway.

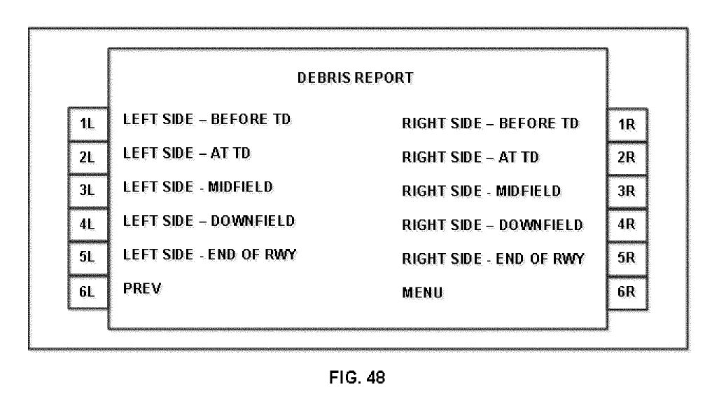

FIG. 48 illustrates an example output of the onboard CPDLCDU [140] device that allows the flight crew to report debris on runway handled by FIG. 62. All buttons numbered 1 through 5 are used on both sides of the CPDLCDU. Flight crew can select from any of the corresponding locations from one of the following buttons: 1L; 2L; 3L; 4L; 5L; 1R; 2R; 3R; 4R; and 5R. each of the buttons refer to a location in reference to the runway.

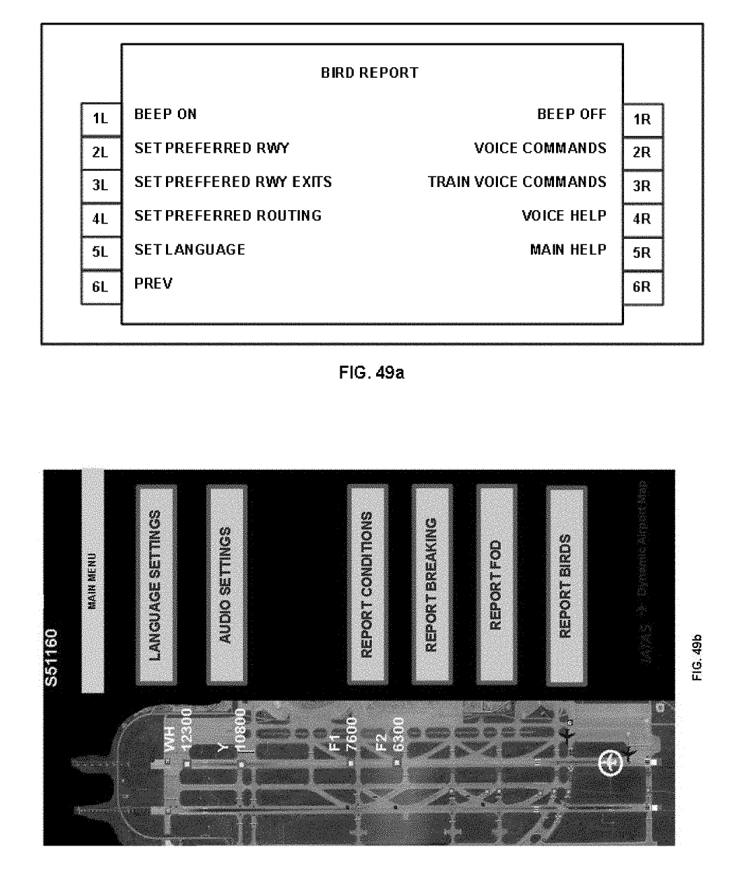

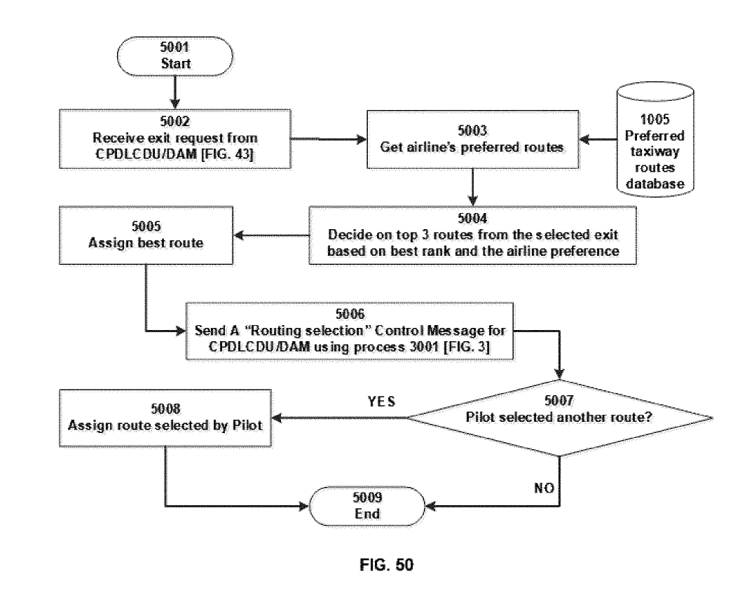

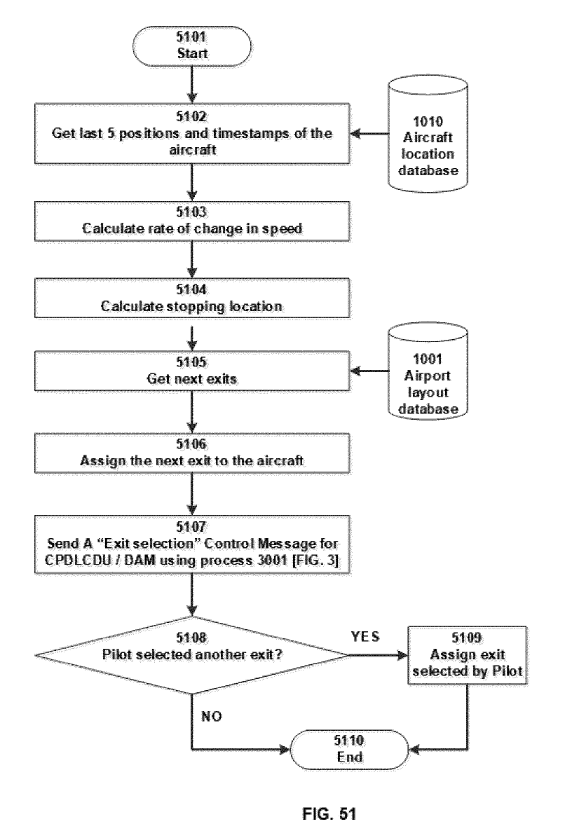

FIG. 49a illustrates an example of the onboard CPDLCDU [140] menu. The Menu provides common options to set common preferences.

FIG. 49b illustrates a partial example of the onboard DAM [161] main menu options. The Menu provides common options to set common preferences, as well as reporting as discussed in FIGS. 45 through 48.

FIG. 50 illustrates a flow diagram of the processes in a method within the AMS [320] involved with a Pilot runway exit request. 5002 receives the requested exit from the CPDLCDU [140] as shown in FIG. 43. 5003 retrieves the preferred routes for each of the airline from the Preferred Taxiway Routes Database [1005]. 5004 processes the best 3 routes from the airline routes, 5005 assigns the best route of the 3 to the aircraft. 5006 sends the Pilot a routing selection Control Message through process 3001 [FIG. 3] and the Pilot can accept the route or select another route [FIG. 44]. If a Pilot selects a different route 5007 through the CPDLCDU [140] as shown in FIG. 44, selected route is assigned 5008.

FIG. 51 illustrates a flow diagram of the processes in a method within the AMS [320] involved with calculating breaking speeds and runway exits while an aircraft is landing or aborting a takeoff. 5102 gets the last 5 positions reported and stored in the Aircraft Locations Database [1010]. 5103 calculates the rate of change between the last 5 locations based on the timestamp of each location data. 5104 calculates the stopping location where the aircraft can safely exit the runway. 5105 extracts the next few exits beyond the stop location and 5106 assigns the first exit to the aircraft. 5107 sends the Pilot an exit selection Control Message through process 3001 [FIG. 3] and the Pilot can accept the route or select a different exit from one of the other exits extracted in 5105. If a Pilot selects a different route through the CPDLCDU [140] as shown in FIG. 44 in 5108, 5109 will assign the exit selected by the Pilot.

FIG. 43b illustrates an example screen of the onboard DAM [161] with easier interface for the user for providing additional functionality as described in FIG. 43a.

FIG. 44 illustrates an example output of the onboard CPDLCDU [140] device that allows flight crew to select a routing from a list of routes generated by FIG. 24. The left side contains up to 5 routes. Each route includes the estimated time for the complete route as well as the congestion level (low, med, high), route path with taxiways, junctions and runway crossings. The flight crew can select any of the buttons from the left that have corresponding 30 routes. In this example, 1L, 2L and 3L can be pressed as they have corresponding routes. Buttons 4L and 5L do not have corresponding routes and are not usable.

FIG. 45 illustrates an example output of the onboard CPDLCDU [140] device that allows the flight crew to report a runway breaking action, handled by FIG. 59. The left side allows flight crew to press one of buttons that correspond to one of the following breaking 35 action types: “1L” very good; “2L” good; “3L” average or fair; “4L” bad; “5L” very bad or NIL.

FIG. 46 illustrates an example output of the onboard CPDLCDU [140] device that allows the flight crew to report runway conditions, handled by FIG. 60. The left side allows flight crew to press one of buttons that correspond to one of the following runway conditions: 40 “1L” dry; “2L” wet or water; “3L” icy; “4L” snow cover; “5L” flooded. Some regions have additional runway condition types that can be added on the display, such as oily, slush, sand and mud.

FIG. 47 illustrates an example output of the onboard CPDLCDU [140] device that allows the flight crew to report bird activity handled by FIG. 61. All buttons numbered 1 45 through 5 are used on both sides of the CPDLCDU are used. Flight crew can select from any of the corresponding locations from one of the following buttons: 1L; 2L; 3L; 4L; 5L; 1R; 2R; 3R; 4R; and 5R. each of the buttons refer to a location in reference to the runway.

FIG. 48 illustrates an example output of the onboard CPDLCDU [140] device that allows the flight crew to report debris on runway handled by FIG. 62. All buttons numbered 1 through 5 are used on both sides of the CPDLCDU are used. Flight crew can select from any 5 of the corresponding locations from one of the following buttons: 1L; 2L; 3L; 4L; 5L; 1R; 2R; 3R; 4R; and 5R. each of the buttons refer to a location in reference to the runway.

FIG. 49a illustrates an example of the onboard CPDLCDU [140] menu. The Menu provides common options to set common preferences.

FIG. 49b illustrates an example output of the onboard DAM [161] that allows the flight crew to report debris on runway, in accordance with an example embodiment.

FIG. 50 illustrates a flow diagram of the processes in a method within the AMS [320] 10 involved with a Pilot runway exit request. 5002 receives the requested exit from the CPDLCDU [140] as shown in FIG. 43. 5003 retrieves the preferred routes for each of the airline from the Preferred Taxiway Routes Database [1005]. 5004 processes the best 3 routes from the airline routes, 5005 assigns the best route of the 3 to the aircraft. 5006 sends the Pilot a routing selection Control Message through process 3001 [FIG. 3] and the Pilot can 15 accept the route of select another route [FIG. 44]. If a Pilot selects a different route 5007 through the CPDLCDU [140] as shown in FIG. 44, selected route is assigned 5008.

FIG. 51 illustrates a flow diagram of the processes in a method within the AMS [320] involved with calculating breaking speeds and runway exits while an aircraft is landing or aborting a takeoff. 5102 gets the last 5 positions reported and stored in the Aircraft Locations 20 Database [1010]. 5103 calculates the rate of change between the last 5 locations based on the timestamp of each location data. 5104 calculates the stopping location where the aircraft can safely exit the runway. 5105 extracts the next few exits beyond the stop location and 5106 assigns the first exit to the aircraft. 5107 sends the Pilot an exit selection Control Message through process 3001 [FIG. 3] and the Pilot can accept the route or select a different exit from 25 one of the other exits extracted in 5105. If a Pilot selects a different route through the CPDLCDU [140] as shown in FIG. 44 in 5108, 5109 will assign the exit selected by the Pilot.

FIG. 52 illustrates a flow diagram of the processes in a method within the AMS [320] involved with calculating aircraft progress on a taxiway. 5202 retrieves the assigned route for the aircraft from either the Airport Departures database [1002] or the Airport Arrivals database [1003]. 5203 retrieves the current aircraft position. 5204 retrieves from 2308 the future anticipated positions for the aircraft until it completes the taxiing as used in FIG. 23. 5204 retrieves the last minute of data available for the aircraft future position. 5205 creates a timespan starting from the time the aircraft started the taxi operation and the anticipated remaining time in minutes until the taxi operation will be complete. The formula for the timespan is: timespan=minutes since start of operation+minutes till end of operation. 5206 calculates the position within the timespan in the form of a percentage (minutes elapsed from start divided by the total minutes for the taxi operation). For example, an aircraft exited a runway 5 minutes ago, and still has 15 minutes until it reaches the Gate. The timespan is 20 minutes of total time in taxi operation (5+15). Since 5 minutes have passed since the operation started, the result of the process is 25% (5/20). 5207 Uses all previous data from 5204 through 5206 to derive a picture with the locations of all aircrafts or airside object operations.

FIG. 53 illustrates a flow diagram of the processes in a method within the AMS [320] involved with a Request Release operation from Departure ATC. 5302 receives the ATC responsible for giving the release. 5303 receives the aircraft position, and 5304 checks if the aircraft is anticipated to start the takeoff roll within two minutes. As long as the aircraft has more than two minutes until the takeoff roll, the condition is rechecked every few seconds 5305. Once the aircraft is anticipated to start the takeoff operation within the next two minutes, AMS [320] sends ICM [330] a release request message 5306, to display to the ATC for acceptance 5307 and sound a tone associated with a releaser request 1708. Once the ATC accepts the aircraft release request from the ICM [330] in 5309 over the ICM [330], the ICM [330] sends AMS [320] a message of release acceptance 5311, and sounds a tone to the ATC over the ICM [330] associated with a handoff acceptance 5313. Until ATC accepts the release in 5309, 5310 waits and redisplays the release request 5307 and sounds the release request tone in 5308 every few seconds.

FIG. 54 illustrates a flow diagram of the processes in a method within the AMS [320] involved with determining if an aircraft cleared a junction. The method uses position reports from the APRS [353] located at the corners of the junction. 5402 retrieves the aircraft current location from the Aircraft Locations Database [1010]. 5403 retrieves all the APRS [353] at the junction in the area of the aircraft. 5404 retrieves from the Aircraft Locations Database [1010] any last reported positions from any of the APRS [353] in 5403. 5405 sorts all retrieved reported aircraft positions reported by the junction APRS [353] from 5403 in descending order, the result of the sort ensures the latest reports are first and the older reports are last. 5406 extract the first two APRS [353] that are different within the sorted list of positions as sorted by 5405. 5407 compares the two APRS [353] from 5406 and checks if they are within the same junction. If the output from 5407 is true the junctions APRS [353] and the aircraft cleared the Junction 5408 and the process is terminated. As long as the output from 5407 is false, the aircraft did not clear the junction yet 5410 and the method will wait a few seconds 5411 and re-execute from 5402 until 5407 is true.

FIG. 55 illustrates a flow diagram of the processes in a method within the AMS [320] involved with calculating junction congestions and hotspots levels. Method compares expected congestions from FIG. 23 with normal congestion levels. 5502 retrieves the latest data from 2313 FIG. 23 with anticipated congestion levels and hotspots for all junctions. 5503 retrieves the normal congestion levels for each of the junctions from the Airport layout database [1001]. 5504 compares each of the current and anticipated junction congestion levels from 5502 with the normal congestion levels from 5503. 5505 discards all current and future congestions that are lower than the normal congestions by at least twenty percent, ensuring any congestions close to the normal congestion levels by twenty percent or higher are handled by the system. 5506 sorts the current and future congestion levels. 5507 stores the results for future reference in 5508.

FIG. 56 illustrates a flow diagram of the processes in a method within the AMS [320] involved in LGRC [355] image processing for confirming locked gear of a landing aircraft. The method receives and compares images from the LGRC [355] to confirm the front landing gear is locked. The LGRC is positioned at an angle to capture as many images as possible for the verification. 5602 retrieves aircraft position from the Aircraft Locations Database [1010] and 5603 checks if the location is close to the area of the LGRC [355]. As long as the aircraft is not positioned within the lense of the LGRC [355] 5603, the method waits 100 milliseconds 5604 and retrieves again the aircraft position in 5602. Once the aircraft is known to be within the LGRC [355] lense in 5603, 5605 imports the next available image from the LGRC [355] and 5606 processes the image to focus on the front nose of the aircraft including the landing gear. 5607 rotates the image of the image to compensate for the angle of the lense in relation to the bottom of the aircraft. 5608 resizes the image to a unified width and height as all other images for comparison. 5610 compares the incoming image with the last image within the images stored in 5609. If the comparison in 5610 output is true the image is the same as the previously stored image in 5608 and process 5612 is executed until the aircraft has passed the LGRC lense. If the comparison in 5610 output is false the image is not the same as the previously stored image in 5608 and 5611 stores the image in 5608 for future comparison. 5611 stores the data for future comparisons. 5612 calculates if the aircraft has passed the range of the lense. Once the aircraft has passed the lense in 5612, 5613 compares all the images stored within 5609. after the correction in 5607, When gear is locked, 5609 should only have a single image or all images are within acceptable deviation for an error factor, if the gear is not locked, the difference in deviation between the images is high. 5613 calculates the total deviation of error factors between all the images and 5614 decides if the gear is locked based on the error factor output from 5613. As long 5614 output is true, the gear is locked and the method is complete. 5615 sends a Control Message using process 3001 [FIG. 3] to alert the pilot, and 5616 dispatches emergency personnel using process 3201 [FIG. 32]. In addition, the ICM [330] notifies ATC with a landing gear warning and 5618 sounds the notification tone associated with the landing gear warning.

FIG. 57 illustrates a flow diagram of the processes in a method within the AMS [320] involved in issuing a “hold short” ATC command to an aircraft. A “hold short” directive is given near junctions while an aircraft is taxiing. 5702 retrieves the current location of the aircraft from the Aircraft Locations Database [1010]. 5403 retrieves the closest junctions APRS [353] within the routing path of the aircraft from the Airport Layout database [1001]. If there are no close junction APRS [353] in 5704, the aircraft is not close to a junction and 5705 waits for a few seconds and retries 5702. Once the aircraft is near at least one junction APRS [353] in 5704, 5706 retrieves all other aircrafts close to the junction from the Aircraft Locations Database [1010]. If the junction involves a runway 5707, the aircraft must hold short of the runway junction at all times and 5708 sends a “Hold Short” Control Message through process 3001 [FIG. 3] for the flight crew through the CPDLCDU [140] and 5709 generates “Hold Short” over the radio frequency for the flight crew. If the junction does not cross a runway 5707, 5710 further checks for other possible aircraft near the junction. If the output of 5710 is false, the aircraft can cross the runway, 5714 sends a “Hold Short” Control Message through process 3001 [FIG. 3] for the flight crew through the CPDLCDU [140] and 5715 generates “Hold Short” over the radio frequency for the flight crew. If other aircrafts are near the junction in 5710, 5711 further checks if the aircraft has a priority, if it does not have priority the aircraft must hold short of the junction at all times and 5708 sends a “Hold Short” Control Message through process 3001 [FIG. 3] for the flight crew through the CPDLCDU [140] and 5709 generates “Hold Short” over the radio frequency for the flight crew. If the aircraft does have priority over other aircrafts for crossing the junction in 5711, the aircraft can cross the runway and 5712 sends a “cross runway” Control Message through process 3001 [FIG. 3] with the additional information that traffic will make way, and 5713 generates “cross runway” over the radio frequency with the additional information that traffic will make way. 5714 sends a “cross taxiway” Control Message through process 3001 [FIG. 3] with the additional information that traffic will make way, and 5715 generates “cross taxiway” over the radio frequency with the additional information that traffic will make way. The method is always executing for every aircraft as long as the aircraft has not completed its taxiing [FIG. 52].

FIG. 58 illustrates a flow diagram of the processes in a method within the AMS [320] involved with runway capacity balancing and takeoff to landing ratios. Aside from calculating the takeoff to landing ratios for each runway, the method reroutes future takeoffs to other runways or opens an additional runway if the runway is expected to be over capacity. 5802 retrieves all the available runways from the Airport Layout Database [1001], 5803 filters only for the active runways. 5804 retrieves all departures that have not started taxiing yet from the Airport Departures Database [1001] for each runway, and 1003 retrieves all the expected landings from the Airport Arrivals Database [1003] for each runway. 5805 retrieves data for next 30 minutes of arrival data. Once the data is available, 5806 sorts all landings and takeoff data for each runway. 5807 calculates the number of takeoff and landing operations expected for each runway. 5808 calculates the takeoff to landing ratio for each runway. 5809 calculates the overall time for all expected operations versus the capacity of the runway, the output is a percentage of the expected operations in relation to the capacity (total operations time divided by capacity). 5810 checks for overcapacity from the output of 5809. If there is no overcapacity expected for a runway, 5811 checks if there are more runways to calculate. If there are, 5807 is executed again, if 5811 output is false, there are no more runways to check and the method is complete. If the capacity was exceeded in 5810, 5813 checks for available runways that are not at capacity and can handle more takeoffs. If they are 5814, 5815 diverts future takeoffs to that runway, as long as the diverted takeoffs have not left the gate yet for taxiing to the original runway. After 5815 reassigns future takeoffs, 5811 checks if there are more runways to calculate. If there are, 5807 is executed again, if 5811 output is false, there are no more runways to check and the method is complete. If there were no available runways to handle the overcapacity in 5815, 5816 checks if there are any available runways that can be opened. If there are, 5817 will open a new runway and use process 5815 to divert takeoffs as stated above in 5815. If there are no runways that can be opened, 5815 diverts future takeoffs as stated above, and ensures there is a balance in runway capacity at any given time when at least one runway is at overcapacity.

FIG. 59 illustrates a flow diagram of the processes in a method within the AMS [320] involved with Pilot report of breaking action. The method processes the data sent by a Pilot via the CPDLCDU [140] and stores it into the database for future use in runway operations. 5902 retrieves the aircraft type and runway used, 5903 decodes the button pressed on the CPDLCDU [140] for the associated data. 5904 stores in the Runway Conditions Database [1011] the following data: runway; time of report; aircraft type; reported breaking condition. The data is used for issuing breaking condition notification to other pilots during landing operations on the CPDLCDU [140], an example is the “GOOD BRKNG BY 757 [3 MIN]” in FIG. 39 telling the Pilot the last reported breaking action on the runway was good and was reported 3 minutes ago by a Boeing 757.

FIG. 60 illustrates a flow diagram of the processes in a method AMS [320] involved with Pilot report of runway conditions. The method processes the data sent by a Pilot via the CPDLCDU [140] and stores it into the database for future use in runway operations. 6002 retrieves the aircraft type and runway used, 6003 decodes the button pressed on the CPDLCDU [140] for the associated data. 6004 stores in the Runway Conditions Database [1011] the following data: runway; time of report; aircraft type; reported runway condition. The data is used for runway condition notification to other pilots during landing operations on the CPDLCDU [140], an example is the “WET RWY” in FIG. 39 telling the Pilot the runway condition is wet.

FIG. 61 illustrates a flow diagram of the processes in a method within the AMS [320] involved with Pilot report of birds. The method processes the data sent by a Pilot via the CPDLCDU [140] and stores it into the database for future use in runway operations. 6102 retrieves the aircraft type and runway used, 6103 decodes the button pressed on the CPDLCDU [140] for the associated data. 6104 stores in the Runway Conditions Database [1011] the following data: runway; time of report; aircraft type; reported location of birds. The data is used for issuing bird alerts to other pilots during takeoff and landing operations on the CPDLCDU [140].

FIG. 62 illustrates a flow diagram of the processes in a method within the AMS [320] involved with Pilot report of debris on a runway. The method processes the data sent by a Pilot via the CPDLCDU [140] and stores it into the database for future. 6202 retrieves the aircraft type and runway used, 6203 decodes the button pressed on the CPDLCDU [140] for the associated data. 6204 stores in the Runway Conditions Database [1011] the following data: runway; time of report; aircraft type; reported location of debris.

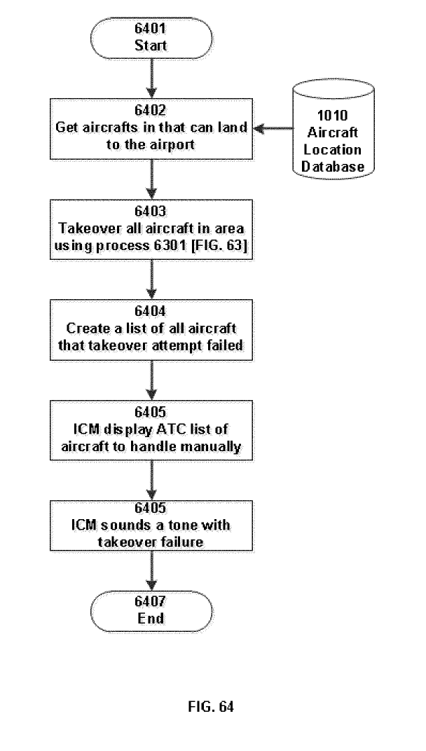

FIG. 63 illustrates a flow diagram of the processes in a method within the AMS [320] involved with taking over an aircraft and activating the autopilot. The method is executed automatically and is managed by ATC through the ICM [330]. 6302 retrieves the aircraft data from the Aircraft Location Database [1010] including: squawk code, location; altitude; speed; heading; and route if available. 6303 checks if the aircraft is squawking a distress code. If the squawk code is normal and the aircraft is not deviating from the route, the method is terminated. If the aircraft is deviating from its planned course or is squawking for distress. 6304 checks if the aircraft is deviating from its original route. 6305 checks if the automated takeover is allowed, the setting for automated takeover is managed by ATC through the ICM [330]. If the automated takeover is not allowed, 6308 a warning is displayed to the ATC through the ICM [330] in 6308 and a tone associated to a takeover failure will sound through the ICM [330] in 6309 to alert the ATC of failure in the aircraft takeover attempt. If the automated takeover is allowed in 6305, to avoid unauthorized use of the takeover a secondary facility authorizes the takeover process 6306, 6307 sends a “autopilot on” Control Message through process 3001 [FIG. 3] directly to the FANS [120]/FMS [130] to turn on the autopilot [150] and lock it in case of human tampering onboard the aircraft. 6312 receives a response code from the aircraft avionics, if the response is a false, the ATC will be notified as above of the failure in the takeover attempt. If the response in 6312 is true, the autopilot [150] is turned on, and can only be managed from the ground until the autopilot [150] is turned off. While the autopilot [150] is on, 6313 waits for execution of commands until new command is sent to the autopilot [150] to execute. 6314 processes the required changes in the flight path including: altitude; heading; speed; vector; route; or flight plan. If there are changes to be sent to the aircraft 6315, 6316 sends a “flight plan” Control Message using process 3001 [FIG. 3] telling the aircraft what to execute. The process of 6312 through 6315 continues until the aircraft landed or the autopilot [150] is turned off or until a continuous error occurs in sending the Control Messages in 6316.

FIG. 64 illustrates a flow diagram of the processes in a method within the AMS [320] involved with grounding all airborne aircrafts. The method is used in the event of terrorist attack similar to 9/11 where all airborne aircraft must be grounded as soon as possible. The system efficiently tries to takes over all aircraft close the airport and land them [FIG. 63]. Each airport grounds the aircrafts within its area. 6402 retrieves all airborne aircraft that can land at the airport. 6403 tries to turn on the autopilot [150] of each aircraft and send a flight plan to land at the airport using Process 6301 [FIG. 63]. 6404 receives all the error codes from the takeover attempt in 6403 and adds them to a list. 6405 displays the list of the aircraft that need to be contacted manually by ATC for landing them at the airport. 6405 sounds the takeover fail tone to notify the ATC of the list created in 6404. This method is intended to considerably lower the workload of ATC as nearly all commercial aircraft near major airports are automatically grounded by the system.

FIG. 65 lists all common terms and their associated codes used throughout this document.

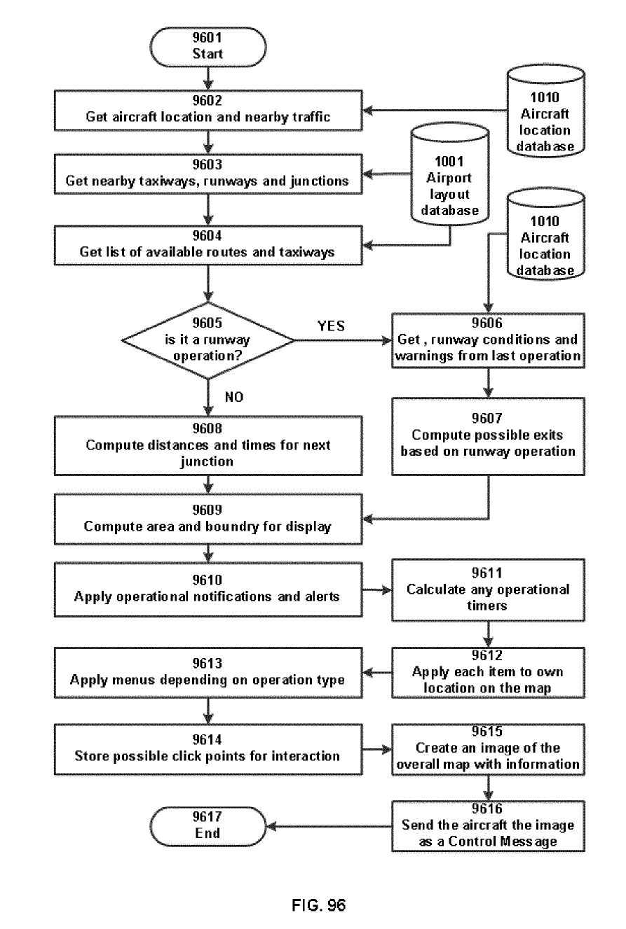

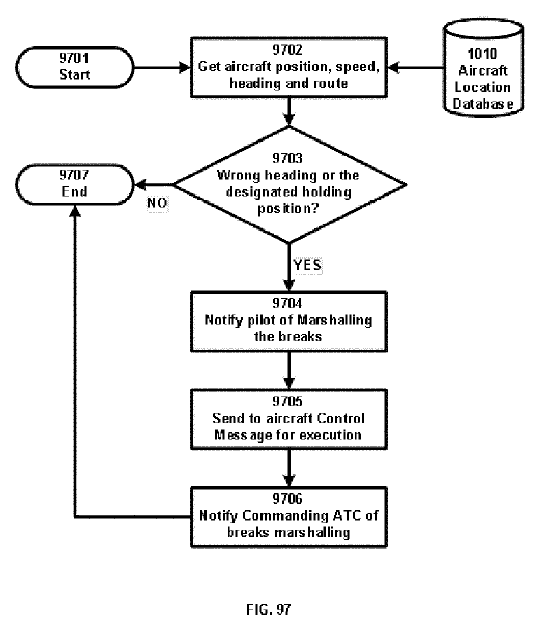

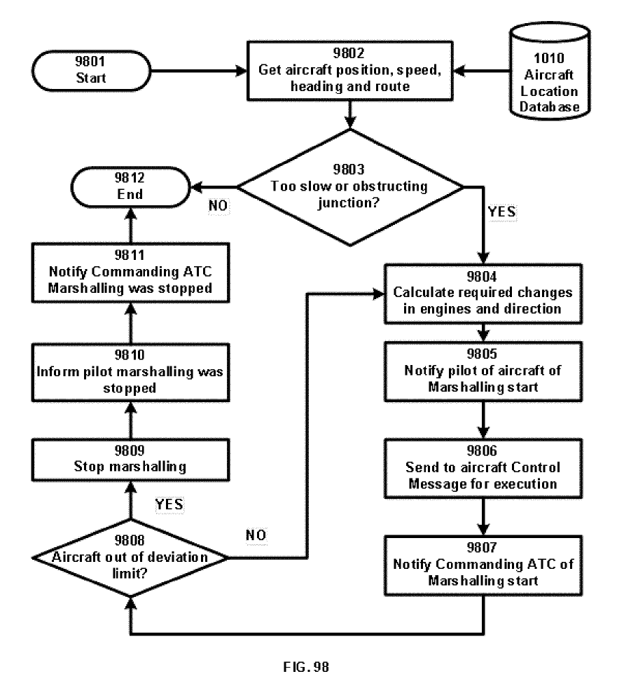

FIG. 96 illustrates a flow diagram of the processes in a method within the AMS [320] involved with filtering and merging data to produce a single dynamic map as an image, the image is processed and sent for display aboard DAM [141]. 9602 fetches all traffic in surrounding area or future on-route traffic that me affect airside object operations, 9603 fetches all physical data on available nearby and on-route to destination, taxiways, junctions, runways, restricted areas, that may be of use to the airside object in the future to reach final destination within aerodrome. 9604 fetches list of available data of all full taxi routes as well as progressive routing that may be of use, 9605 filters the data depending on area of operation and operation type. It is important to stress that the reason for not processing the data aboard the airside object is due to several factors such reliability since incorrect or incomplete data due to loss of communication and is not refreshed in real-time, and therefore, deemed unsafe and unusable. 9606 filters only for runway data, and 9607 adds possible exits for takeoff and landing operations. If the operation is not associated to a runway, 9708 computes distances and times to nearby or junctions assigned within a route, all data is filtered to only consider a set area in respect to airside object position and operation. 6309 checks id the airside object is within its operating boundary. 9610, applies all notifications affecting the area being displayed, such as constructions, birds, FOD and alike. 9611 calculates the anticipated time of the next command or operation to be given to the pilot, to increase situational awareness and capacity on each runway, junction and taxiway. In addition, the timer calculates optimal taxi speed to reduce variance in engine power consumption, and to time the speed in order to minimize the slowdown at junctions, possibly to the point of being able to continue a junction crossing without stopping or even slowing the airside object. 9612 applies all filtered collected data into an image overlay on an airport satellite image or airport diagram as preferred by the pilot. 9613 adds possible menus associated to current operation or as requested by the pilot, 9614 stores all possible points that may be clicked on the screen for referencing future interaction sent back to the system for processing. 9615 ultimately creates a final compressed and encrypted image to be decrypted by DAM [161], 9616, uses the AGC [610] as shown in FIG. 4, to send the data as a control message to the CCS [160] onboard the airside object. It is important to note that portions of this method are used by the methods associated to marshalling airside object breaks, steering and engine power as shown in FIG. 97 and FIG. 98, as well as other methods that require timing information for junctions and taxiway operations.

FIG. 97 illustrates a flow diagram of the processes in a method within the AMS [320] involved with marshalling breaks of an airside object if it is moving in the wrong direction or is not stopping at the proper location. 9702 gathers airside object position, speed and heading, while accounting for previous historical positioning and speed data, as well as instruction to be executed, 9703 decides if the airside object needs to be stopped. 9704 notify the pilot via a DAM [140] warning that the airside object breaks are being marshalled. 9805 sends DAM [140] a control message from the AMS [320] to pass to the breaking system aboard the airside object as a control message, to apply breaks until a full stop is achieved. 9706 also notifies the commanding ATC of the marshalling, and is alerted in the ICM [330] of the location and airside object, to enable the commanding ATC to further examine the nearby traffic and make additional overrides if needed.

FIG. 98 illustrates a flow diagram of the processes in a method within the AMS [320] involved with marshalling steering and engine power aboard an aircraft if it is moving in the wrong direction or needs to me moved, in cases such as not fully clearing a junction, or not expediting a command. The same process and command control as FIG. 97 are used, but the control message is sent to the onboard steering system and/or the engine power system. 9808 constantly checks if the required position goal is achieved, and repeats the process until the desired position and/or engine power is produced. The control is given back to the pilot after the marshalling was completed or, if better performance was produced by the pilot.

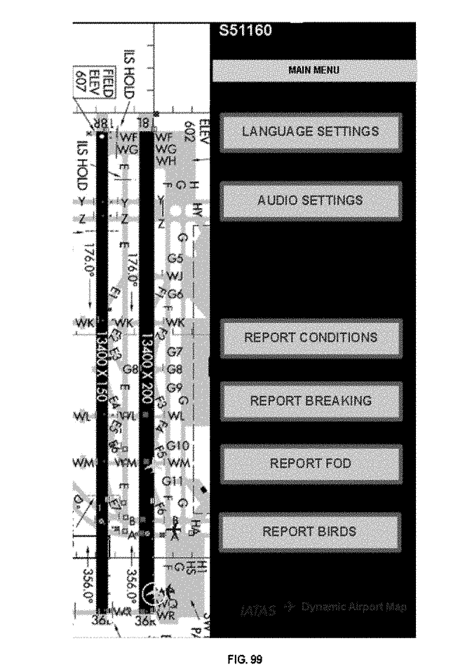

FIG. 99 illustrates a possible embodiment for displaying the Dynamic Map, where a pilot can select a map diagram instead of a satellite image.

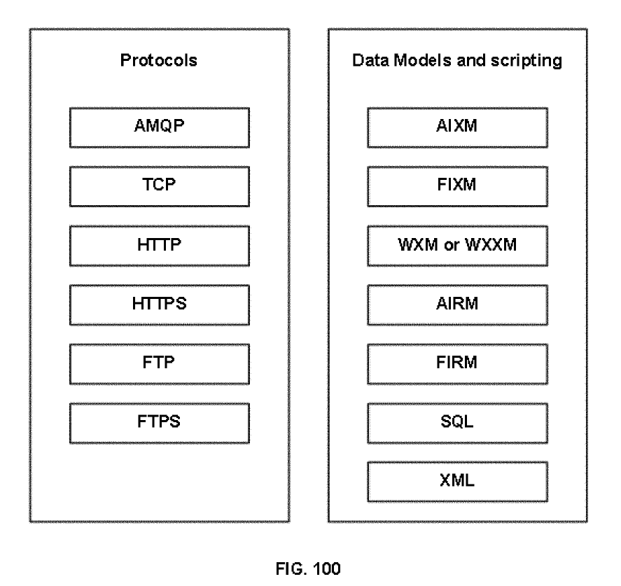

FIG. 100 illustrates an example of the numerous supported interface protocols, data models, scripting and framework standards.

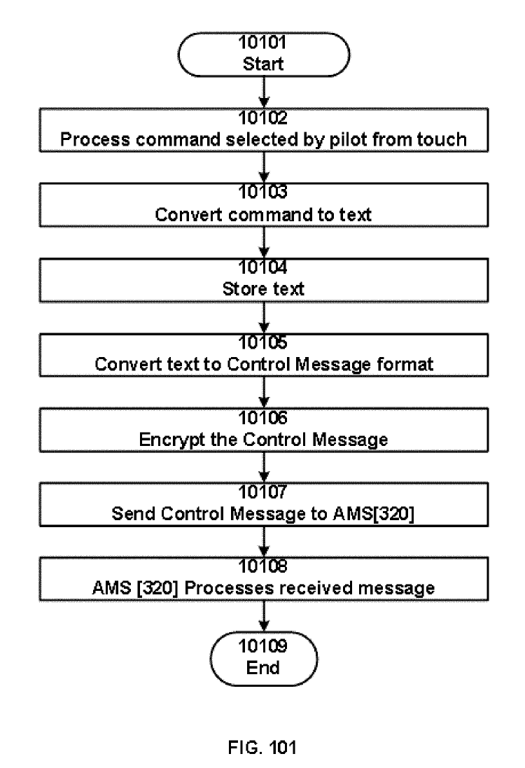

FIG. 101 illustrates an example of the process used to capture pilot interaction with DAM [161], and send the interaction as a control message to AMS [320] for processing. 10102 captures the position of the user interaction, and the number of clicks in the area of the initial click. 10103 converts the touch location and number of interactions as text. 10104 stores the message text. 10105 converts the text to a control message format, is encrypted by 10106 and sent by 10107 to the AMS [320] for decryption and further processing.

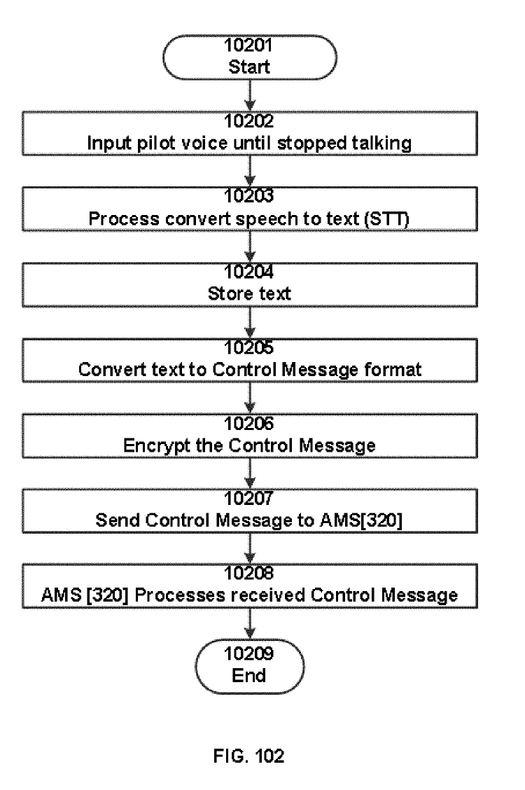

FIG. 102 illustrates an example of the process used to capture a pilot voice command or request and send it to the AMS [320] for processing, including the conversion of the input voice as text, and sending it as a control message as discussed in FIG. 101.

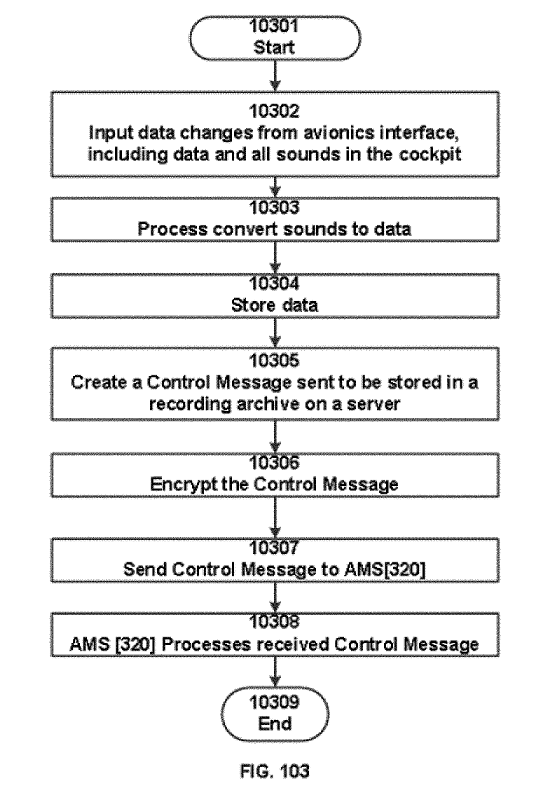

FIG. 103 illustrates an example of the process used to capture data from avionics, and cockpit conversations, to be stored on the ground, in case there is a need to replay the information in relation to other nearby sensors and aircrafts. Any data captured from avionics, or sound within the cockpit is sent as a control message to the AMS [320] and stored on the server [300] as required by governing bodies.

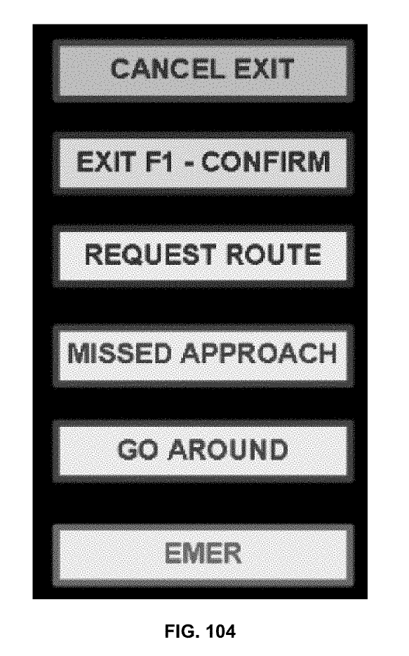

FIG. 104 illustrates an example of a pilot selection menu. The number of options and the option types change depending on the operation type. In addition, there may be some information displayed to the aircrew depending on the operation type. For example, the options available to an aircraft coming into a landing includes cancellation of previously selected exit after the landing, confirming an assigned/suggested exit, request a new route from the runway to the gate, notify of a “MISSED APPROACH” (M/A) or “GO AROUND” (G/A) in case the Pilot decides not to try and approach for a landing again, or declaring an emergency “EMER”. An additional example including the display of information to the aircrew as shown in FIG. 36b, the options include common events such as aborting the takeoff roll “ABORT”, initiation of the takeoff roll “ROLLING” or if the aircrew is unable to commit to initiate the takeoff roll “UNABLE”. The information displayed includes current wind conditions, wake/turbulence advisory/warnings, frequency for Departures ATC, heading and any GPS guided departure routes.

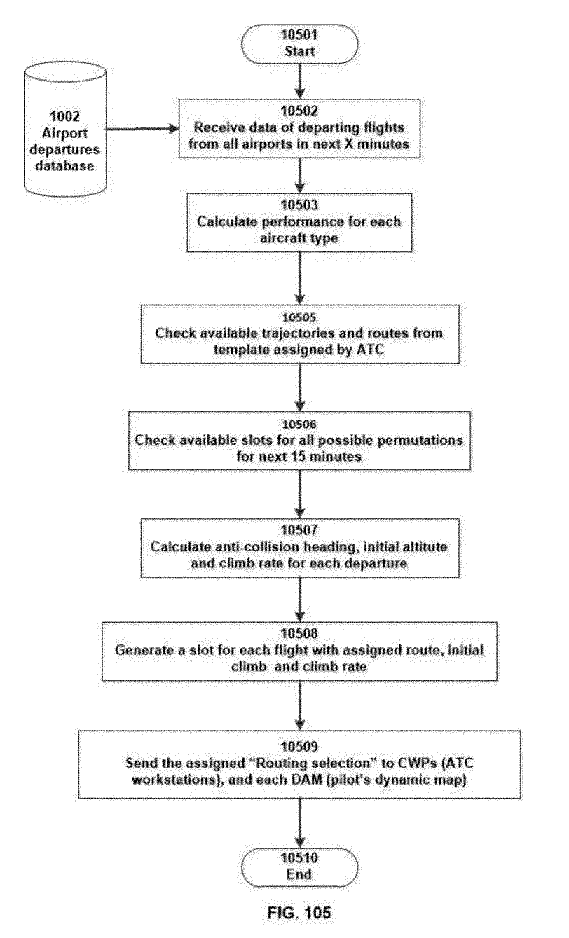

FIG. 105 illustrates an example of flow for automated departure control. The flow assigns departure time slots for each departing aircraft from multiple runways at multiple airports within a designated area based on an assigned template as selected by Departures ATC. 10502 receives all flights and associated data from all known flights at all airports handled by the Departure ATC position. 10503 calculates the performance of each aircraft based on manufacturer information, Mean Takeoff weight (MTOW) to be used for climb rate and turn rate calculations. 10505 Checks all available routes and trajectories allowed, the information is provided by the assigned Departure ATC template to be used. 10506 checks for all available slots at each airport, as well as all possible trajectory and route permutations. The block optimizes for best possible departure trajectory or route for each aircraft based on its performance and updated departure time slot. 10507 calculates for each departure am anti-collision initial climb rate, altitude, turn rate and heading, heading and routing with a climb rate and turn rate supported by the aircraft type, and ensures each aircraft has protected airspace ensuring vertical separation, horizontal separation and wake separation while taking into account current winds and atmospheric conditions. 10508 generates the departure slot information, including initial climb rate, altitude, turn rate and heading. Further departure route or additional climb rate, altitude, turn rate and heading. 10509 sends the information to the all relevant CWP (controller Working Positions) including Departure ATC, Tower ATC and Shift Managers, ATC Recording systems. In Addition 10509 sends the information for every flight to its DAMS for displaying the information to the Pilot.

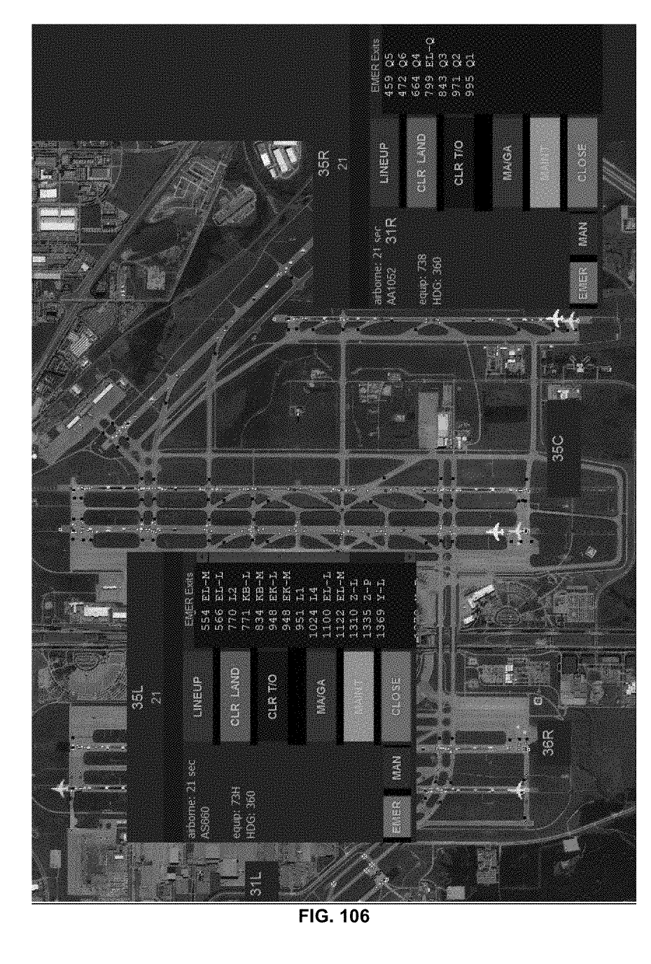

FIG. 106 illustrates an example of CWP (Controller Working Position) display. The CWP Display includes a dynamic chart or aerial photo or satellite map displaying all of the airport areas, runways, taxiways, junctions (green/lime squares), emergency exits (shown in red/yellow squares), aircrafts taking off (yellow aircraft), airborne aircrafts after takeoff roll (lime aircraft), taxiing and aircrafts holding short prior to takeoff roll (aqua aircraft). In addition, there is a Runway Control Panel for each active runway, as shown in this example for Runway 35L. Each Runway Control Panel includes the following information: seconds till the next operation can safely take place, accounting for wake separation while taking into account any crosswind conditions lowering the wake separation requirements (shown 21 seconds under the Runway designation). In addition each Runway Control Panel displays is continuously updated displaying all possible exit names and the exit distance from current aircraft position (shown 554 EL-X). In addition, each Runway Control Panel allows a Controller to relay common clearances and ATC commands for “cleared to land”, “cleared for takeoff”, “lineup and wait”, Missed Approach” (M/A), “Go-Around” (G/A) and the like. A Controller may also change the runway status to be in maintenance (MAINT), closed (CLOSE), operate the runway manually without automation intervention (MAN), or, declare an emergency closing the runway and forcing automated rerouting of other aircrafts.

What is claimed is:

1. A computer implemented method for autonomous or automatic management of airport air traffic control, the method comprising:
automatically generating and exchanging control messages of data information between the airport air traffic control and a specific aircraft's pilot via a data link connecting the airport air traffic control system and the interface and control systems within the aircraft by executing a selected predefined control message;
automatically generating and exchanging control and data voice messages between the airport air traffic control and plurality of aircraft's pilots via voice communication channels connecting the airport air traffic control system and the interface and control systems within the aircraft by executing a selected predefined control message;
continuously updating information on the position of all aircrafts within the control zone of the airport air traffic control from airborne avionics and ground sensors;
continuously updating information regarding the status of the runways, junctions, taxiways, weather conditions, debris, birds within the control zone of the airport air traffic control from authorized reporting bodies such as controllers, pilots, external systems;
displaying operational information on cockpit display according to the flight stage of the aircraft and relevant airport traffic;
enabling the pilot to send requests and/or responses over voice channels or data link channels;
recording all information exchanged via the audio and data communication channels, all sounds within the cockpit, flight performance data from aircraft sensors and avionics; and
displaying information to the controller and enabling him to manage related associated airport automated operations either by touch screen, data entry, mouse or by hand gestures.

2. The method of claim 1, further comprising the steps of:
executing voice recognition on voice messages received from aircraft's pilot;
automatically converting received message to text message; and
automatically synthesizing text to speech.

3. The method of claim 2, further comprising the step of translating messages from English to pilot's native language and vice versa.

4. The method of claim 1, wherein a control message transmitted via data link can be text messages, graphics, pictures, or binary data.

5. The method of claim 1, wherein each predefined control message includes receiving of indication whether a command sent to an aircraft has been accepted or rejected.

6. The method of claim 1, wherein moving map of the airport is displayed on flight deck display during landing, taking-off, and taxiing.

7. The method of claim 1, wherein data link information exchanged between the airport air traffic control and aircrafts or other air traffic controls is encrypted by information sender and is decrypted by information receiver.

8. A computer implemented method for automatic management of airport air traffic control, the method comprising:
automatic hand-off of control to and from other air traffic control or CWP;
providing continuous verbal and visual information and commands to plurality of aircrafts during landing;
providing continuous verbal and visual information and commands to plurality aircrafts during take-off;
providing continuous verbal and visual information and commands to plurality of pilots during taxiing;
providing continuous verbal and visual information and commands to plurality of pilots during climbing;
providing continuous verbal and visual information and commands to plurality of pilots during descending;
providing continuous verbal and visual information and commands to plurality of pilots during operations within the airport;
taking control of the aircraft in case of hijacking or emergency situation by sending data to the automatic pilot and flight management computer on said aircraft;
managing the dispatching of emergency personnel and providing them continuous information on preferred standby position, and relevant information; and
balancing the use of multiple runways by evaluating anticipated traffic load, weather and operational conditions.

9. The method of claim 8, further comprising the steps of:
providing lineup and wait command to aircraft via voice and data link channels;
providing takeoff information comprising of: runway conditions; weather; birds; debris; emergency exists; expected time until airborne; NAVAID or RNAV or initial climb, heading and departure contact information;
providing takeoff clearance command via voice and data link channels;
providing rolling updates via data link channels; and
providing turbulence warning if required.

10. The method of claim 8, further comprising the steps of:
providing landing clearance command via voice and data link channels;
providing braking updates information comprised of: runway conditions; birds; debris; relevant exits and distance from current location;
providing turbulence warning if required;
flashing airfield lights of exit to take;
generating of go-around suggestion approach command if required by analyzing landing situation;
generating of missed approach command if required by analyzing landing situation; and
checking of landing gear locking by image processing data from cameras.

11. The method of claim 8, further comprising the steps of:
predicting congestion and hotspots on taxiways;
selecting preferred takeoff junction on long runways for departing aircraft;
recommending to pilot preferred taxiing routes with anticipated taxiing time;
monitoring landing aircraft on the runway and recommend next exit junction;
selecting landing aircraft preferred taxiing route;
displaying updated position and countdown timers within the route to the pilot on the Dynamic map in the cockpit; and
monitoring the taxiing of the aircraft.

12. The method of claim 8, further comprising the steps of:
controlling junction crossing of aircrafts and vehicles; and
monitoring junction crossing.

13. The method of claim 8, further comprising the steps of:
displaying a colored Dynamic map to pilot, said map displays updated surrounding traffic in the air and on the ground.

14. The method of claim 8, further comprising the step of:
generating control commands and managing grounding of all aircrafts in case of emergency.

15. The method of claim 8, further comprising the steps of:
marshaling breaks or steering and engine power upon detection of dangerous situations, such as aircraft continues to move past a specified holding position, or too slow clearing of a junction.

16. The method of claim 8, further comprising the steps of:
executing automatic hand-off from approach ATC after receiving hand-off request; and
generating hand-off request to departure ATC and automatically managing the hand-off procedure.

17. An airport air traffic control system comprising:
plurality server processor;
airport air traffic management software package executed on said server;
plurality of ground based sensors functionally coupled to said server;
plurality of voice and data communication equipment coupled to said server;
plurality of computerized terminals coupled to said server;
plurality of aircrafts communicatively coupled to said server via airborne communication equipment;
display and control units within each aircraft coupled to said airborne communication equipment;
ground vehicles communicatively coupled to said server via said voice and data communication equipment; and
airfield lights system, controlled by said server.

18. The airport air traffic control system of claim 17 whereas ground based sensors are comprised of:
plurality of radar units;
plurality of movement detection cameras providing information on aircraft location;
plurality of aircraft position reporting sensors; and
plurality of landing gear reporting cameras.

19. The airport air traffic control system of claim 17 whereas computerized terminals are comprised of:
strategic airline monitoring module exchanging flight information with airport air traffic management software;
plurality of CWP (Controller Working Position) enabling a controller to remotely communicate with airport air traffic management software and send commands and data;
airport operations center module for exchanging aircraft and airport scheduling with the airport management software;
plurality of air traffic control terminals running software package that enables automatic handoff of control; and
plurality of emergency dispatch modules.

20. The airport air traffic control system of claim 17 whereas the display and control units within each aircraft are comprised of:
future air navigation system (FANS) communicatively coupled to ground communication equipment;
controller pilot data link communication (CPDLC) unit communicatively coupled to ground communication equipment and to said FANS;
controller pilot data link communication display unit (CPDLCDU) functionally connected to said CPDLC capable of displaying text and graphics and functional keys;
autopilot system coupled to said FANS;
a flight management system (FMS) coupled to said autopilot, FANS and CPDLC units;
a cockpit computer system (CCS) communicatively coupled to ground communication equipment and to FANS and avionics through FANS, said cockpit computer is capable of displaying Dynamic map, the map is in color and relevant information is superimposed on said map; and
a software package executed within the CCS for displaying Dynamic map.

21. A method, the method comprises:
receiving an at least one parameter associated with an at least one aircraft or with an at least one airside object or with an airfield or with an at least one airport;
calculating one or more routes associated with said aircraft or said airside object or said airport or said airfield, said calculating being in accordance with said at least one parameter and in accordance with an at least one routing criteria; wherein said at least one routing criteria comprises one member of a group consisting of: environment of said airport or said airfield, performance of said airside objector said airport, preference of an operator of said aircraft or said airside object, air regulation, airport or airfield related restrictions, time to pushback, fuel saving, optimize use of runway or taxiway or junction in said airport or said airfield, and safety of said aircraft or said airside object; and
transmitting said one or more routes to said at least one airside object or to an at least one other airside object or to said at least one aircraft, to an at least one other aircraft or to an at least one CWP (Controller Working Position), said transferring is for presenting said one or more routes on a dynamic map (DAM) or on said an at least one CWP.

22. The method of claim 21, wherein said at least one parameter comprises one member of a group consisting of type of said aircraft or said airside object, route of other aircraft or other airside object, junction congestion, traffic in said airport, hotspot, overcapacity at a runway, overcapacity at a taxiway, available runway, closed area, closed taxiway, closed junction, available taxiway, available junction, expected taxi time, runway sequencing, gate usage, gate scheduling, maintenance work, congestions at other airports, time from an at least one runway to an at least one gate and parameter associated with environment of said airport or said airfield.

23. The method of claim 21, wherein said at least one routes comprise an at least one parameter; wherein said at least one parameter comprises estimate time for completing said route or congestion level of said route.

24. The method of claim 23, further comprising displaying said one or more routes and said at least one parameter associated with each of said one or more routes, receiving selected route from said one or more routes and displaying said selected route; said displaying being on a DAM (Dynamic map) aboard said aircraft or said aboard airside object or on a CWP (Controller Working Position).

25. A method, the method comprises:
by a server;
s receiving from an at least one sensor covering an airport or an airfield or from a database associated with said server, data associated with an at least one operation of an aircraft or an airside object; and
as result of said receiving, transmitting said data or other data calculated from said data to said aircraft or to said airside object or to an at least one other aircraft or to an at least one other airside object;
wherein said transmitting is for presenting said data or said other data for presenting a selection menu associated with said data or with said other data and with said operation; or
wherein said transmitting is for alerting an alert associated with said data or with said other data.

26. The method of claim 25, wherein said receiving and said transmitting and said presenting or said alerting is within operation of said aircraft or said airside object while said aircraft or said airside object is in said airfield or in said airport.

27. The method of claim 25, further comprising translating said data to a language selected by an operator of said aircraft or said airside object or said other aircraft or said other airside object.

28. The method of claim 25, wherein said data or said other data comprises one member of a group consisting of: FOD (Foreign object debris), winds during said operation, braking action per aircraft type, area and vector of bird movement, closed taxiway, closed junction, closed runway, final resting area of said at least one aircraft, available safe runway exit, calculated TD point of said at least one aircraft, calculated braking deceleration of said at least one aircraft, crossing of an at least one other aircraft or airside object affecting said aircraft or airside object, takeoff of other aircraft, an indication of violating a route of said at least one aircraft, or said an at least one airside object, landing of other aircraft, calculated heading of said at least one aircraft or said at least one airside object, calculated speed of said at least one aircraft or said at least one airside object, clearing of a junction, clearing of a position, expedite instructions, read-back confirmation, hear-back confirmation, clearance delivery request, clearance delivery change, clearance delivery approval, calculated descent rate of said at least one aircraft, prevailing winds, runway braking action in accordance with the type and weight of said at least one aircraft, deviation from heading or route of said at least one aircraft or said at least one airside object, required heading correction, proper descent rate for a pilot to safely land said aircraft within designated area, ATC (air traffic control) frequency, calculated wake information, barometric pressure, departure clearance route, initial climb of said at least one aircraft, assigned gate number of said at least one aircraft or said at least one airside object, time countdown for operation of said at least one aircraft or said at least one airside object, go-around or missed approach, statistic associated with operation of said aircraft or said at least one airside object, calculated decision height, follow another said aircraft or said airside object, give way to another aircraft or another airside object, maintain separation, distance to next junction, a turn in a route of said aircraft or said at least one airside object, restricted taxiway, restricted runway, restricted junction, restricted gate, restricted stand, environment, restricted terminal, distance to emergency exists during take-off roll, holding pattern, holding positions, holding short, temperature barometric pressure at different altitudes, gusts, vertical windshears, horizontal windshears, turbulence of said other aircrafts, wake of said other aircrafts, wake warning, turbulence warning, emergency information, time slotting assignment and current or future position or operation or calculated future positions of said aircraft or said airside object or said other aircraft or said other airside object or said at least one airport or said at least one airfield.

29. A method, the method comprises:
during an operation of an aircraft or an airside object within an airport or an airfield and by a server:
receiving data associated with said operation; and
as a result of said receiving said data, presenting said data or alerting an alert associated with said data or presenting a pilot selection menu associated with said data or with said operation; said presenting is on said DAM (Dynamic map) located in said aircraft or said airside object.

30. A method, the method comprises:
by an at least one server:
receiving from an at least one sensor covering an airport or an airfield or an aircraft or an airside object, or from a database associated with said airport or said airfield or said aircraft or said airside object, data associated with operation of said airport or an airfield or said aircraft or said airside object.
processing said data to, thereby, generating one member of a group consisting of a control message for controlling said aircraft or said airside object, an alert for alerting said aircraft or said airside object or for alerting a CWP (Controller Working Position) and a signal for signaling said aircraft or said airside object or said CWP; and
transmitting said control message to said aircraft or said airside object; said transmitting is for operating said aircraft or said airside object in accordance with said control message; or
transmitting said alert to said aircraft or said airside object or said CWP to thereby presenting said alert in said aircraft or said airside object or said CWP; or
transmitting said signal to said aircraft or said airside object or to said CWP.

31. A method, the method comprises:
receiving a control message or an alert or a signal from a server; said control message or said alert or said signal being generated by said server in response to receiving from an at least one sensor covering an airport or an airfield or an aircraft or an airside object, or in response to receiving from a database associated with said airport or said airfield or said aircraft or said airside object data associated with an operation of said aircraft or said airside object; and
executing one more other operations in accordance with said control message; or
presenting said alert in said aircraft or said airside object or a CWP (Controller Working Position).

32. The method of claim 31 wherein said control message comprises one member of a group consisting of: a control message for aircraft to execute or a control message for a vehicle to execute or a control message for an automated or autonomous airside crew to execute;
wherein said control message for aircraft comprises one member of a group consisting of DH (decision height), applying breaks, stopping, applying engine power, controlling turning, controlling taxi speed, altitude, height, heading, descent, climb, descent rate, climb rate, turn rate, vector, new route, update flight plan, turn autopilot on, turn autopilot off, lock autopilot, unlock autopilot, approaching, departing, landing, taking off, taxiing, hold short, speedup, maximum speed, minimum speed, follow, give way and maintain way, maintain separation and performing an at least one task capable by said aircraft assigned by said control message;
wherein said control message for vehicle comprises one member of a group consisting of applying breaks, stopping, applying engine power, controlling turning, controlling speed, new route, updated route, hold short, speedup, maximum speed, minimum speed, follow, give way, maintain separation and performing an at least one task capable by said vehicle assigned by said control message; and
wherein said control message for automated or autonomous airside crew comprises one member of a group consisting of applying breaks, stopping, applying engine power, controlling turning, controlling speed, new route, updated route, hold short, speedup, maximum speed, minimum speed, follow, give way and maintain separation and perform an at least one assigned task.

33. The method of claim 32 wherein said alert comprises one member of a group consisting of entering a restricted area, making a wrong turn, wrong speed, wrong route, not slowing, not stopping, not clearing junction, not following, not giving way, not abiding to assigned route and not stopping in a junction, not abiding to regulation, not abiding to restriction, not abiding to assigned taxi instruction, not abiding to any type of clearance instruction, not abiding to expedite, not abiding to controller instructions and unconfirmed from gear lock.

34. A method, the method comprises:
receiving from an at least one wind sensor, data associated with wind direction associated with an at least one runway or data associated with wind strength associated with said at least one runway;
calculating wake information of an at least one landing or taking off of an at least one aircraft on said at least one runway,
calculating an at least one wake dissipation of said landing or said taking off of operation of said at least one aircraft; said calculating is taking into account said wake information or said wind direction or said wind strength; wherein a result of said calculation comprise an at least one member of a group consisting of: timing operations, spacing, separation and count down timer, wake dissipation image, wake dissipation data, on an at least one other aircraft or on an at least one other airside object, said at least one aircraft or said at least one airside object is positioned within an area of said runway; said area of said runway comprises said runway or an at least one taxiway attached to said runway or an at an least one end of said runway or an at least one other runway or on an at least one taxiway attached to an at least one other runway or an least one end of and at least one other runway, said at least one other runway is parallel to said runway or located within 20NM of said runway; and
transmitting said result to said least one other aircraft or to said at least one other airside object or to CWP (Controller Working Position).

35. A method, the method comprises:
receiving from one or more sensors located in an airport or receiving from an at least one airside objects or from at least one aircraft positioned in said airport, data associated with environment of said airport or with an at least one airport associated operation of said at least one airside object within said airport;
generating an at least one control command from said data; wherein said at least one control command being for controlling one or more operations of said at least one airside objects or said at least one aircraft; and
transferring said control commands to said at least one airside objects or said at least one aircraft or CWP (Controller Working Position); said transferring is for presenting said control command in said at least one airside objects or said at least one aircraft said CWP or for operating said at least one airside objects or said at least one aircraft or said CWP in accordance with said control command.

36. A method, the method comprises:
by a server: receiving from one or more of sensors, data; said data being associated with environment of said airport or with one or more operations of one or more airside objects within said airport;
calculating one or more air routes for an at least one of said airside objects; or
calculating one or more expected conflicts between said one or more airside objects; and
displaying said calculated air routes, said calculated expected conflict on a display of a computing device; wherein said displaying being for controlling and monitoring said airport.

37. The method of claim 36 wherein said computing device is not located in said airport.

38. A system, the system comprising:
An at least one wind sensor;
an at least one server; said at least one server is configured for receiving from said at least one wind sensor, data associated with wind direction or strength associated with an at least one runway;
calculating wake information of an at least one landing or taking off of an at least one aircraft on said at least one runway;
calculating an at least one wake dissipation of said landing or said taking off operation of said at least one aircraft; said calculating taking into account said wake information or said wind direction or said wind strength; wherein results of said calculation comprise an one member of a group consisting of: timing operations, spacing, separation and count down timer, wake dissipation image, wake dissipation data, on an at least one other aircraft or on an at least one other airside object, said at least one aircraft or said at least one airside object is positioned within an area of said runway; said area of said runway comprises said runway or an at least one taxiway attached to said runway or an at an least one end of said runway or an at least one other runway or on an at least one taxiway attached to an at least one other runway or an least one end of and at least one other runway; said at least one other runway is parallel to said runway or located within 20NM of said runway; and
transmitting said results to said least one other aircraft or to said at least one other airside object or to CWP (Controller Working Position).

39. A system, the system comprises:
an at least one server; and
an at least one of camera located at an at least one junction or at an at least one edge of a runway of an airport; said an at least one camera is configured for providing an at least one streaming image of an at least one operation of an at least one airside objects on said runway to said server wherein said server is configured for receiving said streaming image and for transmitting said streaming image to a dynamic map of said at least one airside objects for providing reliable visual clarity during poor visibility; or
wherein said camera is configured for providing an at least one image of an at least one object located in an area of said camera to an airside object for presenting an alert in said airside object.

40. A system, said system comprises:
a software driver configured for operating a switch; said switch controlling a lighting system to flash designated airfield lights; and
a processor; said processor is configured for receiving position of an aircraft, for identifying go-around or missed-approach scenario for said aircraft in accordance with said position of said aircraft and for instructing said software driver to control said flash designated airfield lights to flash said designated airfield lights; said flashing is for alerting a pilot of said aircraft about said go-around or missed-approach scenario.

41. A method, the method comprises:
receiving from a first airside object present in an airport, an at least one parameter associated with said first airside object; wherein said an at least one parameter comprises one member of a group consisting of: location of said first airside object in said airport, a ground route of said first airside object and rate of acceleration or rate of deceleration of said first airside object or starting point of said ground route or ending point of said ground route;
receiving from a second airside object present in said airport, a parameter associated with said second airside object; wherein said parameter comprises one member of a group consisting of: location of said second airside object, route of said second airside object and rate of acceleration or deceleration of said second airside object;
calculating a first next position or a first optimized speed for said first airside object or calculating a second next position for said second airside object or a first optimized speed for said second airside object; said calculating being in accordance with said parameter associated with said first airside object and in accordance with said parameter associated with said second airside object; or
if said first airside object is an aircraft, calculating a first time to pushback for said first airside objects; said calculating being in accordance with said parameter associated with said first airside object and in accordance with said parameter associated with said second airside object; or
if said second airside object is an aircraft, calculating a second time to pushback for said second airside objects; said calculating being in accordance with said parameter associated with said first airside object and with said parameter associated with said second airside object; and
transmitting said first next speed to said first airside object; or transmitting said second next speed to said second airside object or transmitting said first time to pushback to said first airside object or transmitting said second time to pushback to said second airside object, said transmitting is for optimizing flow of airport traffic or for aircraft fuel saving or for minimizing times between gate and runway.

42. The method of claim 41 further comprises transmitting an alert to next aircraft to land or to take off.

43. A method, the method comprises:
by an at least one server:
receiving a first event of changing a status of an area of an airport; wherein said status comprises one member of a group consisting of a restricted area or closed area and an opened area or maintenance area or inactive area or active area; or
receiving a second event of an at least one change of runways in use in said airport; or
receiving a third event of sensing a change in environment in said airport; and
in response to said receiving said first event or said second event or said third event recalculating an at least one route of an at least one aircraft or of an at least one airside object; said route is associated with said airport; or
in response to said receiving said first event or said second event or said third event determining an at least one aircraft affecting from said first event or from said second event or from said third event and transmitting a missed-approach message or transmitting a go-around message to said at least one aircraft.

44. A method, the method comprises:
displaying on an at least one CWP (Controller Working Position) a plurality of routes; receiving a selection from a controller of an at least one route from said plurality of routes through said CWP; and
transmitting said selected route to an at list one aircraft or to an at least one airside object or to an at least one other CWP.

45. A method, the method comprises:
receiving a recording, said recording comprises recorded data of an at least one operation of an at least one aircraft or of an at least one airside object
said recorded data further comprises a recording of an at least one environmental data within airport;
extracting said at least one operation or said at least one environmental data from said recorded data; and
presenting said at least one operation or said at least one environmental data of said recorded data; said presenting is in accordance with a timestamp associated with said recorded data.

46. A system, the system comprises
an at least one LGRC (landing gear reporting camera) located within 500 feet of a runway; said LGRC is configured for detecting an aircraft and for imaging a plurality of images of said detected aircraft; and
an at least one processor; said processor is configured for receiving said plurality of images, for comparing an at least one of said plurality of images of said aircraft with one or more other images from said plurality of images; for identifying movement of front gear of said aircraft as a result of said comparing, and for transmitting alert of potential unlocked gear to said aircraft or to an at least one airside object or to an at least one CWP.
